(19) United States
(12) Patent Application Publication
(10) Pub. No.: US 2022/0097110 A1
(43) Pub. Date: Mar. 31, 2022

(54) MECHANOCHEMICAL PROCESS

(71) Applicants: Elke MUENCH, Dorsheim (DE); SMART MATERIAL PRINTING B.V., Enschede (NL)

(72) Inventor: Gregor LUTHE, Gronau (DE)

(21) Appl. No.: 17/310,581

(22) PCT Filed: Feb. 9, 2020
(86) PCT No.: PCT/EP2020/000035

§ 371 Date: Aug. 12, 2021

(30) Foreign Application Priority Data
Feb. 12, 2019 (DE) 10 2019 000 987.8

(51) Int. Cl. B09B 3/35; B01J 23/745; C08F 292/00; C01B 32/324; C09C 3/08; C09C 3/04; C09C 3/00; C05B 17/00; C05D 9/00; C05C 5/00; C02F 9/00; B01D 53/58; B01D 53/64; B01D 53/81; B09B 3/10; B09B 3/70; B09B 3/50

(52) U.S. Cl. CPC B09B 3/35; C02F 1/441; C08F 292/00; C01B 32/324; C09C 3/08; C09C 3/041; C09C 3/006; C05B 17/00; C05D 9/00; C05C 5/00; C02F 9/00; B01D 53/58; B01D 53/64; B01D 53/81; B09B 3/10; B09B 3/70; B09B 3/50; B01J 23/745

(57) ABSTRACT

The invention relates to a mechanochemical process for decontaminating and/or for eliminating problematic, synthetic, biogenic and biological materials A; for breaking down phosphates B; for immobilising metals and the compounds C thereof; for separating carbon dioxide and carbon monoxide D into elements; and for recovering valuable products E. The process comprises: —providing a material F to be milled containing —at least one material A, B, C and/or D and —at least one type of carbon or carbon-yielding material G, or alternatively providing the components of F and G separately from one another; —filling the material F to be milled into a mechanical mill (1), or alternatively —filling the components of the material F to be milled into a mechanical mill (1) and —milling by means of milling elements (1.2) moved by agitation means (1.4) or by means of rollers (1.4.6); after which —the resulting product I is separated from the milling elements (1.2) or the rollers (1.4.6) and is discharged from the milling chamber (1.1) and worked up. The invention also relates to the use of the products I as valuable materials E, the use of a self-cooling electric motor (4) for driving a mechanochemical mill (1), and mechanochemical mills (1) having new agitation means (1.4).

### FIELD OF INVENTION

The present invention relates to a mechanochemical process for the decontamination and/or elimination of problematic, synthetic, biogenic and biological materials, for the digestion of phosphates, for the immobilization of metals and their compounds, for the splitting of carbon dioxide and carbon monoxide into the elements and for the recovery of valuable products.

The present invention also relates to the use of the products resulting from the mechanochemical process.

Last but not least, the present invention relates to new mechanical mills for mechanochemical processes.

### STATE OF THE ART

The special physicochemical effects and mechanisms of mechanochemistry are the subject of numerous theoretical investigations such as the articles by
V. V. Boldyrev, Mechanochemistry and mechanical activation of solids, in Russian Chemical Reviews, 75 (3) 177-189 (2006);
P. Yu. Butygain and A. N. Streletskii, The Kinetics and Energy Balance of Mechanochemical Transformations, in Physics of the Solid State, Vol. 47, No. 5, 2005, 856-852
J. Fontaine et al. Tribochemistry between hydrogen and diamond-like carbon films, in Surface Coatings Technology 146-147 (2001) 286-291;
L. Takacs, Mechanochemistry and the Other Branches of Chemistry: Similarities and Differences, in Acta Physica Polonica A, Vol. 121 (2012), 3, 711-714;
S. A. Steiner III et al., Circumventing the Mechanochemical Origins of Strength Loess in the Synthesis of Hierarchical Carbon Fibers, in Applied Materials & Interfaces, 2013, 4892-4903; or
Materialsgate Newsletter Sep. 12, 2017, Tribology: Simulation shows previously unknown friction mechanisms at the molecular level.

Furthermore, review articles give an overview of the historical development and perspectives of mechanochemistry, such as the articles by S. L. James et al., Mechanochemistry: opportunities for new and cleaner synthesis, in Chem. Soc. Rev., 2012, 41, 413-447, in which syntheses of inorganic materials such as alloys, oxides, halides, sulfides, nitrides and composites, co-crystals such as charge transfer co-crystals, acid-base co-crystals, ionic co-crystals and organic catalysis by co-crystallization, new forms of drugs such as pharmaceutical co-crystals and organic syntheses with carbon-carbon and carbon-X bond formation such as stoichiometric organic reactions, metal catalyzed organic reactions, organocatalytic asymmetric reactions, syntheses of ligands and host-guest systems, the synthesis of metal complexes and the synthesis of coordination polymers (MOFs) are presented;
P. Balaz et al., Hallmarks of mechanochemistry: from nanoparticles to technology, in Chem. Soc. Rev., 42, 2013, 7571-7637; or
Tomislav Friscic, Supramolecular concepts and new techniques in mechanochemistry: cocrystals, cages, rotoxanes, open metal-organic frameworks, in Chem. Soc. Rev., 2012, 41, 3493-3510.

For example, F. Cavalierie and F. Padella describe in the article Development of composite materials by mechanochemical treatment of post-consumer plastic waste, in Waste Management, 22 (2002) 913-916, the mixture of polypropylene and polyethylene by grinding in liquid carbon dioxide a composite can be produced which no longer shows any incompatibility between the two polymers and which has better properties than the starting polymers.

For example, Haoliang Jia et al. in their article Formation of nanocrystalline TiC from titanium and different carbon sources by mechanical alloying in Journal of Alloys and Compounds, 472 (2009) 97-103, the production of nanocrystalline titanium carbide from titanium powders and various carbon sources.

Tan Xing et al. describe in their article Ball milling: a green approach for synthesis of nitrogen doped carbon nanoparticles in Nanoscale, 2013, 5, 7970-7976, an industrially applicable synthesis process for the production of nitrogen doped carbon nanoparticles.

L. Borchardt et al. describe in their article Mechano-chemistry assisted synthesis of hierarchical porous carbon applied as supercapacitors in Beilstein Journal of Organic Chemistry, 2017, 13, 1332, the production of porous carbon from plant materials for use in capacitors and electrodes.

In their article Mechanochemical surface modification of carbon fibers using a simple rubbing method in Journal of Composite Materials 0 (0) 1-8, S. Motozuka et al. describe the surface modification of carbon fibers based on polyacrylonitrile by mechanical friction.

In their article Mechanochemical Polymerization—Controlling a polycondensation reaction between a diamine and a dialdehyde in a ball mill in RCS Adv., 2016, 6, 64799-64802, S. Gratz and L. Borchardt describe the mechanochemical polycondensation between a diamine and a dialdehyde, which offers an attractive alternative to conventional methods.

In the conference report AIP Conference Proceedings, Volume 664, Issue 1, 150008 (2015), Recycling and Processing of several typical crosslinked polymer scraps with enhanced mechanical properties based on solid state mechanochemical milling, the authors describe the grinding of partially devulcanized or uncrosslinked tire rubber chips, post-vulcanized fluororubber cuttings and cross-linked polyethylene cuttings from cable waste, in which they obtain material with improved processability and better mechanical properties.

Further examples of the usefulness of mechanochemistry in different fields emerge from the following patents.

For example, the German patent application DE 10 2014 101 766 A1 discloses a method for recovering and, if necessary, separating lanthanides as chlorides or oxides from mineral waste and residues. In this process, powder particles are first produced, which are then activated mechanochemically.

The European patent EP 1 830 824 B1 discloses a method for producing a nanoparticle composition which comprises nanoparticles of a therapeutic agent In doing so, a mixture of a precursor compound and a co-reactant is ground in a grinding device using a grinding medium.

The American patent application US 2017/0036967 A1 discloses a method for producing fertilizers based on humic acids from lignite and leonardite in a mechanochemical reactor for highly viscous media.

The mechanochemical production of zeolites is described in the international patent application WO2012/072527 A2.

The mechanochemical production of largely iron-free metal chalcogenides or arsenides from iron-free metal powders and sulfur, selenium, tellurium or arsenic emerges from the European patent application EP 1 681 270 A2.

The European patent EP 1 303 460 B1 describes the mechanochemical synthesis of lithiated manganese dioxide from manganese dioxide and lithium salts.

The translation of the European patent EP 0 963 825 B1, DE 699 11 502 T2, describes the mechanochemical treatment of plastics such as polyethylene terephthalate, polystyrene, polypropylene or polyethylene in the presence of liquid carbon dioxide for the compatibilization and recycling of heterogeneous plastics from urban or commercial waste.

The German patent application DE 42 40 545 A1 describes a process for the production of peptides with the aid of proteolytic enzymes, in which amino-protected amino acids as acylation components are reacted with carboxyl-protected amino acids in the presence of a substance containing water of crystallization such as Na₂CO_{3X} 10H₂O by grinding.

A mechanochemical process for the production of a thermoplastic composite from a non-thermoplastic, natural polymer, such as cellulose or chitin, and from 5 to 20% by weight of a synthetic thermoplastic emerges from the Japanese patent JP 3099064 B2. The resulting composite material itself is thermoplastic.

In the older German patent application file number 10 2018 000 418.0 with the filing date of Jan. 20, 2017, a mechanochemical process for the production of valuable products that are free of persistent organic pollutants and other organohalogen compounds is described. They are made from waste of single-type and non-single-type plastics and plastic laminates that are contaminated with persistent organic pollutants and/or contain other organohalogen compounds.

In doing so, in the mechanochemical process (i) the waste is shredded so that the particle size distribution is as narrow as possible, (ii) the crushed waste is placed in a mill containing grinding balls and further crushed by grinding, (iii) at least one dehalogenating agent is added in a molar excess with respect to the amounts of persistent organic pollutants and/or other organohalogen compounds present, (iv) the mixture of ground comminuted waste and dehalogenating agent is further ground and the grinding is terminated after a preselected time, (v) the resulting valuable products free of persistent organic pollutants and other organohalogen compounds are separated from the grinding balls and separates the halogen-containing, water-soluble products that are created by washing with aqueous solvents and/or does not wash out the halogen-containing, water-insoluble products, but as fillers in the Value products and (vi) the washed products of value after drying and the unwashed products of value are checked to determine whether they still contain persistent organic pollutants and/or other organohalogen compounds, whereby (vii) one adds at least one additive before and/or after process step (iv).

Another problem with the recycling of plastics, especially of unmixed plastics and plastic laminates, is their high content of organically bound halogens if, for example, PVC, PVDF, PTFE or chlorofluorinated thermoplastics are contained in the plastic waste.

In their publication Mechanochemical conversion of brominated POPs into useful oxybromides: a greener approach, in Sci. Rep. 2016, 6:28394, G. Castagnetta et al. describe the decomposition of brominated persistent organic pollutants through the reaction with stoichiometric amounts of bismuth oxide or lanthanum oxide with the formation of the corresponding oxybromides and amorphous carbon.

In their article Simultaneous treatment of PVC and oyster-shell wastes by mechanochemical means, in Waste Management 28 (2008) 484-488, W. Tonganmp et al. describe the dechlorination of PVC with oyster shell waste, which provides calcium chloride and organic products with double bonds.

A mechanochemical process for the reductive dehalogenation of organohalogen substances emerges from the German patent DE 197 42 297 C2, the substance or the substance mixture with the addition of elemental alkali metal, alkaline earth metal, aluminum or iron as reducing agent and ethers, polyethers, ammonia, amines, Amides, trialkylsilanes, polyalkylhydrogensiloxanes or metal nitrides, individually or in combination as a hydrogen source, is ground in one step. In this way, sands or soils contaminated with PCB or chlophen can be mechanochemically decontaminated.

However, not only the high organohalogen content of plastics such as PVC, but also a lower organohalogen content can cause problems when recycling plastic and plastic laminates. Even if the waste does not contain organically bound halogens, after a long period of use of the plastics and laminates outdoors, ubiquitous persistent organic pollutants or persistent organic pollutants or POPs (persistent organic pollutants) such as organochlorine insecticides of the 1st generation such as chlordane, DDT, dieldrin or toxaphene, industrially manufactured chemicals such as PCB or by-products of manufacturing and combustion products such as chlorinated and brominated dioxins and dibenzofurans will inevitably accumulate over time. Representatives of these compound classes are also known as the “dirty dozen”. The POPs are semi-volatile and can occur both in the gas phase and bound to dust particles and are distributed worldwide through long-distance transport mechanisms. Because of their lipophilicity, they bioaccumulate in the adipose tissues of animals and humans. Some of the POPs are considered endocrine disruptors or are carcinogenic and have also been linked to infertility, behavioral disorders, and immunodeficiency. Traces of them contaminate large-scale products such as titanium dioxide nanoparticles, which are used as color pigments in cosmetics, inks and plastics. The amounts may appear small in detail, but because of the amounts of titanium dioxide in question, they cannot be neglected.

(Cf. the article by Georgios Ctistis, Peter Schön, Wouter Bakker and Gregor Luthe, PCDDs, PCDFs, and PCBs co-occurrence in TiO2 nanoparticles, in Environmental Science and Pollution Research, DOI 10.1007/s1 1356-015-5628-7).

In the article “A mini-review on mechanochemical treatment of contaminated soil: From laboratory to large-scale”, in Critical Reviews in Environmental Science and Technology, August 2018, pages 1 to 51, G. Cagnetta gives an overview of mechanochemical decontamination of soils.

From the German patent application DE 102 61 204 A1 a method is known for decontamination or detoxification of solid or liquid products contaminated with environmental toxins such as polyhalogenated compounds or organochlorine substances such as dioxins, dibenzofurans and by-products (congeners) or PCBs by means of high-kinetic processes, in which the contaminated products are subjected to high-kinetic fine comminution using so-called tribomaterials by the multiple effects of impact or shear forces. All types of glass from Duran/Solidex to window glass are used as tribomaterials. In addition, grains of sand, granite particles or quartz porphyry particles as well as enamel as cullet particles or sodalite or ceramics can be used, if necessary in a mixture. In these cases, the particles are up to 5 mm in size. But also be oxides such as silicon dioxide, calcium oxide, magnesium oxide, titanium dioxide, iron oxides, zirconium oxide or boron oxide, sulfides such as pyrite, iron sulfide and antimony sulfide, nitrides such as boron nitride and silicon nitride, carbides such as boron carbide, silicon carbide and tungsten carbide, silicides such as iron silicide and titanium silicide or silicon and boron may be used as such or in admixtures, if necessary. The particle sizes are between 10 μm and 1 mm. In Example 3 of the patent application, 10 g of activated carbon to which 0.17 TCDD (2,3,7,8-tetrachlorodibenzo[1,4]dioxin) and 0.23 g of congeners were absorbed were milled with 200 g of broken Duran glass and 2 kg Grind steel balls (CR 6). No toxins or volatile organic compounds could be detected after grinding.

Processes for removing trace substances are known from the company publication “HUBER Technology Waste Water Solution, Fourth Cleaning Level: HUBER Solutions for Eliminating Micropollutants”, downloaded from the Internet on Dec. 30, 2018. These use activated carbon filters, which are regenerated by washing them out. However, as the filter continues to operate, the loading of the inner surface of the activated carbon with micropollutants increases. The process with an activated carbon filter can also be combined with ozonization or with sand filtration of the water from the secondary clarifier tank.

Every year in Germany alone, millions of tons of liquid manure, dried liquid manure, liquid manure, digestate, dry ferments, sewage sludge, ferments, biowaste, water from secondary clarifiers, dry concentrates from the biological purification stages and waste and residues from chemical washers, filters and electrostatic precipitators, waste and residues from the exhaust air treatment and from air conditioning systems accrue. These contain, among other things, nitrates, nitrites, nitrosamines, ammonium salts, ammonia, sulfur compounds, pesticides, drugs and their residues and metabolites, heavy metals and radioactive metals and their compounds, viruses, bacteria and other toxic materials.

The German legislature and the European Union are therefore applying ever stricter standards to the emission of these pollutants. Producers, waste processors and waste users have to adapt to this.

Liquid manure and its traditional and customary utilization methods, such as spreading it as farm-own fertilizer on fields and grassland with a liquid manure tank that spreads the liquid manure on the surface or inoculates directly into the soil, are particularly problematic. If the liquid manure is applied in excess or at times of the year when the vegetation cannot absorb the nutrients it contains, such as in winter, the risk of nutrients leaching into deeper soil layers and of seepage or shielding and erosion in groundwater and surface water increases. Ammonium salts, nitrates and other liquid manure ingredients can, for example, cause algal blooms and fish deaths through eutrophication in water bodies. Last but not least, the application on the soil surface—especially when using wide spreaders—is associated with nutrient losses because the easily soluble nitrogen compounds and above all ammonium salts are lost in the form of ammonia.

Manure can also contain residues from veterinary drugs, especially antibiotics. Especially in intensive animal husbandry, in which antibiotics are used on a large scale, the animals excrete a large part of the substances in the faeces and urine unchanged. By spreading such manure, the drugs also get into the environment, such as the groundwater. Manure fertilization is generally forbidden for vegetable and fruit growing, as dangerous pathogens such as EHEC bacterial strains can get into the soil through animal excrement.

The liquid or solid residue that remains after the fermentation of biomass in a biogas plant is called digestate. The terms biogas slurry or fermentation product are also used. Because of their high content of nutrients, the fermentation residues are mostly used as agricultural fertilizer. With other methods of utilization, the digestate is first dried before it is spread on agricultural land. The drying systems for the fermentation residues are often operated with heat from the conversion of biogas into electricity. Since the fermentation residues can still contain a certain proportion of hard-to-break carbohydrates such as cellulose and lignocellulose, they can also be of interest as fuel after drying. However, its high mineral content and the sulfur and nitrogen compounds it contains cause high levels of slag and corrosion.

Another problem area is sewage sludge. This is a mixture of solids and liquids that are produced by sedimentation in wastewater treatment. In addition to water, the liquid medium contains a large number of dissolved chemical compounds. In its initial state, sewage sludge is thin and dark in color. By sedimentation (action of gravity) solids contents of about 2% to 5% are achieved.

Another problem area is sewage sludge. This is a mixture of solids and liquids that are produced by sedimentation in wastewater treatment. In addition to water, the liquid medium contains a large number of dissolved chemical compounds. In its initial state, sewage sludge is thin and dark in color. By sedimentation (action of gravity) solids contents of about 2% to 5% are achieved.

With sewage sludge, a distinction is made between raw sludge and treated sewage sludge. Sludge fields in sewage treatment plants appear as primarily sludge in the mechanical cleaning stage or as excess sludge in the biological stage. Excess sludge consists mostly of microorganisms such as protozoa and bacteria. By aerobic and anaerobic stabilization of the raw sludge, the less odor-intensive, treated sewage sludge is obtained. The anaerobic treatment takes place in larger sewage treatment plants in digestion towers and supplies the digested sludge.

By flocculation and precipitation with auxiliary materials such as iron (III) chloride or lime, the sewage sludge is processed in such a way that it can be dewatered to a solids content of up to 35% by using, for example, centrifuges and belt sieve systems. With the help of chamber filter presses, even higher degrees of dewatering can be achieved. The sewage sludge is rich in nutrients, as the bacteria in the biological stage use the wastewater constituents to build up the biomass. Nitrates, which are present in up to 1300 mg/liter, phosphates and other nutrient salts are of particular importance for agriculture.

However, sewage sludge also contains substances that can be problematic for the environment and people. In particular, these substances are heavy metals that occur, among other things, through dissolution from pipelines. Organic pollutants are also a problem which is not to be neglected. Sewage sludge can contain a large number of organic compounds with different properties and effects that end up in the wastewater through anthropogenic processes. For example, these substances can be carcinogenic, mutagenic, toxic or hormonally effective. The Sewage Sludge Ordinance specifies limit values for the sum parameters AOX (absorbable organically bound halogens), PCB (polychlorinated biphenyls) and PCDD (polychlorinated dioxins and dibenzofurans). If such substances are present in the wastewater, there is a particular danger because they can bioaccumulate even in low concentrations after agricultural application and get into the food chain. Due to the legal bans on the use of some weed and pest control agents, some of these compounds are currently no longer detectable in the sewage sludge. However, other toxic organic compounds are still present in the sewage sludge.

However, sewage sludge also contains substances that can be problematic for the environment and people. In particular, these substances are heavy metals that occur, among other things, through dissolution from pipelines. Organic pollutants are also a problem which is not to be neglected. Sewage sludge can contain a large number of organic compounds with different properties and effects that end up in the wastewater through anthropogenic processes. For example, these substances can be carcinogenic, mutagenic, toxic or hormonally effective. The Sewage Sludge Ordinance specifies limit values for the sum parameters AOX (absorbable organically bound halogens), PCB (polychlorinated biphenyls) and PCDD (polychlorinated dioxins and dibenzofurans). If such substances are present in the wastewater, there is a particular danger because they can bioaccumulate even in low concentrations after agricultural application and get into the food chain. Due to the legal bans on the use of some weed and pest control agents, some of these compounds are currently no longer detectable in the sewage sludge. However, other toxic organic compounds are still present in the sewage sludge.

As with manure, there are no known economic processes by which the heavy metals and the other toxic substances can be rendered harmless and at the same time the phosphates and the other nutrient salts can be recovered in a biologically available form.

However, sewage sludge also contains substances that can be problematic for the environment and people. In particular, these substances are heavy metals that occur, among other things, through dissolution from pipelines. Organic pollutants are also a problem which is not to be neglected. Sewage sludge can contain a large number of organic compounds with different properties and effects that end up in the wastewater through anthropogenic processes. For example, these substances can be carcinogenic, mutagenic, toxic or hormonally effective. The Sewage Sludge Ordinance specifies limit values for the sum parameters AOX (absorbable organically bound halogens), PCB (polychlorinated biphenyls) and PCDD (polychlorinated dioxins and dibenzofurans). If such substances are present in the wastewater, there is a particular danger because they can bioaccumulate even in low concentrations after agricultural application and get into the food chain. Due to the legal bans on the use of some weed and pest control agents, some of these compounds are currently no longer detectable in the sewage sludge. However, other toxic organic compounds are still present in the sewage sludge.

As with manure, there are no known economic processes by which the heavy metals and the other toxic substances can be rendered harmless and at the same time the phosphates and the other nutrient salts can be recovered in a biologically available form.

Another problem area is phosphorus. Phosphorus is a finite resource, the easily recoverable mineral reserves of which should be depleted in 80 to 120 years. There is an annual potential of around 70,000 t of phosphorus for recovery in German wastewater, while around 120,000 t per year are used in Germany alone. Phosphorus recycling is now mandatory for large water treatment plants with a population equivalent of 50,000 or more. The uptake of phosphorus and micronutrients such as potassium and magnesium can also be increased by nitrification inhibitors, which lengthen the ammonium phase of the nitrogen introduced into the soil. Liquid manure processing through incineration or pyrolysis of the liquid manure converts the phosphate contained in it through vitrification, which means that it is no longer biologically available and lost for fertilization.

Coals are known to bind phosphates and then make them bioavailable again to the plants. Biochar and biochar are used for this, as is lignite, which, however, contains many toxic polycyclic aromatic hydrocarbons (PAHs). Another secondary source of phosphate is building materials such as phosphate-containing cements, concretes, bricks, artificial stones and annular gap mortar as well as phosphate-containing foods such as dairy products, sausage products and canned fish. However, only poorly functioning and therefore uneconomical processes are available for the recovery of phosphate in biologically available form.

Another secondary source of phosphate is building materials such as phosphate-containing cements, concretes, bricks, artificial stones and annular gap mortar as well as phosphate-containing foods such as dairy products, sausage products and canned fish. However, only poorly functioning and therefore uneconomical processes are available for the recovery of phosphate in biologically available form.

Every year, 200,000,000 t of liquid manure and additional fermentation residues, dry ferments and concentrates from exhaust air scrubbers are brought to the fields in Germany. This corresponds to 34,000,000 t/year of ammonium, 36,000,000 t/year of nitrate and 20,000,000 t/year and phosphate from liquid manure alone.

The ammonium form of ammonia, however, is not lost via the gas phase because it is not volatile. However, their mobility is lower than that of nitrate, since it can bond ionically as a cation to the negatively charged soil particles.

In soils saturated with water and at high temperatures, denitrification to nitrous oxide (laughing gas) and nitrogen oxides NOx, which are greenhouse gases, is favored.

Attempts are therefore currently being made to burn and/or pyrolyze manure, to destroy nitrate, to bind ammonia by drying or to use nitrification inhibitors or to sterilize manure under pressure.

The pyrolysis and the incineration of the manure require high energies because the water has to be evaporated. In addition, the fine dust must be retained with filters. Phosphates are lost because they vitrify and are therefore no longer biologically available. Important nitrogen fertilizers are lost and are converted into nitrogen oxides NOx, which are hazardous to the environment and form acids. The procedures must be carried out centrally so that they can only be implemented on a large scale and involve high investments. This leads to additional transport costs and emissions. The loss of nitrogen fertilizer must be compensated for by artificial fertilizers. In and of itself, it is not the nitrates and ammonium that are the real problem, but their uneven distribution over the year and their uneven uptake by the plants and leaching. These problems are not solved by pyrolysis and incineration.

When the nitrate is destroyed by using biological and chemical processes, important nitrogen fertilizers are lost, which loss has to be compensated for by artificial fertilizers. The procedures are very costly and do not solve the problem of long-term fertilization.

The binding of ammonia in dryers by water and acids and subsequent biological degradation is also not effective. It is true that ammonia is bound by water and/or acid during the drying of liquid manure and biogas and can then be oxidized to nitrates with bacteria. This liquid fertilizer can also be applied during the growing season and adapted to the needs of the plants. The disadvantage, however, is the enormous amount of energy required to evaporate 200,000,000 liters of water and condense it again and bind acid. Simple calculations show that the energy requirement would correspond to twelve times the amount of natural gas that is produced in Germany itself. For these reasons, this solution would not make sense in terms of energy, not to mention the carbon footprint that would be associated with it.

The reduction of fertilizer loss through nitrification inhibitors is a simple process that can be carried out in a decentralized manner. Phosphates, potassium and magnesium remain biologically available, which ensures an improved yield and less nitrate gets into the groundwater. However, the nitrification inhibitors used are classified as hazardous to water and as water-soluble, which is why they contaminate the groundwater. If nitrates could be withdrawn from the groundwater through biological treatment, the nitrification inhibitors would accumulate in the groundwater and in the food chain and are therefore endangering in the long run.

When filtering liquid manure with CNF filters, the nanopores clog up directly, so that they are not permeable for liquid manure without prior micro- and nanofiltration and cannot bind the nitrate either. CNF binds heavy metals in the anionic form, but these must be removed from the slurry together with the CNF, otherwise they will be released again in the soil when the CNF biodegrades.

Coals bind phosphates and other nutrients and release them delayed. The problem, however, is the high production costs for activated carbon, for example, at around € 2000.00/ton, or the high level of contamination of lignite.

Other waste containing environmentally harmful organic materials is the sludge from oil production. Here, too, no satisfactory solution has yet been found for converting this type of waste into valuable products.

The concentration of the greenhouse gas carbon dioxide in the earth's atmosphere has increased continuously since the industrial revolution and has now reached a critical value that leads to a noticeable warming of the earth's atmosphere. As a result, the permafrost soil, for example, is melting and the glaciers are receding as water reserves. Another consequence could be the development of methane—an even more effective greenhouse gas—from methane ice, the negative consequences of which are unforeseeable. There is therefore no lack of attempts to reduce the formation of carbon dioxide and/or to withdraw the carbon dioxide once it has formed from the atmosphere. However, the corresponding processes are expensive, time-consuming and their success is questionable. There is therefore no lack of attempts to split carbon dioxide into oxygen and carbon at comparatively low temperatures, as can be seen from the following publications:
H. Kato et al., JOURNAL OF MATERIALS SCIENCE (1994), 29: 5689, “Decomposition of carbon dioxide to carbon by hydrogen-reduced Ni (II)-bearing ferrite”;
Kodama et al., Journal of Solid State Chemistry, 1995, “XRD and Mössbauer studies on oxygen deficient Ni (II)-bearing ferrite with a high reactivity for CO2 decomposition to carbon”;
Kodama et al., Materials Research Bulletin, 1995, “CO₂ decomposition to carbon by ultrafine Ni (II) bearing ferrite at 300° C.”;
Masamichi Tsuji et al., Applied Catalysis A: General, Vol. 142 (1), 1996, 31-45, “Catalytic acceleration for C02 decomposition into carbon by Rh, Pt or Ce impregnation onto Ni (ii)—bearing ferrite”;
Chun-lei Zhang et al., Materials Chemistry and Physics, Vol. 62 (1), 2000, 52-61, “Studies on the decomposing carbon dioxide into carbon with oxygen deficient magnetite: II. The effects of magnetite on activity of decomposition CO₂ and mechanism of the reaction”; and
Doma Esrafilzadeh et al., Nature Communications 10, Article number: 865 (2019), “Room temperature CO₂ reduction to solid carbon species on liquid metals featuring atomically thin ceria interfaces”.

However, these processes still require further development in order to be able to be used industrially.

Furthermore, the waste from carbon fiber-reinforced plastics (CFRP) is difficult to recycle in order to recover the expensive carbon fibers for further use. For example, carbon fiber reinforced polyepoxides are treated with supercritical water or solvents to release the carbon fibers. From the American patent application US 2019/0203013 A1 a work-up process is known in which the CFRP are aerobically depolymerized. The released carbon fibers can be reused and the resulting monomers can be polymerized again. However, this is comparatively complex. In particular, the separation of the monomers is problematic in terms of safety. The method known from the American patent application US 2019/0039266 A1 and the known device circumvent this problem by pyrolyzing the CFRP, which releases the carbon fibers again—but at the cost of eliminating the plastic matrix.

It would therefore be desirable if the CFRP could be converted directly into new products of value. However, the previously known methods and devices are not suitable for this.

An acid-catalyzed mechanochemical process is known from the article by S. Amirjylayer et al., Understanding the Mechanocatalytic Conversion of Biomass: A Low-Energy One-Step Reaction Mechanism by Applying Mechanical Force, Angewandte Chemie International Edition, Vol. 58, Issue 16, with which celluloses can be broken down into low molecular weight sugars. It is not known to what extent this process can be used for the industrial production of salable products of value.

Overall, methods of the prior art are therefore only poorly or not at all suited for the decontamination or elimination of problematic synthetic, biogenic and biological materials, for immobilizing metals, for digesting phosphates, for splitting carbon dioxide and carbon monoxide into the elements and for recovering Valuable products suitable.

### OBJECT OF THE PRESENT INVENTION

The present invention was based on the object of finding a widely applicable method that enables natural, synthetic, biological and biogenic materials to be decontaminated and/or eliminated in a simple manner, and metals to be immobilized so that they can be safely stored, to break down phosphates and make them biologically available again, to split carbon dioxide and carbon monoxide into its elements, so that a carbon dioxide sink is created, and to extract valuable products such as full-fledged fertilizers or the allotropes of carbon such as graphene, carbon nanotubes, carbon nanocons and activated carbon. In particular, however, activated charcoal is to be obtained, which can be fed back into the process or used for the production of terra preta or as a carbon dioxide sink.

### SOLUTION ACCORDING TO THE INVENTION

Accordingly, the object of the present invention was solved with the aid of the mechanochemical method for the decontamination and/or elimination of problematic, synthetic, biogenic and biological materials, for breaking down phosphates, for the immobilization of metals and their compounds, for the splitting of carbon dioxide and carbon monoxide into the elements and for the recovery of products of value according to the independent patent claim 1 and the mechanochemical mill according to the independent patent claim 20. Advantageous embodiments and uses can be found in the dependent claims referring back to them.

### ADVANTAGES OF THE PRESENT INVENTION

With regard to the prior art, it was surprising and not foreseeable for the person skilled in the art that the object on which the present invention was based could be achieved with the aid of the mechanochemical process according to the invention. In particular, it was surprising that the mechanochemical process according to the invention no longer had the disadvantages of the prior art, but that it was extremely broadly applicable and made it possible to decontaminate and/or eliminate synthetic, biological and biogenic materials, metals and their compounds in a simple manner immobilize and detoxify so that they can be safely stored or used as catalysts, to break down phosphates and make them biologically available again, to split carbon dioxide and carbon monoxide into oxygen and elemental carbon and to produce valuable products such as full-fledged fertilizers or the allotropes of carbon such as graphene and carbon nanotubes To extract carbon nanocones and activated carbon. In particular, however, activated charcoal could be obtained, which could be fed back into the mechanochemical process. This made it possible to reduce the carbon dioxide footprint, as biomass could be permanently converted into coal. In addition, because of the coal, the fertilizers produced were able to intensify the activation of microorganisms in the soil. In addition, it was even possible to use lignite for the mechanochemical process according to the invention.

In particular, it was surprising that in the mechanochemical process, no more polycyclic aromatic hydrocarbons (PAH; PAH), nitrosamines, tars and other harmful substances were formed and no brominated and/or chlorinated dioxins, dibenzofurans and toxic lipophilic compounds, which generate radical oxidative stress (ROS), were formed due to the presence of chlorides and bromides. In addition, drug residues, toxins of all kinds, biocides, viruses, bacteria, algae, poisonous plants and parts thereof, as well as poisonous animals and parts thereof, could be destroyed and eliminated. It was the particular advantage that the mechanochemical process according to the invention converted organic materials of any kind into carbon, in particular activated carbon, which could, for example, be returned to the fourth purification stage of sewage treatment plants or could be used for battery storage. With plastics and increased proportions of sand or cement, new masonry sand and masonry cement could be produced. In particular, the wall cements no longer showed any cement efflorescence and/or cement veils. In addition, the cement could be used as a source of phosphate and as a raw material for the manufacture of fertilizers. Anatas and diamonds could occur as by-products. The powdery products of the mechanochemical process according to the invention could be processed directly into granules and pellets.

The powdery products of the mechanochemical process according to the invention could be used for the production of release agents for plastic molding from membranes of fuel cells, for the recycling of plastics from electronic materials and the production of pure plastics by bacteria.

Furthermore, the mechanochemical process according to the invention could serve to convert thermosets into thermoplastics and/or activate thermosets on their surface through the formation of reactive radical centers and/or functional groups, so that they served as graft bases for the graft copolymerization.

It was also surprising that explosives and pyrotechnic materials could also be disposed of without problems using the mechanochemical method according to the invention.

Overall, the implementation of the mechanochemical process according to the invention required comparatively little energy, lower costs and lower transport costs and contributed to protecting the phosphate reserves.

### DETAILED DESCRIPTION OF THE INVENTION

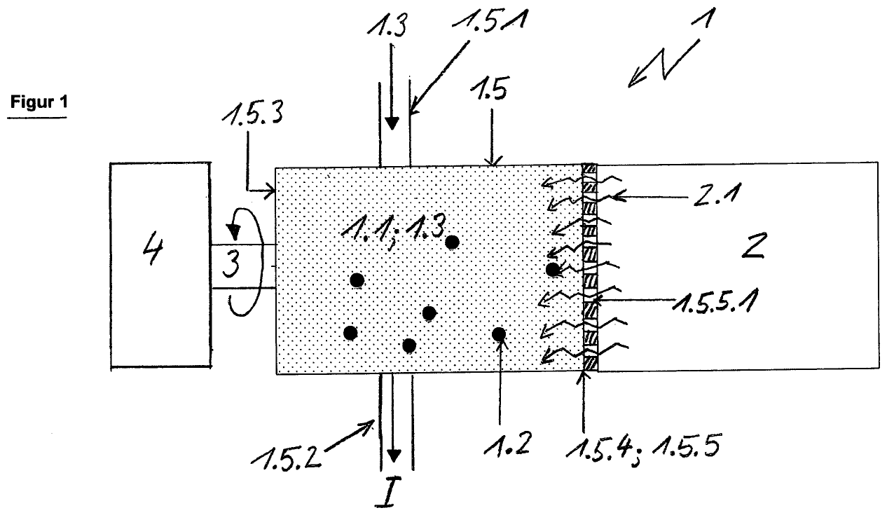

The present invention relates to a mechanochemical process which is carried out with the aid of mechanical mills. The customary and known mechanical mills can be used for the process according to the invention. Examples of suitable mechanical mills are ball mills, hammer mills, pinned disk mills, jet mills, vibration mills, shaking mills, horizontal mills, attritors and planetary mills. For example, the mechanical mill described in the German patent application DE 195 04 540 A1, FIGS. 1a to 4b, can be used.

The means for agitating the grinding media in an energy-rich mass flow together with the grinding stock, in addition to the attritors according to the aforementioned German patent application, can have different shapes which are preferably symmetrical with respect to the at least one, in particular one, drive shaft. These agitation means are preferably made up of metals, alloys, ceramics and with ceramics and coated metals and alloys.

For example, the power transmission can take place through planar striking wings that have at least two striking ends that are arranged symmetrically to the drive shaft so that no imbalance occurs. The striking wings can be arranged on the drive shaft in a gap and/or in congruence and preferably have circular holes in the region of their ends.

However, planar striking disks can also be used which preferably have a circular circumference and preferably have circular, oval, elliptical and/or elongated holes curved parallel to the circumference, which are preferably arranged in a circle and preferably at the same distance from one another. The striking discs can be arranged on the drive shaft in such a way that the holes are in a gap and/or in congruence.

However, the planar striking disks can also have raised webs on their surface, which are arranged symmetrically and run in a straight line and/or preferably curved in the direction of rotation from the drive shaft to the circular edge. The beginnings and the ends of the webs are preferably arranged at the same distance from one another. At least four of these webs are preferably used. In a further embodiment, these webs are arranged on the two opposite sides of the planar striking disks. The webs can have a 4-cornered, a 3-cornered or a semicircular cross-section. The striking disks can be arranged on the drive shaft in such a way that the webs are in a gap and/or in congruence.

The power transmission to the grinding media can, however, also take place by means of striking fans arranged symmetrically to the drive shaft. These are formed by a ring that surrounds the drive shaft and at least two fan-shaped fans radiating from this ring. In a further embodiment, the ring widens on at least two surfaces which are arranged symmetrically to the drive shaft, each of which merges into at least two outwardly radiating striking fans. The edges are preferably curved and lie on an imaginary circle around the entire arrangement. Thus, it can be n-fold single striking fan or n-fold multiple striking fan, where n=at least 2.

In a further embodiment, the striking fans can have raised webs on one side or on two opposite sides, which are arranged symmetrically to one another and extend from the drive shaft to the respective edge of the striking fan. The webs can have triangular, quadrangular or semicircular profiles. In yet another embodiment, these webs can run parallel to the curved edges of the striking fan.

The agitation means described above are preferably spaced apart by at least the width of a grinding body. The width of the agitation means seen in the transverse direction to the drive shaft is preferably 0.1 to 8 times the width of the respective grinding media. The agitation means can be arranged parallel to one another or offset on the drive shaft.

Instead of the agitation means described above, striking clubs can also be used, which are arranged symmetrically and the drive shaft and have the striking bodies which are connected to the ring surrounding the drive shaft by straight or curved rods of equal length or of different lengths. The impact bodies can be cuboid, shovel-shaped, spherical or teardrop-shaped bodies or ellipsoids. So that there is no imbalance when turning, they should preferably have the same weight.

The drive shafts themselves can be spline shafts, hollow shafts, power take-off shafts, worm shafts, conical shafts, conical shafts or triangular shafts.

Instead of the arrangements of a drive shaft and the agitation means described above arranged around it, at least two counter-rotating rollers arranged parallel to one another in the longitudinal direction of the grinding chamber can be used. The grinding material is ground in the area where the rollers touch.

In one embodiment, the rollers are arranged obliquely to the longitudinal axis of the grinding chamber, which results in additional torsion of the ground material.

In yet another embodiment, the roller rotates against an abrasion surface, so that the grinding takes place in the area of contact between the roller and the abrasion surface.

In further embodiments, the surfaces of the rollers and the abrasion surfaces can have structures such as, for example, serrations, nipples and/or depressions.

In a still further embodiment, the impact effect and the fitting fit can be improved by resilience of the roller surface. This can be achieved by virtue of the fact that the rollers as a whole are arranged resiliently against one another. However, individual points on the roll surface can also be designed to be separately resilient. This can be achieved, for example, in that the rollers have depressions in the area of their surface in which balls are arranged which are pressed out of the depressions by spiral springs. The depressions can have a larger clear width than the radius of the ball, so that the grist that gets into the depressions trickles out of the depressions again as the rollers rotate further.

The grinding chamber in which the agitation means are arranged is preferably of tubular design and preferably has a circular circumference. If the rollers described above are used, the grinding space can also be delimited by two opposite, parallel, straight walls which extend at a distance over the width of the rollers and which are connected by two opposite curved walls.

In the longitudinal direction, i.e. seen along the drive shaft, the circumference of the grinding chamber can constrict at least once, so that at least two spherical-shaped grinding chambers arranged one behind the other and connected to one another by a circular opening result. The dimensions of the agitation means are then adapted to the course of the walls in the individual grinding chambers, so that the agitation means are also the largest at the largest diameter of the spherical grinding chambers, with their dimensions decreasing to the left and to the right, following the rounding of the grinding chambers.

The mechanical mills can be powered directly by the energy supplied by wind turbines, water turbines and tidal power plants.

The repulsion motors have proven themselves for the smooth start-up of large mechanical mills. These can then be throttled in their power output during the subsequent continuous operation.

A combination of a powerful motor for starting up, which is switched off after starting, and a weaker motor for continuous operation can also be used.

In addition, gas turbines and internal combustion engines powered by fossil fuels or fuels obtained from biotechnology can be used.

Asynchronous motors, DC motors (commutator motors), AC and three-phase motors, rotating field and traveling field machines, three-phase asynchronous machines, slip-ring motors, three-phase synchronous machines, cascade machines, stepper motors, brushless DC motors, linear motors, AC motors, capacitor motors, synchronous motors, shaded-pole motors are also suitable. Reluctance motors, magnetic motors, transverse flux machines, commutators or commutator machines, DC motors, universal motors (for DC and AC), permanently excited DC motors, electrically excited (separately excited) DC motors, series motors, shunt motors, compound motors, ball bearing motors, unipolar machines, homopolar motors and Barlow wheels.

Electric motors according to the international patent application WO 2017/055246A2 are preferably used. These comprise at least one electrical machine component with at least one winding for generating a magnetic field, which comprises at least one waveguide, which has a jacket and an inner cavity through which a coolant can be conducted, the winding having two ends at which an electrical operating voltage is connected and where

the waveguides are round tube-shaped and have an outer diameter in a range of 3 mm,

the ends of the winding each serve as a coolant inlet or coolant outlet and

the ends of the winding are connected to a connector that includes a coolant inlet and/or a coolant outlet, multiple waveguide connections for connecting waveguides, a distribution channel through which the coolant is fed into at least one waveguide, and/or a collecting channel in which the coolant emerging from at least one waveguide flows in and is directed to the coolant outlet of the connector.

Electric motors of this type are sold by Dynamic E Flow GmbH, Kaufbeuren, Germany, under the Capcooltech® brand. The types HC and LC are preferably used.

However, motors driven by compressed air can also be used, which are particularly useful in explosion-proof areas.

The grinding can take place at a temperature of the grinding media and the ground material from −273° C. to +1200° C. The temperatures in the so-called hotspots and in the plasmas can be up to 15,000° C.

The duration of the grinding can vary widely and can therefore be perfectly adapted to the task at hand. The grinding time is preferably from 0.5 minutes to 1000 hours, more preferably from 10 minutes to 500 hours, particularly preferably from 10 minutes to 100 hours and in particular from 10 minutes to 50 hours.

The grinding can be carried out in the presence of at least one, in particular one, inert substance. Examples of suitable inert substances are gaseous, liquid and solid nitrogen, gaseous, liquid and solid carbon dioxide under conditions under which it is not split into the elements, and sulfur hexafluoride and the gaseous, liquid and solid noble gases neon, argon, krypton and xenon and gaseous and liquid helium.

Preferably, a plasma is present during the grinding inside the mills, i.e., in the grinding room. The plasma can generated by the generation of triboplasm by means of a gas discharge, hotspots, electrostatic charging, emission of exoelectrons, triboluminescence, crystal lattice defects, shredding, dislocations, crystal lattice vibrations, fracture formation, cutting processes, compression, sanding, drilling, grinding, abrasion, high pressures, friction metastable conditions and hotspots due to the collision of the solid bodies and/or the friction of the solid bodies against each other as well as due to catalytically active and/or piezoelectric particles and coatings on the grinding bodies and/or the walls of the grinding chamber and/or on the agitation means and/or in the grinding chamber of the mechanical mills, focused laser radiation, electron radiation, radioactive radiation, X-rays, UV radiation, IR radiation, microwave radiation, ultrasound, chemical and nuclear reactions, electrostatic fields, electromagnetic fields, direct voltage, capacitive electrical excitation, wire explosions, gas discharges, arcs, spark discharges, vacuum spark discharges, cyclotron resonance, capacitive glass tube discharge and the pinch effect.

The radiation can be radiated into the grinding chamber through mechanically stable, scratch-resistant, radiation-permeable windows, via the drive shaft and/or the agitation means.

In addition, IR radiation and UV radiation, preferably with specific wavelengths that stimulate bonds, can be used. Through acoustophoresis or acoustic aggregation, in particular through standing ultrasonic waves, the ground material can be changed during grinding in order to open up new mechanochemical process paths. The resulting nanoparticles and microparticles of the grist can be aggregated again in order to react mechanochemically in a new way.

The plasma is preferably generated by piezoelectric particles. Piezoelectric particles from the group consisting of carbon, quartz, glass, barium titanate (BTO), lead zirconate titanate (PZT), lead magnesium niobate (PMN), gallium orthophosphate, berlinite, tourmaline, seignette salt, piezoelectric thin layers of zinc oxide, aluminum nitride, silicon nitride are particularly preferred. Aluminum oxide, zirconium oxide and titanium nitride, polyvinylidene fluoride (PVDF) and ferroelectric, polycrystalline ceramics. In particular, carbon, quartz and glass are used.

In a particular embodiment, the piezoelectric particles or materials are applied to the surfaces of the grinding media, the walls, the drive shafts and/or the agitation means and/or are introduced into the grinding chambers of the mechanical mills.

The catalytically active particles and/or the coatings can also be applied to the grinding bodies, the drive shafts, the walls of the grinding chamber and/or to the agitation means and/or can be introduced into the grinding chamber of the mechanical mills.

The catalytically active particles from the group consisting of metals, metal alloys, metal compounds and microporous materials are preferably used.

As metals can be used: Actinium, symbol: Ac, atomic number: 89

Aluminum, symbol: AI, atomic number: 13

Americium, symbol: Am, atomic number: 95

Antimony, symbol: Sb, atomic number: 51

Arsenic, symbol: As, atomic number: 33

Astat, symbol: At, atomic number: 85

Barium, symbol: Ba, atomic number: 56

Berkelium, symbol: Bk, atomic number: 97

Beryllium, symbol: Be, atomic number: 4

Bismuth, symbol: Bi, atomic number: 83

Lead, symbol: Pb, atomic number: 82

Bohrium, symbol: Bh, atomic number: 107

Boron, symbol: B, atomic number: 5

Cadmium, symbol: Cd, atomic number: 48

Cesium, symbol: Cs, atomic number: 55

Calcium, symbol: Ca, atomic number: 20

Californium, symbol: Cf, atomic number: 98

Cer, symbol: Ce, atomic number: 58

Chromium, symbol: Cr, atomic number: 24

Cobalt, symbol: Co, atomic number: 27

Copernicium, symbol: Cn, atomic number: 112

Curium, symbol: Cm, atomic number: 96

Darmstadtium, symbol: Ds, atomic number: 110

Dubnium, symbol: db, atomic number: 105

Dysprosium, symbol: Dy, Atomic number: 66

Einsteinium, symbol: Es, atomic number: 99

iron, symbol: Fe, atomic number: 26

Erbium, symbol: Er, atomic number: 68

Europium, symbol: Eu, atomic number: 63

Fermium, symbol: Fm, atomic number: 100

Flerovium, symbol: Fl, atomic number: 114

Francium, symbol: Fr, atomic number: 87

Gadolinium, symbol: Gd, Atomic number: 64

Gallium, symbol: Ga, atomic number: 31

Germanium, symbol: Ge, atomic number: 32

Gold, symbol: Au, atomic number: 79

Hafnium, symbol: Hf, atomic number: 72

Hassium, symbol: Hs, atomic number: 108

Holmium, symbol: Ho, atomic number: 67

Indium, symbol: In, atomic number: 49

Iodine, symbol: I, atomic number: 53

Iridium, symbol: Ir, atomic number: 77

Potassium, symbol: K, atomic number: 19

Carbon, symbol: C, atomic number: 6

copper, symbol: Cu, atomic number: 29

lanthanum, symbol: La, atomic number: 57

Lawrencium, symbol: Lr, atomic number: 103

Lithium, symbol: Li, atomic number: 3

Livermorium, symbol: Lv, atomic number: 116

Lutetium, symbol: Lu, atomic number: 71

Magnesium, symbol: Mg, atomic number: 12

Manganese, symbol: Mn, atomic number: 25

Meitnerium, symbol: Mt, atomic number: 109

Mendelevium, symbol: Md, Atomic number: 101

Molybdenum, symbol: Mo, atomic number: 42

Moscovium, symbol: Mc, atomic number: 115

Sodium, symbol: Na, atomic number: 11

Neodymium, symbol: Nd, atomic number: 60

Neptunium, symbol: Np, atomic number: 93

Nickel, Symbol: Ni, atomic number: 28

Nihonium, symbol: Nh, atomic number: 113

Niobium, symbol: Nb, atomic number: 41

Nobelium, symbol: No, atomic number: 102

ganesson, symbol: Og, atomic number: 118

Osmium, symbol: Os, atomic number: 76

Palladium, symbol: Pd, atomic number: 46

Phosphorus, symbol: P, atomic number: 15

Platinum, symbol: Pt, atomic number: 78

Plutonium, symbol: Pu, atomic number: 94

Polonium, symbol: Po, atomic number: 84

Praseodymium, symbol: Pr, atomic number: 59

Promethium, symbol: Pm, atomic number: 61

Protactinium, symbol: Pa, atomic number: 91

Mercury, symbol: Hg, atomic number: 80

Radium, symbol: Ra, atomic number: 88

Rhenium, symbol R, atomic number: 75

Rhodium, symbol: Rh, atomic number: 45

Roentgenium, symbol: Rg, atomic number: 111

Rubidium, symbol: Rb, atomic number: 37

Ruthenium, Symbol: Ru, atomic number: 44

Rutherfordium, symbol: Rf, atomic number: 104

Samarium, symbol: Sm, atomic number: 62

Scandium, symbol: Sc, atomic number: 21

Seaborgium, symbol: Sg, atomic number: 106

Selenium, symbol: Se, atomic number: 34

Silver, symbol: Ag, atomic number: 47

Silicon, symbol: Si, atomic number: 14

Strontium, symbol: Sr, atomic number: 38

Tantalum, symbol: Ta, atomic number: 73

Technetium, symbol: Tc, atomic number: 43

Tellurium, symbol: Te, atomic number: 52

Tennessium, symbol: Ts, atomic number: 117

Terbium, symbol: Tb, atomic number: 65

Thallium, symbol: TI, atomic number: 81

Thorium, symbol: Th, atomic number: 90

Thulium, symbol: Tm, atomic number: 69

Titanium, symbol: Ti, atomic number: 22

Uranium, symbol: U, atomic number: 92

Vanadium, symbol: V, atomic number: 23

Hydrogen, symbol: H, atomic number: 1

Tungsten, symbol: W, atomic number: 74

Ytterbium, symbol: Yb, atomic number: 70

Yttrium, symbol: Y, atomic number: 39

Zinc, symbol: Zn, atomic number: 30

Tin, symbol: Sn, atomic number: 50

Zirconium, symbol: Zr, atomic number: 40.

When using reactive metals such as alkali and alkaline earth metals and radioactive metals, the appropriate customary and known precautionary measures must be taken.

As metal alloys, the following can be used:

Aluminum Alloys:

Alloys with copper, magnesium, silicon or manganese as the main alloying element; Duralumin is a wrought alloy made from aluminum, copper, magnesium, manganese and silicon, partinium, aluminum-manganese alloy. aluminum-magnesium alloy, Hydronalium: trade name for a cast aluminum alloy with 3-12% magnesium, aluminum-silicon alloy, mainly as a cast alloy, Silumin: brand name for a range of hypoeutectic to eutectic aluminum, silicon casting alloys, aluminum-lithium alloy (which are particularly light), aluminum-zinc-magnesium alloy and Titanal

Lead Alloys;

Hard lead consists of lead and antimony; Shot is an alloy of lead, arsenic and antimony; Tin solder is a lead-tin alloy. for some time now, tin alloys containing copper or silver have also been used; sodium-lead alloys are used as drying agents and in the manufacture of tetraethyl lead.

Bismuth Alloys:

Rose's metal is made up of bismuth, lead, and tin; Wood's metal is made up of bismuth, lead, tin and cadmium, Lipowitz metal, Orion metal, fast solder, Darcotmetall

Cobalt Alloys:

Stellites are hard alloys made from 20-68% cobalt; other essential components in different amounts are chromium, tungsten, nickel, molybdenum and, in some cases, up to 2.5% carbon; Vitallium is a metal alloy made from cobalt, chrome and molybdenum (see chrome-cobalt-molybdenum alloy)

Iron Alloys:

Steel is a collective term for plastically deformable iron-carbon alloys and a maximum of 2.06 percent carbon; cast iron is a collective term for non-plastically deformable iron-carbon alloys and at least 2.06% C (usually around 4% percent carbon; iron-nickel alloy; Invar consists (mainly) of iron and nickel; kovar consists (mainly) of iron, nickel and cobalt; ferro alloy

Aluminum Alloy:

Devarda's alloy

Gallium alloy:

Galinstan is a eutectic alloy of gallium, indium and tin.

Gold Alloys:

Titanium gold: Alloy: 99% gold, 1% titanium, is mainly used in the manufacture of wedding rings and in medical technology, in terms of color, it is comparable to 750 yellow gold, but a little grayer; color gold (general) is an alloy of gold, silver (to lighten the yellow and improve the mechanical workability) and copper (for the “noble” intense gold color or for the red tint); yellow gold: the proportion of silver corresponds to that of copper; red gold: the proportion of silver is significantly lower than that of copper (also known locally as Turkish gold); Russian gold: slightly lighter red gold with the unusual gold content of 583; pale gold: the proportion of silver is much higher than that of copper; green gold: gold with predominantly or exclusively silver, small amounts of cadmium are often added to intensify the green tone, but this has been prohibited throughout the EU since 2011; white gold and gray gold are alloys of gold, with platinum, palladium or silver; but there are also white gold alloys with cobalt, chromium, manganese-germanium and other metals; nickel was also used in the past; Electrum is an alloy of gold and silver that was already known in ancient times, the term is also used for amber, since 1920; Electron has been the protected name for a magnesium alloy from what was then I.G. Fabrbenindustrie, Griesheim plant; Normmetall or Norm-Metall (in Switzerland also: guarantee metal) is an alloy containing gold with less than 333% gold content; hard gold: gold produced by electroplating with small proportions (a few atomic %) of cobalt, nickel or iron.

Copper Alloys:

Bronzes or brasses, with tin determining the bronzes and zinc the brass; bronze (real bronze) is an alloy that consists only of copper and tin; aluminum bronze is an alloy that can consist of copper and aluminum as well as parts of nickel and iron; brass is an alloy of copper and zinc, widely used as a rolling and wrought material with an admixture of lead, including aluminum; copper-rich brass is called tombak; lead bronze is an alloy of copper, tin and lead. Isabellin is an alloy of copper, nickel and manganese, primarily for thermally resistant wires (heating conductor alloy); Constantan is a comparable alloy of copper, nickel and manganese, Nickelin is a comparable alloy of copper, nickel and manganese; German silver (alpaca, pakfong) is an alloy of copper, nickel and zinc; gunmetal is an alloy of copper, tin, zinc and lead used for fittings; beryllium copper made from copper and beryllium was especially used for non-sparking tools in mining; white copper is a light-colored copper-arsenic alloy;

Magnesium Alloy:

Electron is a designation that was protected in the 1920s;

Nickel Based Alloys:

Plessit consists of intergrown kamacite (beam iron) and taenite (band iron) and occurs in nickel-iron meteorites; Chronin refers to alloys made of nickel and chromium; Monel is an alloy of nickel, copper, iron and manganese; Inconel and Incoloy are alloys made of nickel, chromium and up to 5% iron that are heat-resistant up to 800° C.; Supermalloy is an alloy of nickel, iron and molybdenum.

Mercury Alloys:

Silver amalgam; gold amalgam, as a compound of mercury with gold, is not a dedicated alloy, but merely an environmentally harmful intermediate stage in gold extraction;

Silver Alloys:

Sterling silver: alloy with 925/1000 silver that is alloyed with copper or other materials, this alloy is mostly used to make coins, jewelry and cutlery; Vermeil: silver that has been fire-gilded; Niello (tula silver): (mainly used in the Middle Ages for works of art and tableware) is made with silver, copper, lead, sulfur and ammonium chloride; Tibet silver: alloy with a very low silver content of 250/1000;

Tungsten Alloys or Composites:

Tungsten is one of the refractory metals which, due to their high melting point (SMWungsten=3422° C.), can only be alloyed with other metals with difficulty and is therefore sintered to give composite materials such as hard metals for machining materials; Widia, is the protected name for a hard metal consisting of tungsten, cobalt, carbon and titanium; a tungsten-silver composite is also misleadingly referred to as a sweat-cooling alloy; the real alloys, on the other hand, include tungsten-molybdenum alloys, high-density tungsten alloys with the alloy components nickel, copper, iron, and molybdenum in varying compositions; as an alloying element with a share of a few percent by weight, tungsten is usually a component of both high-quality steels (see also list of alloying elements) and wire alloys used for lighting purposes (e.g. the Osram® brand as a composition of osmium and tungsten).

Zinc Alloy:

Zamak alloy; fine zinc—cast alloys are mainly used for die-cast parts, including those in fine casting; titanium zinc is a zinc alloy that is preferred for galvanizing and has a very low copper and titanium content; Alzen (ZnAI35), also Alzeen, are brand names for zinc-aluminum alloys;

Tin Alloys:

Britannia metal is an alloy of 90-95% tin with up to 9% antimony and one percent copper; according to the “Foundry Lexicon” (formerly) used for household goods and decorative objects (“false bronzes”); hard tin (Pewter) is an alloy of tin, copper and/or lead; tin solder is a lead-tin alloy, for some time now, tin alloys containing copper or silver have also been used; “Potin gris” is a historical French bronze (copper alloy with a proportion of tin);

Intermetallic Compounds:

Zintd phases; Laves phases; Hune-Rothery phases.

Magnetic and Magnetizable Alloys:

Alloys of iron with at least one metal selected from the group consisting of ruthenium, osmium, cobalt, rhodium, iridium, nickel, palladium, platinum, copper, silver, gold, zinc, cadmium, scandium, yttrium, lanthanum, cerium, praseodymium, neodymium, samarium, europium, gadolinium, terbium oxide, dysprosium, holmium, erbium, thulium, ytterbium, lutetium, titanium, zirconium, hafnium, vanadium, niobium, tantalum, chromium, molybdenum, tungsten, manganese, rhenium, aluminum, Gallium, indium, thallium, germanium, tin, lead, antimony and bismuth; Examples of suitable metal alloys are soft magnetic metal alloys such as Permalloy® based on nickel and iron, nickel-iron-zinc alloys or Sendust based on aluminum, silicon and iron; RE_{1-y}Fe_{100-v-w-x-z}Co_{w}M_{z}Bₓ, where RE is a rare earth metal from the group consisting of cerium, praseodymium, neodymium, samarium, europium, gadolinium, terbium oxide, terbium oxide, dysprosium, holmium, erbium, thulium, ytterbium and lutetium and M for a metal from the group titanium, zirconium, hafnium, vanadium, niobium, tantalum, chromium, and M is molybdenum and tungsten and v=5-15, w>5, x=9-30, y=0.05-0.5 and z=0.1-5; the above-mentioned metals and metal alloys can contain at least one further metal and/or non-metal that is selected from the group consisting of lithium, sodium, potassium, rubidium, cesium, beryllium, magnesium, calcium, strontium, barium, boron, carbon, Silicon, nitrogen, phosphorus, arsenic, oxygen, sulfur, selenium, tellurium, fluorine, chlorine, bromine and iodine, is selected or are contained in non-stoichiometric amounts. A particularly suitable material of this type is NdFeB.

Examples of suitable catalytic metal compounds are the borides, oxides, sulfides, selenides, tellurides, carbides, silicides, germanides, nitrides, phosphides, arsenides, antimonides, fluorides, chlorides, bromides and iodides, coordination compounds with organic and/or inorganic ligands, isopolyacids and heteropolyacids (Polyoxometalates; POM) as well as covalent organic metal organyls, sandwich compounds and carbenes.

In particular, hematite, non-stoichiometric hematites, ferrites, nickel ferrites, nickel salts and polyoxometalates (POM) are used.

Examples of suitable POM are known from the international patent application WO 2016/116259 A1, page 14, line 32, to page 23, line 17, and in particular from Table 1, “Sum Formulas of Suitable POM”.

Examples of suitable microporous materials are zeolites and metal-organic frameworks (metal-organic frameworks; MOFs). Zinc-modified zeolites are used in particular.

By grinding, the catalytically active particles, nanoparticles and microparticles are generated and/or the surfaces of the drive shafts, walls, grinding media, agitation means and/or rollers are repeatedly activated, which increases the catalytic effects. The metals and metal alloys are also repeatedly generated anew through the reduction with the aid of the carbonaceous materials present. This can result in new active centers on the catalysts due to torsion and lattice defects, and they can be supplied with electrons for redox reactions through piezoelectric properties.

The grinding media or grinding balls consist of a high and low temperature resistant, impact-resistant, abrasion-resistant material with a high hardness and a very high melting point. Suitable grinding media consist, for example, of aluminum oxide, steatite, porcelain, zirconium oxide, glass, flint stone, steels, chromium steels, tungsten carbide, silicon carbide, silicon nitride, boron nitride or boron carbide, or they contain these materials.

The grinding media can have any diameter, depending in particular on the size and construction of the mill, the type of acceleration, for example, by rotating the mill wall, by rotating or vibrating the container surrounding the grinding chamber, by centrifugal forces, by compressed air, by impacts or by electrostatic and/or magnetic attraction as well as on the materials to be ground. The diameter can therefore be optimally adapted to the particular task in an advantageous manner. The diameters are preferably from 0.5 cm to 10 cm.

The grinding media can be spheres or ellipsoids or have irregular shapes, so that there are different contact options per collision. In addition, the grinding media can have smooth or roughened surfaces or have cup-shaped depressions such as a golf ball, in which case ground material can accumulate in the cups. The surface of the grinding media can have a layer of the ground material or be doped with it.

Grinding balls are preferably used as grinding media.

If, on the other hand, the rollers described above are used for grinding the material to be ground, none of the grinding media described above are used. The rollers, which can be solid or hollow, are preferably constructed from the same hard materials as the grinding media.

The mechanochemical process according to the invention is used for the decontamination, elimination, regeneration, immobilization, digestion and/or conversion into products of value of natural, synthetic, biogenic and biological materials or milled materials, for immobilizing metals and their compounds, for digesting phosphates, for splitting carbon dioxide and carbon monoxide into the elements and for obtaining valuable products. The said materials preferably contain phosphates, in particular vitreous phosphates, which can be recovered again in biologically available form with the aid of the mechanochemical method according to the invention.

In the first process step of the mechanochemical process according to the invention, at least one, in particular a suspension or pasty mixture, at least one, in particular a finely divided solid mixture and/or at least one, in particular one, gas is provided as the ground material.

In the context of the present invention, a solid material or a solid mixture is regarded as finely divided if it consists of particles with an average particle size d₅₀ of 1 nm to 2 cm.

The at least one finely divided solid mixture, which is either suspended or in the form of a paste or as a finely divided solid powder, preferably contains at least one material which contains or consists of at least one, in particular one, phosphate.

The at least one material is preferably selected from the group consisting of natural, synthetic, biogenic and biological materials that are contaminated, ecologically problematic and questionable, harmful, intensely smelling, toxic, flammable, oxidising, radioactive and/or explosive, mixtures and waste as well contaminated mineral coals, biochars, activated carbons and carbon suppliers.

The materials from the group consisting of dried slurry, liquid manure, fermentation residues, dry ferments, sewage sludge, ferments, composts, biowaste, vegetable waste, leaves, sawn timber, construction timber, mash, pomace, food industry waste, biotechnological waste, genetic engineering waste, animal waste, waste from metal extraction, radioactive waste, waste from carbon fiber-reinforced plastics (CFRP), celluloses, hemicelluloses, liginocelluloses, celluloses, hemicelluloses and/or biomass and waste containing liginocelluloses, high-molecular-weight proteins and structural proteins, dry concentrates from the biological stage of sewage treatment plants, chemical washers and filters, waste water, residues of the exhaust air treatment, nitrogen compounds, sulfur compounds, phosphorus compounds, polycyclic aromatic hydrocarbons (PAH), volatile organic compounds (VOC), reactive gases, medical products, hormones, micropollutants, phosphate-containing building materials, phosphate-containing body parts, phosphate-containing food and feed, other phosphate sources, synthetic and natural, intensely smelling substances, synthetic and natural toxins, biocides, pyrotechnic materials, explosives, viruses, bacteria, mycoplasmas, prions, algae, poisonous plants and parts thereof and poisonous animals and parts thereof.

In particular, the nitrogen compounds from the group consisting of ammonia, aliphatic amines, cycloaliphatic amines, olefinically unsaturated amines, aromatic amines, saturated, unsaturated and aromatic heterocyclic amines and their ammonium compounds, amides, amine oxides, ammine complexes, azo compounds, carbodiimides, hydrazines, hydrazones, Hydrazide hydrazones, guanidines, ureas, biurets, triurets, semicarbazides, carbodiazones, carbazidic acid derivatives, isosemicarbazides, imines, isocyanides, N-hydroxy compounds, carboxamides, carboxylic acid hydrazides, imide, hydrazone, nitrosene compounds, nitramic acids, nitrosenic acids, nitramic acids, nitrosene and nitramic acids, Nitrosyl compounds, nitro compounds, tetrazene and urethanes. In particular, the nitrogen compounds are nitrates, nitrites and nitrosamines.

In particular, the sulfur compounds are selected from the group consisting of the allotropes of sulfur, hydrogen sulfide, thiols, sulfides, sulfur halides, sulfoxides, sulfones, sultones, sulfuric acid esters, sulfonic acids, sulfonic acid esters, sulfur-nitrogen compounds and sulfonium compounds.

In particular, the phosphorus compounds are selected from the group consisting of phosphorus allotropes, phosphines, phosphonium compounds, phosphites, phosphates, phosphonates, phosphorus halides and phosphazenes, but in particular phosphates.

In particular, the fluids are selected from the group consisting of industrial solvents and residues of industrial solvents, in particular solvents from the paint industry, the automotive industry, chip manufacture and industrial low-molecular and high-molecular organic synthesis.

In particular, the volatile organic compounds (VOC) from the group consisting of aldehydes and ketones such as ethanal, propionaldehyde, thioaldehyde, butyraldehyde, heptanal, methyl ethyl ketone, cyclohexanone and formaldehyde, alkanes and cycloalkanes such as hexane, heptane, octane, nonane, decane, cyclohexanone and methylcyclohexane, aromatics such as benzene, toluene, ethylbenzene, xylene, cresol and styrene, phenols such as phenol and cresol, volatile halogenated hydrocarbons (LHKW) such as partially and fully chlorinated hydrocarbons, fluorinated hydrocarbons and chlorofluorocarbons, chlorofluorocarbons, chlorofluorocarbons, chlorofluorocarbons, trifluorochloromethane, carbon tetrachloro, chlorofluorofluorocarbons, tetrachloroethane and dichlorobenzene.

In particular, the reactive gases, which are not mentioned above, from the group consisting of methane, ethane, propane, butane, ethylene, propylene, hydrogen cyanide, dicyan, phosgene, acetylene, vinyl fluoride, vinyl chloride, vinylidene chloride, vinylidene fluoride, nitrogen trifluoride, tetrafluorohydrazine, cis- and trans-difluorodiazine, sulfur tetrafluoride and carbon monoxide.

Under the right conditions, carbon dioxide is also a reactive gas.

In particular, the PAH from the group consisting of pentalene, indene, naphthalene, azulene, heptalene, biphenylene, asymmetrical indacene, symmetrical indacene, acenaphthylene, fluorene, phenals, phenanthrene, anthracene, acephenanthrylene, aceanthrylene, triphenylene, pyrene, chrysene, naphthacene Pleiades, picene, perylene, pentaphene, pentacene, tetraphenylene, hexaphene, hexacene, rubicene, coronene, trinaphthylene, heptaphene, heptacene, octacene, ovals, superphenals, benzo [a] anthracene, benzob [b] fluoranthene, benzo [k] fluoranthene, Benzo [a] pyrene, dibenzo [a,h] anthracene, indeno [1,2,3-cd] pyrene and benzo[ghi]perylene.

In particular, the medical devices from the group consisting of the drugs, including hormones, that are listed in the “YELLOW LIST Pharnmaindex” and the “Red List”, drugs not approved for human use, veterinary drugs, drugs in the research stage, in development and in clinical tests as well as their wastes and their metabolites.

In particular, the micropollutants are selected from the group consisting of medical devices, industrial chemicals and hormones in concentrations from pg/liter to ng/liter and microplastics. In particular, the phosphate-containing building materials are selected from the group consisting of phosphate-containing cements, concretes, bricks, artificial stones, stones, boards, composite materials with wood and annular gap mortar.

In particular, the other sources of phosphate are selected from the group consisting of detergents, anti-corrosion agents, teeth, tooth meal, bones, bone meal, apatite and hydroxyapatite.

In particular, the phosphate-containing foods and feeds are selected from the group consisting of dairy products, sausage products, lemonades, ready meals, canned fish and phosphate-containing feeds for animals.

In particular, the intensely smelling substances are selected from the group consisting of synthetic, organic and inorganic nitrogen, sulfur, selenium, tellurium, phosphorus and arsenic compounds, animal-friendly and antiphatic fragrances and plant-based sympathetic and antiphatic fragrances.

In particular, the synthetic toxins are selected from the group consisting of warfare agents, potassium cyanide, beryllium, selenium, tellurium, thallium, white phosphorus, arsenic, arsenic compounds, cadmium, mercury, mercury compounds, polonium, plutonium and polyhalogenated aromatics, dioxins and dibenzofurans.

In particular, the natural toxins are selected from the group consisting of vegetable, animal, fungal and bacterial toxins and algae toxins.

In particular, the biocides from the group consisting of pesticides, herbicides, virucides against viruses, bactericides against bacteria, acaricides against mites, algaeides, fungicides against fungi, insecticides against insects, microbicides against germs, molluscicides against snails, nematicides against roundworms (nematodes), rodenticides against rodents, avicides against birds and piscicides against fish.

In particular, the pyrotechnic materials are selected from the group consisting of fireworks and theatrical fireworks and the oxidizing agents, fuels and auxiliaries used therein.

In particular, the explosives are selected from the group consisting of chlorates, perchlorates, xenon oxides, organic and inorganic nitrogen halogen compounds, peroxides, nitric acid esters, nitro compounds, nitramines, nitrosamines, high-energy nitrogen compounds, initial explosives and low-smoke powders. Examples of such explosives are described, for example, in the textbook by Thomas M. Klapotke, Chemistry of High-Energy Materials, Walter de Gruyter, Berlin/New York, 2011.

In particular, the poisonous plants and the parts thereof are selected from the group consisting of the plants blue monkshood, dog parsley, arum, deadly nightshade, angel's trumpet, brunfelsia, boxwood, tumbled calf crop, water hemlock, autumn crocus, hemlock, spotted hemlock, lily of the valley, cyclamen, common sea apple, High delphinium, red foxglove, dieffenbachia, worm ferns, gold lacquer, Californian poppy seeds, peacock cones, poinsettia, rubber tree, crown of fame, ivy, smelly hellebore, christmas rose, hogweed, hyacinth, henbane, holly, iris, laburnum, tobacco, bleeding heart, oleander single berry, kidney bean, bracken, apricot, apricot, cherry laurel, buttercup, rhubarb, wonder tree, rhododendron, robinia, elder, bitter-sweet nightshade, potato, Ignatius peanut, tansy, bell tree, ongaonga, white germer, wisteria, tomato, aubergine and yew tree.

In particular, the poisonous animals and parts thereof are selected from the group consisting of sponges, flower animals, hydrozoans, umbrella jellyfish, poly-bristles, snails, cephalopods, insects, arachnids, fish, amphibians, reptiles, birds and mammals.

Examples of structural proteins are keratin of the hair, nails, hooves and horns of mammals, of the feathers of birds and scales of reptiles, collagen of the connective tissue and the extracellular matrix of all tissue animals, elastin, fibrillar (fibrous) structural proteins such as myosin and tropomyosin, which cause contraction the muscle cells (these are usually referred to as movement proteins), fibroin silk proteins from insects (fibroin and sericin) or spiders (spidroin 1 and spidroin 2), arthropodin and sclerotin (phenol-tanned arthropodin), in addition to chitin, the main component of the body shell (cuticle) Arthropods, centrioles and microtubules of most living things and microfilaments of the cytoskeleton of most living things.

The carbon-supplying materials from the group consisting of the above-described plant materials as well as husks, wood shavings, sawdust, hay, grass, grain, awns, silage, nutshells, bark, dried leaves and needles and natural fibers such as seed fibers such as cotton (CO), Kapok (KP), poplar fluff, acon, bamboo fibers, nettle fibers, hemp fibers (HA), jute (JU), kenaf, linen (LI), hops, ramie (RA) and hemp, hard fibers such as pineapple, carog, curauA, henequen, New Zealand flax, sisal (Sl) and coconut (CC) and fibers made from natural polymers such as cellulosic fibers such as viscose (CV), modal (CMD), lyocell (CLY), cupro (CUP), acetate (CA) and triacetate (CTA) selected.

In addition, the at least one preferably phosphate-containing material contains at least one type of carbon selected from the group consisting of pure, finely divided mineral coal, pure, finely divided biochar, pure, finely divided activated carbon, contaminated, finely divided mineral coal, contaminated, finely divided biochar, contaminated, finely divided activated carbon, finely divided lignite and pure and contaminated finely divided carbon suppliers and from the aforementioned moistened materials.

The at least one, in particular one finely divided solid mixture can furthermore contain at least one solid, finely divided or, in the case of the at least one suspension, at least one dissolved, emulsified or suspended additive that differs from the materials described above. Preferably, at least one additive from the group consisting of inorganic and organic salts, acids, bases, oxides, reducing agents, oxidizing agents, water vapor, superheated steam, zeolites and sheet silicates is added. Examples of suitable inorganic and organic salts are the lithium, sodium, potassium, magnesium and calcium salts of hydrochloric acid, sulfuric acid, nitric acid, nitrous acid, acetic acid, propionic acid, butyric acid, benzoic acid, benzenesulfonic acid and benzenephosphonic acid. Examples of suitable acids are those mentioned above. Examples of suitable bases are lithium, sodium, potassium, magnesium and calcium hydroxide. Examples of suitable oxides are the iron oxides, aluminum oxide, gallium oxide, indium oxide, silicon oxide, sands, germanium oxide, tin oxide, lead oxide, antimony oxide and bismuth oxide. Examples of suitable reducing agents are hydrogen, lithium aluminum nitride, sodium borohydride, sodium sulfite, sodium dithionite and sodium thiosulfate. Examples of suitable oxidizing agents are oxygen, hydrogen peroxide and organic peroxides, sodium percarbonate, potassium permanganate, potassium dichromate and the halogens.

The oxidizing agents mentioned have the advantage that they can provide the carbons with functional groups that improve adsorption and chemisorption and open up new reaction paths.

In particular, sodium chloride, potassium chloride and sheet silicates are used.

The phyllosilicates are preferably nanoparticles and/or microparticles with a mean particle size d₅₀ of 1 nm to <1000 μm, preferably 10 nm to 900 μm, in particular 300 nm to 1000 nm, particularly in particular 650±200 nm, very particularly in particular 650±150 nm and in particular 650±100 nm.

The elemental composition and the structure of the layered silicate micro- and/or nanoparticles can also vary very widely. For example, the classification of silicates into the following structures is known:

Island silicates

Group silicates

Ring silicates

Chain and band silicates

Transition structures between chain and layered silicates

Layered silicates

Framework silicates.

Layered silicates are silicates whose silicate ions consist of layers of corner-linked SiO₄-tetrahedra. These layers and/or double layers are not further linked to one another. The technically important clay minerals found in sedimentary rocks are also sheet silicates. The layered structure of these minerals determines the shape and properties of the crystals. They are usually tabular to leafy with good to perfect cleavage parallel to the layers. The number of positions in the rings that make up the silicate layers often determines the symmetry and shape of the crystals. Water molecules, large cations and/or lipids can accumulate between the layers.

Examples of suitable sheet silicates are shown in Table 1 below. The list is exemplary and not exhaustive.

TABLE 1
Molecular Formulas of Phyllosilicates ^{a)}

| No. | Type | Molecular formular |
|---|---|---|
| 1 | Martinite | (Na,Ca)₁₁Ca₄(Si,S,B)₁₄B₂O₄₀F₂•4(H₂O) |
| 2 | Apophyllite-(NaF) | NaCa₄Si₈O₂₀F•8H₂O |
| 3 | Apophyllite-(KF) | (K,Na)Ca₄Si₈O₂₀(F,OH)•8H₂O |
| 4 | Apophyllite-(KOH) | KCa₄Si₈O₂₀(OH,F)•8H₂O |
| 5 | Cuprorivaite | CaCuSi₄O₁₀ |
| 6 | Wesselsite | (Sr,Ba)Cu[Si₄O₁₀] |
| 7 | Effenbergerite | BaCu[Si₄O₁₀] |
| 8 | Gillespite | BaFe²⁺Si₄O₁₀ |
| 9 | Sanbomite | BaSi₂O₅ |
| 10 | Bigcreekite | BaSi₂O₅•4H₂O |
| 11 | Davanite | K₂TiSi₆O₁₅ |
| 12 | Dalyite | K₂ZrSi₆O₁₅ |
| 13 | Fenaksite | KNaFe²⁺Si₄O₁₀ |
| 14 | Manaksite | KNaMn²⁺[Si₄O₁₀] |
| 15 | Ershovite | K₃Na₄(Fe,Mn,Ti)₂[Si₈O₂₀(OH)₄]•4H₂O |
| 16 | Paraershovite | Na₃K₃Fe³⁺₂Si₈O₂₀(OH)₄•4H₂O |
| 17 | Natrosilite | Na₂Si₂O₅ |
| 18 | Kanemite | NaSi₂O₅•3H₂O |
| 19 | Revdite | Na₁₆Si₁₆O₂₇(OH)₂₆•28H₂O |
| 20 | Latiumite | (Ca,K)₄(Si,Al)₅O₁₁(SO₄,CO₃) |
| 21 | Tuscanite | K(Ca,Na)₆(Si,Al)₁₀O₂₂(SO₄,CO₃,(OH)₂)•H₂O |
| 22 | Carletonite | KNa₄Ca₄Si₈O₁₈(CO₃)₄(OH,F)•H₂O |
| 23 | Pyrophyllite | Al₂Si₄O₁₀(OH)₂ |
| 24 | Ferripyrophyllite | Fe³⁺Si₂O₅(OH) |
| 25 | Macaulayite | (Fe³⁺,Al)₂₄Si₄O₄₃(OH)₂ |
| 26 | Talc | Mg₃Si₄O₁₀(OH)₂ |
| 27 | Minnesotaite | Fe²⁺₃Si₄O₁₀(OH)₂ |
| 28 | Willemseite | (Ni,Mg)₃Si₄O₁₀(OH)₂ |
| 29 | Pimelite | Ni₃Si₄O₁₀(OH)₂•4H₂O |
| 30 | Kegelite | Pb₄Al₂Si₄O₁₀(SO₄)(CO₃)₂(OH)₄ |
| 31 | Aluminoseladonite | K(Mg,Fe²⁺)Al[(OH)₂\|Si₄O₁₀] |
| 32 | Ferroaluminoseladonite | K(Fe²⁺,Mg)(Al,Fe³⁺)[(OH)₂\|Si₄O₁₀] |
| 33 | Seladonite | K(Mg,Fe²⁺)(Fe³⁺,Al)Si₄O₁₀(OH)₂ |
| 34 | Chromseladonite | KMgCr[(OH)₂\|Si₄O₁₀] |
| 35 | Ferroseladonite | K(Fe²⁺,Mg)(Fe³⁺,Al)[(OH)₂\|Si₄O₁₀] |
| 36 | Paragonite | NaAl₂(Si₃Al)O₁₀(OH)₂ |
| 37 | Boromuskovite | KAl₂(Si₃B)O₁₀(OH,F)₂ |
| 38 | Muskovite | KAl₂(Si₃Al)O₁₀(OH,F)₂ |
| 39 | Chromphyllite | K(Cr,Al)₂[(OH,F)₂\|AlSi₃O₁₀] |
| 40 | Roscoelithe | K(V,Al,Mg)₂AlSi₃O₁₀(OH)₂ |
| 41 | Ganterite | (Ba,Na,K)(Al,Mg)₂[(OH,F)₂\|(Al,Si)Si₂O₁₀] |
| 42 | Tobelithe | (NH₄,K)Al₂(Si₃Al)O₁₀(OH)₂ |
| 43 | Nanpingite | CsAl₂(Si,Al)₄O₁₀(OH,F)₂ |
| 44 | Polylithiontie | KLi₂AlSi₄O₁₀(F,OH)₂ |
| 45 | Tainiolithe | KLiMg₂Si₄O₁₀F₂ |
| 46 | Norrishite | KLiMn³⁺₂Si₄O₁₂ |
| 47 | Shirokshinite | KNaMg₂[F₂\|Si₄O₁₀] |
| 48 | Montdorite | KMn_{0.5}²⁺Fe_{1.5}²⁺Mg_{0.5}[F₂\|Si₄O₁₀] |
| 49 | Trilithionite | KLi_{1.5}Al_{1.5}[F₂\|AlSi₃O₁₀] |
| 50 | Masutomilithe | K(Li,Al,Mn²⁺)₃(Si,Al)₄O₁₀(F,OH)₂ |
| 51 | Aspidolithe-1M | NaMg₃(AlSi₃)O₁₀(OH)₂ |
| 52 | Fluorophlogopite | KMg₃(AlSi₃)O₁₀F₂ |
| 53 | Phlogopite | KMg₃(Si₃Al)O₁₀(F,OH)₂ |
| 54 | Tetraferriphlogopite | KMg₃[(F,OH)₂\|(Al,Fe³⁺)Si₃O₁₀] |
| 55 | Hendricksite | K(Zn,Mn)₃Si₃AlO₁₀(OH)₂ |
| 56 | Shirozulithe | K(Mn²⁺,Mg)₃[(OH)₂\|AlSi₃O₁₀] |
| 57 | Fluorannit | KFe3²⁺[(F,OH)₂\|AlSi₃O₁₀] |
| 58 | Annite | KFe²⁺₃(Si₃Al)O₁₀(OH,F)₂ |
| 59 | Tetraferriannite | KFe²⁺₃(Si₃Fe³⁺)0₁₀(OH)₂ |
| 60 | Ephesite | NaLiAl₂(Al₂Si₂)O₁₀(OH)₂ |
| 61 | Preiswerkite | NaMg₂Al₃Si₂O₁₀(OH)₂ |
| 62 | Eastonite | KMg₂Al[(OH)₂\|Al₂Si₂O₁₀] |
| 63 | Siderophyllite | KFe₂²⁺Al(Al₂Si₂)O₁₀(F,OH)₂ |
| 64 | Anandite | (Ba,K)(Fe²⁺,Mg)₃(Si,Al,Fe)₄O₁₀(S,OH)₂ |
| 65 | Bityite | CaLiAl₂(AlBeSi₂)O₁₀(OH)₂ |
| 66 | Oxykinoshitalithe | (Ba,K)(Mg,Fe²⁺,Ti⁴⁺)₃(Si,Al)₄O₁₀O₂ |
| 67 | Kinoshitalithe | (Ba,K)(Mg,Mn,Al)₃Si₂Al₂O₁₀(OH)2 |
| 68 | Ferrokinoshitalithe | Ba(Fe²⁺,Mg)₃[(OH,F)₂\|Al₂SiO₁₀] |
| 69 | Margarite | CaAl₂(Al₂Si₂)O₁₀(OH)₂ |
| 70 | Chemykhite | BaV₂(Si₂Al₂)O₁₀(OH)₂ |
| 71 | Clintonite | Ca(Mg,Al)₃(Al₃Si)O₁₀(OH)₂ |
| 72 | Wonesite | (Na,K,)(Mg,Fe,Al)₆(Si,Al)₈O₂₀(OH,F)₄ |
| 73 | Brammallite | (Na,H₃O)(Al,Mg,Fe)₂(Si,Al)₄O₁₀[(OH)₂,H₂O] |
| 74 | Illite | (K,H₃O)Al₂(Si₃Al)O₁₀(H₂O,OH)₂ |
| 75 | Glaukonite | (K,Na)(Fe³⁺,Al,Mg)₂(Si,Al)₄O₁₀(OH)₂ |
| 76 | Agrellite | NaCa₂Si₄O₁₀F |
| 77 | Glagolevite | NaMg₆[(OH,O)₈\|AlSi₃O₁₀]•H₂O |
| 78 | Erlianite | Fe²⁺₄Fe³⁺₂Si₆O₁₅(OH)₈ |
| 79 | Bannisterite | (Ca,K,Na)(Mn²⁺,Fe²⁺,Mg,Zn)₁₀(Si,Al)₁₆O₃₈(OH)₈•nH₂O |
| 80 | Bariumbannisterite | (K,H₃O)(Ba,Ca)(Mn²⁺,Fe²⁺,Mg)₂₁(Si,Al)₃₂O₈₀(O,OH)₁₆•4-12 H₂O |
| 81 | Lennilenapeite | K₆₋₇(Mg,Mn,Fe²⁺,Fe³⁺,Zn)₄₈(Si,Al)₇₂(O,OH)₂₁₆•16H₂O |
| 82 | Stilpnomelane | K(Fe²⁺,Mg,Fe³⁺,Al)₈(Si,Al)₁₂(O,OH)₂₇•2H₂O |
| 83 | Franklinphilite | (K,Na)₁₋ₓ(Mn²⁺,Mg,Zn,Fe³⁺)₈(Si,Al)₁₂(O,OH)₃₆•nH₂O |
| 84 | Parsettensite | (K,Na,Ca)_{7.5}(Mn,Mg)₄₉Si₇₂O₁₆₈(OH)₅₀•nH₂O |
| 85 | Middendorfite | K₃Na₂Mn₅Si₁₂(O,OH)₃₆•2H₂O |
| 86 | Eggletonite | (Na,K,Ca)₂(Mn,Fe)₈(Si,Al)₁₂O₂₉(OH)₇•11H₂O |
| 87 | Ganophyllite | (K,Na)ₓMn²⁺₆(Si,Al)₁₀O₂₄(OH)₄•nH₂O {x = 1-2}{n = 7-11} |
| 88 | Tamaite | (Ca,K,Ba,N₃₋₄Mn²⁺₂₄[(OH)₁₂\|{Si,Al)₄(O,OH)₁₀}₁₀]•21H₂O |
| 89 | Ekmanite | (Fe²⁺,Mg,Mn,Fe³⁺)₃(Si,Al)₄O₁₀(OH)₂•2H₂O |
| 90 | Lunijianlaite | Li_{0.7}Al_{6.2}(Si₇AlO₂₀)(OH,O)₁₀ |
| 91 | Saliotite | Na_{0.5}Li_{0.5}Al₃[(OH)₅\|AlSi₃O₁₀] |
| 92 | Kulkeite | Na_{0.35}Mg₈Al(AlSi₇)O₂₀(OH)₁₀ |
| 93 | Aliettite | Ca_{0.2}Mg₆(Si,Al)₈O₂₀(OH)₄•4H₂O |
| 94 | Rectorite | (Na,Ca)Al₄(Si,Al)₈O₂₀(OH)₄•2H₂O |
| 95 | Tarasovite | (Na,K,H₃O,Ca)₂Al₄[(OH)₂\|(Si,Al)₄O₁₀]₂•H₂O |
| 96 | Tosudite | Na_{0.5}(Al,Mg)₆(Si,Al)₈O₁₈(OH)₁₂•5H₂O |
| 97 | Corrensite | (Ca,Na,K)(Mg,Fe,Al)₉(Si,Al)₈O₂₀(OH)₁₀•nH₂O |
| 98 | Brinrobertsite | (Na,K,Ca)_{0.3}(Al,Fe,Mg)₄(Si,Al)₈O₂₀(OH)₄•3.5H₂O |
| 99 | Montmorillonite | (Na,Ca)_{0.3}(Al,Mg)₂Si₄O₁₀(OH)₂•nH₂O |
| 100 | Beidellite | (Na,Ca_{0.5})_{0.3}Al₂(Si,Al)₄O₁₀(OH)₂•4H₂O |
| 101 | Nontronite | Na_{0.3}Fe₂³⁺(Si,Al)₄O₁₀(OH)₂•4H₂O |
| 102 | Volkonskoite | Ca_{0.3}(Cr³⁺Mg,Fe³⁺)₂(Si,Al)₄O₁₀(OH)₂•4H₂O |
| 103 | Swinefordite | (Ca,Na)_{0.3}(Al,Li,Mg)₂(Si,Al)₄O₁₀(OH,F)₂•2H₂O |
| 104 | Yakhontovite | (Ca,Na,K)_{0.3}(CuFe²⁺Mg)₂Si₄O₁₀(OH)₂•3H₂O |
| 105 | Hectorite | Na_{0.3}(Mg,Li)₃Si₄O₁₀(F,OH)₂ |
| 106 | Saponite | (Ca\|2,Na)_{0.3}(Mg,Fe²⁺)₃(Si,Al)₄O₁₀(OH)₂•4H₂O |
| 107 | Ferrosaponite | Ca_{0.3}(Fe²⁺Mg,Fe³⁺)₃[(OH)₂\|(Si,Al)Si₃O₁₀]•4H₂O |
| 108 | Spadaite | MgSiO₂(OH)₂•H₂O |
| 109 | Stevensite | (Ca\|₂)_{0.3}Mg₃Si₄O₁₀(OH)₂ |
| 110 | Sauconite | Na_{0.3}Zn₃(Si,Al)₄O₁₀(OH)₂•4H₂O |
| 111 | Zinksilite | Zn₃Si₄O₁₀(OH)₂•4H₂O |
| 112 | Vermiculite | Mg_{0.7}(Mg,Fe,Al)₆(Si,Al)₈O₂₀(OH)₄•8H₂O |
| 113 | Rilandite | (Cr³⁺,Al)₆SiO₁₁•5H₂O |
| 114 | Donbassite | Al_{2.3}[(OH)₈\|AlSi₃O₁₀] |
| 115 | Sudoite | Mg₂Al₃(Si₃Al)O₁₀(OH)₈ |
| 116 | Klinochlore | (Mg,Fe²⁺)₅Al(Si₃Al)O₁₀(OH)₈ |
| 117 | Chamosite | (Fe²⁺,Mg,Fe³⁺)₅Al(Si₃Al)O₁₀(OH,O)₈ |
| 118 | Orthochamosite | (Fe²⁺Mg,Fe³⁺)₅Al(Si₃Al)O₁₀(OH,O)₈ |
| 119 | Baileychlore | (Zn,Fe²⁺,Al,Mg)₆(Si,Al)₄O₁₀(OH)₈ |
| 120 | Pennantite | Mn²⁺₅Al(Si₃Al)O₁₀(OH)₈ |
| 121 | Nimite | (Ni,Mg,Fe²⁺)₅Al(Si₃Al)O₁₀(OH)₈ |
| 122 | Gonyerite | Mn²⁺₅Fe³⁺(Si₃Fe³⁺O₁₀)(OH)₈ |
| 123 | Cookeite | LiAl₄(Si₃Al)O₁₀(OH)₈ |
| 124 | Borocookeite | Li_{1-1.5}Al_{4-3.5}[(OH,F)₈\|(B,Al)Si₃O₁₀] |
| 125 | Manandonite | Li₂Al₄[(Si₂AlB)O₁₀](OH)₈ |
| 126 | Franklinfurnaceite | Ca2(Fe³⁺Al)Mn³⁺Mn₃²⁺Zn₂Si₂O₁₀(OH)₈ |
| 127 | Kämmererite(Var. v. | Mg₅(Al,Cr)₂Si₃O₁₀(OH)₈ |
| | Klinochlore) | |
| 128 | Niksergievite | (Ba, Ca)₂Al₃[(OH)₆\|CO₃\|(Si, Al)₄O₁₀]•0.2 H₂O |
| 129 | Surite | Pb₂Ca(Al,Mg)₂(Si,Al)₄O₁₀(OH)₂(CO₃,OH)₃•0.5 H₂O |
| 130 | Ferrisurite | (Pb,Ca)₂₋₃(Fe³⁺,Al)₂[(OH,F)_{2.5-3}\|(CO₃)_{1.5-2}\|Si₄O₁₀]•0.5 H₂O |
| 131 | Kaolinite | Al₂Si₂O₅(OH)₄ |
| 132 | Dickite | Al₂Si₂O₅(OH)₄ |
| 133 | Halloysite-7Å | Al₂Si₂O₅(OH)₄ |
| 134 | Sturtite | Fe³⁺(Mn²⁺,Ca,Mg)Si₄O₁₀(OH)₃•10 H₂O |
| 135 | Allophane | Al₂O₃•(SiO₂)_{1.3-2}•(H₂O)_{2.5-3} |
| 136 | Imogolithe | Al₂SiO₃(OH)₄ |
| 137 | Odinite | (Fe³⁺,Mg,Al,Fe²⁺,Ti,Mn)_{2.4}(Si_{1.8}Al_{0.2})O₅(OH)₄ |
| 138 | Hisingerite | Fe₂³⁺Si₂O₅(OH)₄•2H₂O |
| 139 | Neotokite | (Mn,Fe²⁺)SiO₃•H₂O |
| 140 | Chrysotile | Mg₃Si₂O₅(OH)₄ |
| 141 | Klinochrysotile | Mg₃Si₂O₅(OH)₄ |
| 142 | Maufite | (Mg,Ni)Al₄Si₃O₁₃•4H₂O |
| 143 | Orthochrysotil | Mg₃Si₂O₅(OH)₄ |
| 144 | Parachrysotil | Mg₃Si₂O₅(OH)₄ |
| 145 | Antigorite | (Mg,Fe²⁺)₃Si₂O₅(OH)₄ |
| 146 | Lizardite | Mg₃Si₂O₅(OH)₄ |
| 147 | Karyopilite | Mn²⁺₃Si₂O₅(OH)₄ |
| 148 | Greenalithe | (Fe²⁺,Fe³⁺)₂₋₃Si₂O₅(OH)₄ |
| 149 | Berthierine | (Fe²⁺,Fe³⁺,Al)₃(Si,Al)₂O₅(OH)₄ |
| 150 | Fraipontite | (Zn,Al)₃(Si,Al)₂O₅(OH)₄ |
| 151 | Zinalsite | Zn₇Al₄(SiO₄)₆(OH)₂•9H₂O |
| 152 | Dozyite | Mg₇(Al,Fe³⁺,Cr)₂[(OH)₁₂\|Al₂Si₄O₁₅] |
| 153 | Amesite | Mg₂Al(SiAl)O₅(OH)₄ |
| 154 | Kellyite | (Mn²⁺,Mg,Al)₃(Si,Al)₂O₅(OH)₄ |
| 155 | Cronstedtite | Fe₂²⁺Fe³⁺(SiFe³⁺)O₅(OH)₄ |
| 156 | Karpinskite | (Mg,Ni)₂Si₂O₅(OH)₂ |
| 157 | Népouite | (Ni,Mg)₃Si₂O₅(OH)₄ |
| 158 | Pecoraite | Ni₃Si₂O₅(OH)₄ |
| 159 | Brindleyite | (Ni,Mg,Fe²⁺)₂Al(SiAl)O₅(OH)₄ |
| 160 | Carlosturanite | (Mg,Fe²⁺,Ti)₂₁(Si,Al)₁₂O₂₈(OH)₃₄•H₂O |
| 161 | Pyrosmalithe-(Fe) | (Fe²⁺,Mn)₈Si₆O₁₅(Cl,OH)₁₀ |
| 162 | Pyrosmalithe-(Mn) | (Mn,Fe²⁺)₈Si₆O₁₅(OH,Cl)₁₀ |
| 163 | Brokenhillite | (Mn,Fe)₈Si₆O₁₅(OH,Cl)₁₀ |
| 164 | Nelenite | (Mn,Fe²⁺)₁₆Si₁₂As³⁺₃O₃₆(OH)₁₇ |
| 165 | Schallerite | (Mn²⁺,Fe²⁺)₁₆Si₁₂As³⁺₃O₃₆(OH)₁₇ |
| 166 | Friedelite | Mn²⁺₈Si₆O₁₅(OH,Cl)₁₀ |
| 167 | Mcgillite | Mn²⁺₈Si₆O₁₅(OH)₈Cl₂ |
| 168 | Bementite | Mn₇Si₆O₁₅(OH)₈ |
| 169 | Varennesite | Na₈(Mn,Fe³⁺,Ti)₂[(OH,Cl)₂\|(Si₂O₅)₅]•12H₂O |
| 170 | Naujakasite | Na₆(Fe²⁺,Mn)Al₄Si₈O₂₆ |
| 171 | Manganonaujakasite | Na₆(Mn²⁺,Fe²⁺)Al₄[Si₈O₂₆] |
| 172 | Spodiophyllite | (Na,K)₄(Mg,Fe²⁺)₃(Fe³⁺,Al)₂(Si₈O₂₄) |
| 173 | Sazhinit-e(Ce) | Na₂CeSi₆O₁₄(OH)•nH₂O |
| 174 | Sazhinite-(La) | Na₃La[Si₆O₁₅]•2H₂O |
| 175 | Burckhardtite | Pb₂(Fe³⁺Te⁶⁺)[AlSi₃O₈]O₆ |
| 176 | Tuperssuatsiaite | Na₂(Fe³⁺,Mn²⁺)₃Si₈O₂₀(OH)₂•4H₂O |
| 177 | Palygorskite | (Mg,Al)₂Si₄O₁₀(OH)•4H₂O |
| 178 | Yofortierite | Mn²⁺₅Si₈O₂₀(OH)₂•7H₂O |
| 179 | Sepiolithe | Mg₄Si₆O₁₅(OH)₂•6H₂O |
| 180 | Falcondoite | (Ni,Mg)₄Si₆O₁₅(OH)₂•6H₂O |
| 181 | Loughlinite | Na₂Mg₃Si₆O₁₆•8H₂O |
| 182 | Kalifersite | (K,Na)₅Fe₇³⁺[(OH)₃\|Si₁₀O₂₅]₂•12H₂O |
| 183 | Minehillite | (K,Na)₂₋₃Ca₂₈(Zn₄Al₄Si₄₀)O₁₁₂(OH)₁₆ |
| 184 | Truscottite | (Ca,Mn)₁₄Si₂₄O₅₈(OH)₈•2H₂O |
| 185 | Orlymanite | Ca₄Mn₃²⁺Si₈O₂₀(OH)₆•2H₂O |
| 186 | Fedorite | (Na,K)₂₋₃(Ca,Na)₇[Si₄O₈(F,Cl,OH)2\|(Si₄O₁₀)₃]•3.5H₂O |
| 187 | Reyerite | (Na,K)₄Ca₁₄Si₂₂Al₂O₅₈(OH)₈•6H₂O |
| 188 | Gyrolithe | NaCa₁₆Si₂₃AlO₆₀(OH)₈•14H₂O |
| 189 | Tungusite | Ca₁₄Fe₉²⁺[(OH)₂₂\|(Si₄O₁₀)₆] |
| 190 | Zeophyllite | Ca₄Si₃O₈(OH,F)₄•2H₂O |
| 191 | Armstrongite | CaZr(Si₆O₁₅)•3 H₂O |
| 192 | Jagoite | Pb₁₈Fe³⁺₄[Si₄(Si,Fe³⁺)₆][Pb₄Si₁₆(Si,Fe)₄]O₈₂Cl₆ |
| 193 | Hyttsjöite | Pb₁₈Ba₂Ca₅Mn₂²⁺Fe₂³⁺[Cl\|(Si₁₅O₄₅)₂]•6H₂0 |
| 194 | Maricopaite | Ca₂Pb₇(Si₃₆,Al₁₂)(O,OH)₉₉•n(H₂O,OH) |
| 195 | Cayansite | Ca(VO)Si₄O₁₀•4H₂O |
| 196 | Pentagonite | Ca(VO)Si₄O₁₀•4H₂O |
| 197 | Weeksite | (K,Ba)₂[(UO₂)₂\|Si₅O₁₃]•4H₂O |
| 198 | Coutinhoite | Th_{0.5}(UO₂)₂Si₅O₁₃•3H₂O |
| 199 | Haiweeite | Ca[(UO₂)₂\|Si₅O₁₂(OH)₂]•6H₂O |
| 200 | Metahaiweeite | Ca(UO₂)₂Si₆O₁₅•nH₂O |
| 201 | Monteregianite-(Y) | KNa₂YSi₈O₁₉•5H₂O |
| 202 | Mountainite | KNa₂Ca₂[Si₈O₁₉(OH)]•6H₂O |
| 203 | Rhodesite | KHCa₂Si₈O₁₉•5H₂O |
| 204 | Delhayelithe | K₇Na₃Ca₅Al₂Si₁₄O₃₈F₄Cl₂ |
| 205 | Hydrodelhayelithe | KCa₂AlSi₇O₁₇(OH)₂•6H₂O |
| 206 | Macdonaldite | BaCa₄Si₁₆O₃₆(OH)₂•10H₂O |
| 207 | Cymrite | Ba(Si,Al)₄(O,OH)₈•H₂O |
| 208 | Kampfite | Ba₁₂(Si₁₁Al₅)O₃₁(CO₃)₈Cl₅ |
| 209 | Lourenswalsite | (K,Ba)₂(Ti,Mg,Ca,Fe)₄(Si,Al,Fe)₆O₁₄(OH)₁₂ |
| 210 | Tienshanite | (Na,K)₉₋₁₀(Ca,Y)₂Ba₆(Mn²⁺,Fe²⁺,Ti⁴⁺,Zn)₆(Ti,Nb) |
| | | [(O,F,OH)₁₁\|B₂O₄\|Si₆O₁₅]₆ |
| 211 | Wickenburgite | Pb₃CaAl[Si₁₀O₂₇]•3H₂O |
| 212 | Silhydritee | Si₃O₆•H₂O |
| 213 | Magadiite | Na₂Si₁₄O₂₉•11H₂O |
| 214 | Strätlingite | Ca₂Al[(OH)₆AlSiO₂(OH)₄]•2.5 H₂O |
| 215 | Vertumnite | Ca₄Al₄Si₄O₆(OH)₂₄•3H₂O |
| 216 | Zussmanite | K(Fe²⁺,Mg,Mn)₁₃(Si,Al)₁₈O₄₂(OH)₁₄ |
| 217 | Coombsite | K(Mn²⁺,Fe²⁺,Mg)₁₃[(OH)₇\|(Si,Al)₃O₃\|Si₆O₁₈]₂ |

^{a)} cf. Mineralienatlas, Mineralklasse VIII/H-Schichtsilikate (Phyllosilikate), Strunz 8 Systematik

In particular, bentonite from the group of montmorillonites ((Na, Ca)_{0.3}(Al, Mg)₂Si₄O₁₀(OH)₂.nH₂O) is used. Bentonite is a mixture of different clay minerals and contains montmorillonite as the main component. Sodium bentonite can absorb many times its own dry weight in water. Calcium bentonite can also absorb fats and/or oils.

The layered silicate micro- and/or nanoparticles described above are functionalized, not functionalized, aggregated, not aggregated, agglomerated, not agglomerated, supported and/or not supported. For example, they can be functionalized, agglomerated and supported. But they can also not be functionalized and aggregated.

They can act catalytically and/or support dehalogenation.

The grinding stock contains at least one, in particular one fluid, at least one, in particular one solution, at least one, in particular one suspension, at least one, in particular one finely divided, solid mixture and/or at least one, in particular one reactive gas. The above-mentioned materials contain problematic, synthetic, biogenic and biological materials, phosphates, metals and/or their compounds and/or carbon dioxide and/or carbon monoxide.

In addition, the grist contains the coals and/or carbon suppliers described above.

The at least one, in particular one, suspension can also be in the form of a paste which contains at least one, in particular one finely divided solid mixture and/or its constituents. The constituents of the at least one, in particular one solid, finely divided mixture can also be provided separately from one another.

The at least one, in particular one, suspension or paste can contain a continuous aqueous and/or a continuous organic liquid phase.

An aqueous phase is preferably used which can contain water-miscible, protic and/or aprotic polar organic solvents. In particular, the aqueous phase does not contain any organic solvents.

At least one of the solvents described above is used as the at least one, in particular one fluid.

At least one solvent in which at least one of the above-described materials is dissolved in a molecularly dispersed manner is used as the at least one, in particular one solution.

The at least one reactive gas can be present as a gas, as a condensed fluid and/or as a frozen solid.

In a second or third process step, the ground material is metered continuously or discontinuously to at least one, in particular one mechanical mill. Alternatively, the constituents of the grist can be metered in successively or simultaneously, continuously or discontinuously, to the at least one, in particular one mechanical mill.

In a fourth process step, the ground material is finely ground at constant and/or variable speed with the aid of the grinding media described above, which are moved with the aid of the agitation means described above, after which, in a fifth process step, the at least one, in particular one resulting ground suspension of at least one pulverulent product or the at least one, in particular one pulverulent product is continuously or discontinuously separated from the grinding bodies in a fifth process step and discharged from the grinding chamber.

“Variable speed of rotation” means that the speed of rotation in the course of the grinding increases up to a limit value or decreases from a preselected value or increases at least once and then decreases again.

The ground products can be added continuously or discontinuously to at least one further mechanical mill or a cascade of mills.

In a sixth process step, the at least one, in particular one, ground, finely divided solid product is separated from the at least one, in particular one, ground suspension, whereby at least one digested, biologically available, water-soluble material, in particular at least one phosphate, is transferred into the liquid, in particular aqueous medium, preferably in molecularly dispersed form.

Alternatively, the at least one digested, biologically available, water-soluble material present or still present in the at least one finely divided, solid product, in particular at least one phosphate, is left in the at least one product until it is used, for example, as a fertilizer.

Furthermore, the at least one washed, finely divided, solid product made of activated carbon is returned to the first process step and/or used in some other way as a sales product.

The at least one, in particular one finely divided solid product can be washed out by washing out, decanting, distillation, chromatography, extraction, magnetic separation, filtration, sedimentation and/or centrifugation.

The at least one, in particular one finely divided solid product that is obtained as described above can also contain at least one further, in particular at least two further biologically available material(s) soluble in liquids, in particular in aqueous media, which material(s) is or are left in the at least one product until further use or the materials(s) is or are washed out of the at least one product. These biologically available materials are preferably selected from the group consisting of lithium, sodium and potassium salts as well as magnesium and calcium salts, in particular sulfates.

In addition, the at least one, in particular one, solid, finely divided product can contain at least one immobilized metal selected from the group consisting of main group elements, heavy metals and radioactive metals and their compounds. The main group elements are in particular beryllium, arsenic, antimony, bismuth, aluminum, gallium, germanium, selenium, tellurium, thallium and lead. The heavy metals are the transition metals, especially precious metals such as rhodium, iridium, palladium, platinum, silver and gold, and the lanthanides. The radioactive metals are in particular the actinides. The compounds are the oxides, hydroxides, acids, salts, complexes or organometallic compounds of these elements and metals.

It is a particular advantage of the method according to the invention that toxic and/or carcinogenic metal compounds such as chromates or dichromates are reduced in the course of the method according to the invention, for example to chromium (III) or to the zero-valent metals such as chromium (0) and are thereby detoxified and immobilized.

At least one, in particular one, washed-out, solid, finely divided product is the valuable product activated carbon, which can be returned to the first process step. This is a particular advantage of the mechanochemical process according to the invention, because it enables the provision of expensive fresh activated carbon to be minimized.

In addition, the at least one solid, finely divided product that has not been washed out can be a valuable phosphate-containing fertilizer.

Furthermore, the at least one immobilized metal and/or the at least one immobilized metal compound can be at least one material that can be safely stored or dumped or it can be at least one heterogeneous catalyst.

When the at least one immobilized metal is at least one of the noble metals mentioned above, it can be easily recovered by burning the activated carbon.

In a further particularly preferred embodiment of the mechanochemical process according to the invention, the weight ratio of the fluids, the solutions, the suspensions, the finely divided solid mixtures and/or the gases or the materials mentioned plus at least one additive to pure, finely divided mineral coal, biochar or activated charcoal, contaminated, finely divided, mineral charcoal, biochar or activated charcoal, finely divided lignite or pure or contaminated, finely divided carbon suppliers as well as to the above-mentioned, moistened materials is 0.01 to 10¹², preferably 0.1 to 10⁸, particularly preferably 1.0 to 10⁶ and especially 1.0 to 10⁴.

It is a very important advantage of the mechanochemical process according to the invention that it serves to reduce or eliminate ammonia, ammonium salts, nitrates, nitrites and nitrosamines and/or to simultaneously generate biologically available phosphates and activated carbons. For this purpose, the mechanochemical process according to the invention is carried out in particular with dried liquid manure, liquid manure, fermentation residues, dry ferments, sewage sludge, ferments, biowaste, vegetable waste, animal waste, dry concentrates of the biological purification stages of sewage treatment plants, chemical washers and filters, waste water and residues of the exhaust air treatment.

In doing so, the particular advantage of the mechanochemical process according to the invention, namely that the nitrogen compounds are all converted into elemental nitrogen without NOx or nitrous oxide being produced, shows itself. The elimination takes place very quickly, so that the mechanochemical process according to the invention can be ended after a comparatively short time, for example after 100 minutes.

In particular, the mechanochemical process according to the invention is carried out in the context of at least a fourth purification stage of sewage treatment plants.

The process according to the invention can, however, be applied much more broadly, as is shown by the following examples.

The Processing of Liquid Manure, Biomass from Biogas Plants, Liquid Manure and Sewage Sludge in the Mechanical Mills with the Help of Activated Carbon

Scientific studies show that activated carbon absorbs the following substances well to very well:

Particles or Suspended solids that are larger than the pores of the filter, such as fibers, suspended solids.

Bacteria and parasites that are larger than the pores of the filter.

Chlorine and chlorine compounds.

Organic compounds (chemical compounds based on carbon) such as pesticides and pesticide residues, herbicides, insecticides, drug residues, hormones and hormone-like substances.

Certain heavy metals such as lead and copper, selenium, cadmium, trace elements from biogas plants, uranium as an accompanying substance of phosphate.

Ozone, superoxide, oxidizing agents.

The substances that activated carbon block filters cannot or hardly absorb include:

Organic and inorganic particles or particulate suspended matter that is smaller than the pores of the filter.

Dissolved salts: natural minerals such as calcium and magnesium ions, nitrate, nitrite, ammonium, etc.

Liquid manure, biomass, liquid manure, sewage sludge contain in different concentrations:

Water.

Water-soluble cations: potassium, sodium, calcium, magnesium.

Water-soluble ions: chloride, nitrate, nitrite, phosphate, sulfate, ammonium.

Dissolved gases; Ammonia, hydrogen sulfide, methane, carbon dioxide, carbon monoxide.

Organic compounds: humic acids, pesticides, drugs and residues, hormones, PAHs, amides, proteins.

Solid components: suspended matter, particles, fibers, sand.

Chlorine and chlorine compounds from cleaning agents and externally added materials.

Bacteria, crypotosporidia, giardiae.

There are different methods of processing liquid manure:

Separation with Press Screws

Press screws have a medium energy requirement. In them, the manure is pressed against a surrounding sieve with a screw. The thin phase goes through the sieve, and the solid phase is pressed out against a mechanical resistance. With the change in resistance—for example, of the opening area—the degree of separation can be influenced. Press screws can separate 25% by weight 25% by weight, 50% by weight of dry matter, 30% by weight of nitrogen and up to 40% by weight of phosphate.

Separation with Centrifuges

Centrifuges have a higher energy requirement, but separate more phosphate. The solid and liquid phases are separated in a rapidly rotating drum. With this technology, not only fibrous materials, as in press screws, but also fine materials enter into the solid phase. This means that nutrients are enriched in this phase. Separating centrifuges can separate 15% by weight, 60% by weight of dry matter, 20% by weight of nitrogen and up to 70% by weight of the phosphate.

Multi-Stage Manure Separators

Multi-stage separators with two centrifuges are not only very expensive, they also have extremely high energy consumption. However, they extract: 30% by weight, 90% by weight of the dry mass, 50% by weight of the nitrogen and up to 95% by weight of the phosphate

Mobile Manure Separators

In addition to permanently installed separators, various mobile versions are available. These devices can be brought flexibly to different locations by forklift truck, on car or heavy-duty trailers or on trucks. This means that the smaller quantities of liquid manure from smaller companies, for example from contractors, can be treated with well-utilized technology.

Mechanochemical Processing

Depending on the nutrient balance, the solid phases can be processed further or mechanochemically processed. The mechanochemical work-up pursues the following goals:

To convert nitrates and ammonium, which are shown as nitrogen here, together with organic nitrogen to atmospheric nitrogen.

The phosphate remains water-soluble or is returned to it and thus made bioavailable.

Dry matter, which consists of cellulose, hemicellulose, lignin, humic acid, proteins, amines, tissue residues, bacteria, sludge, fibers and PAHs bound to them, are processed into coal or, depending on the running time of the mechanical mill, are converted into short-chain biomolecules at first. These have nutritional value for fungi, bacteria, and animals. The material can be fed into the biogas plant to convert the nutrients into methane. In combination, the nitrogen content has been reduced at the same time.

The Activated Charcoal Clarification

With an activated carbon block filter, three different principles complement each other in their effects:

The Mechanical Effect of the Activated Carbon

Like a sieve, the activated carbon, holds back all particles that are larger than their pores. This mechanical action filters, for example, bacteria, cryptosporidia (single-cell parasites), giardia (small intestine parasites), suspended particles and sand, rust particles, asbestos fibers, etc. In order to achieve even finer and more reliable particle filtration than would be possible with pure activated carbon filters, some filter inserts also use a second filter stage in the form of a hollow fiber membrane.

The Catalytic Effect

Certain substances that are smaller than the pores of the filter can be converted by the activated carbon with its catalytic effect. These substances are then no longer in their original form. The catalytic effect eliminates, for example, the unpleasant taste of chlorinated water. Activated charcoal is very efficient in terms of its catalytic effect, since it is depleted only a little. With the catalytic effect, for example, the following are removed from the water: chlorine, CHCs and FCHCs.

The Adsorptive Effect

The activated carbon can absorb certain substances that are smaller than the pores of the filter with their adsorptive effect. During adsorption, the substances attach to the activated carbon and stick to it. The forces that cause this adhesion are not chemical bonds, but “Van der Waals forces”, which act in a similar way to magnetic forces on various substances.

Activated carbon has the greatest adsorption power of all known substances and is therefore particularly suitable as a filter medium.

“Van der Waals forces” are very strong, but only act at a very short distance. The proximity to the contact surface and the speed at which the water flows past it is therefore decisive for the adsorptive effect. The finer an activated carbon filter and the slower the water permeates it, the better is the adsorptive filtering. This is where an advantage of particularly small activated carbon comes into play, because it has comparatively fine pores and slows down the flow of water.

With its adsorptive effect, an activated carbon filter can bind organic substances and inorganic substances that are undesirable in water for human consumption, such as lead, copper, pesticides, herbicides, fungicides, hormone residues, drug residues as well as odor and taste-impairing substances.

The Mechanochemical Processing of the Loaded Activated Carbon

The activated carbon is pressed out, briefly pre-dried and then mechanochemically processed with a mechanical mill and recycled so that it can be reused in a cycle. The separated water can also be reused. The mechanochemical work-up aims to:

To convert nitrates and ammonium together with organic nitrogen to atmospheric nitrogen.

To render small phosphate particles, which are water-insoluble and therefore not available to plants, bioavailable again.

To process dry matter, which consists of cellulose, hemicellulose, lignin, humic acid, proteins, amines, tissue residues, bacteria, sludge, fibers and PAHs, back into coal or, depending on the running time of the mechanical mill, to convert it into short-chain biomolecules in first place. These have nutritional value for fungi, bacteria, and animals. The material can advantageously be fed into the biogas plant to convert the nutrients into methane. In doing so, the nitrogen content is reduced at the same time.

To bind heavy metals and reuse them as auxiliary materials in the activated carbon for biomass systems. In this way they do not end up in the field or in the natural environment. In particular, heavy metals such as uranium, cadmium, lead, copper and cobalt longer get into the natural environment.

Herbicides, fungicides, hormone residues and drug residues are broken down into charcoal.

Chlorine, CHCs, CFCs, PCBs and dioxins are converted to non-toxic chlorides and carbon.

The water that is left after the activated carbon filtering can be separated into clean water and nutrients using conventional desalination systems.

The activated carbon can always be recycled.

The Mechanochemistry in the Desalination of Water

In all cases, the desalinated water is not suitable for direct use as drinking water. In addition, such low-salt waters are corrosive for ferrous materials, since no lime-rust protective layer can be formed. Subsequent addition of calcium hydrogen carbonate therefore increases the carbonate hardness content in the water again. Calcium hydrogen carbonate is produced by a reaction of calcium hydroxide (milk of lime) with carbon dioxide (CO₂).

The following section lists the usual processes in the order of their economic importance. The process of multi-stage flash evaporation (MSF) is most widespread and is used on a large industrial scale. In addition to these processes, solar seawater desalination processes are also used to a lesser extent.

The Multi-Stage Flash Evaporation

This is a thermal process with the abbreviation “MSF” (Multi Stage Flash Evaporation). It is the most commonly used process for seawater desalination. The antecedent technique was the multi-effect distillation.

In this process, the salty water supplied is heated to a temperature of 115° C. using the waste heat from a caloric power plant, and, in rare cases, also from a nuclear power plant. The salt water heated in the so-called brine heater evaporates in downstream relaxation stages under vacuum. The water vapor is deposited as condensate within these stages on pipes filled with cooling liquid and is drawn off as salt-free water. The water, which is increasingly enriched with salt through the evaporation process, is also called brine (brine) and is cooled to the condensation temperature (approx. 40° C.) of the steam of the supplied fresh water. It then serves as a cooling liquid in the pipelines. The pipes themselves are continuously cleaned of crystallizing salt with sponge rubber balls. Finally, fresh salt water is fed to the brine and the mixture is heated up again by the waste heat from the gas turbine. The entire process is therefore a closed cycle. The surplus of the salt concentrating in the cycle is returned to the sea.

Large-scale plants, such as the Jabal Ali power plant and seawater desalination plant, the world's largest seawater desalination plant, desalinate 2.135 million cubic meters of seawater every day. Usually, up to 500,000 cubic meters of drinking water are extracted from the seawater every day with the process. Similar quantities are also produced by the oil-fired power plants in the region. The energy consumption is 23-27 kWh/m3.

The Reverse Osmosis

In reverse osmosis, the solution is pressed under high pressure through a semipermeable membrane made of polyamide, PTFE or sulfonated copolymers with a pore diameter of 0.5 to 5 nm to overcome the osmotic pressure. This acts like a filter and only lets certain ions and molecules pass through. Thus, a separation of the original solution is obtained. The membrane filter can hold back salts, bacteria, viruses, an oversupply of lime and toxins such as heavy metals.

The osmotic pressure increases with increasing salt concentration, so the process would come to a standstill at some point. To counteract this, the concentrate is discharged. Since the crystallization of the salt or the minerals (precipitation) in the membranes must be prevented, the use of reverse osmosis only makes sense up to a certain maximum concentration of the reflux. Depending on the salt concentration, due to the high pressure, even in optimal systems, an energy consumption of between 2 and 4 kWh per cubic meter of drinking water must be expected.

The membranes of a reverse osmosis system are not maintenance-free. The formation of deposits, caused by mineral deposits (scaling), biological substances (biofouling) or colloidal particles, reduces the permeation of the water molecules through the membranes. To counteract this, the membranes must be rinsed with chemical cleaners. Anti-scaling agents such as polyphosphoric acid and polymaleic acid as well as biocides and chlorine against bacterial deposits are common. These cleaning agents or rinsing waters are not environmentally friendly and must be separated or treated before being returned to the sea.

The drinking water treatment systems can be equipped with additional pre-filters depending on the type of water pollution. Coarse material can be separated up to a particle size of 20 μm. An additional activated carbon filter separates organic substances such as pesticides. UV irradiation can also be used downstream, which represents an additional level of safety against germs. A system that works according to this principle is the Mossel Bay seawater desalination plant in South Africa.

At every stage of reverse osmosis, mechanochemical processing with activated carbon offers a solution that is better than reverse osmosis itself:

Before microfiltration, the activated carbon is used as a precursor to microfiltration in order to protect the membrane from dirt and particles. This will reduce the buildup and clogging.

Common macromolecules are retained at the ultrafiltration stage. Most of this has already happened due to the activated carbon, so that the ultrafiltration membrane is a guard membrane that is less clogged and lasts much longer. This applies in particular to cellulose, hemicellulose, ligning, humic acids, proteins and metabolites.

Nanofiltration retains dissociated salts, divalent and higher-valent salts, cations and anions such as sulfates, phosphates and alkaline earth metals as well as sugars. It is particularly important that phosphates can be separated here and processed cleanly together with alkaline earth metals.

In reverse osmosis, monovalent and undissociated salts are retained. This creates a highly enriched solution and suspension that contains a lot of ammonium and nitrate as well as chlorides, bromides and alkali metal cations. These salts can be thickened separately or sold as fertilizer concentrate or, if there is an oversupply, simply converted mechanochemically into atmospheric nitrogen after they have been dried. This would then increase the concentration of cations that are not destroyed, such as potassium, in the mechanical mill.

The activated carbon as a prefilter is mechanochemically recycled after drying.

The Membrane Distillation

In the membrane distillation process, a microporous membrane is used that only allows water vapor to pass through, but retains liquid water. On one side of the membrane there is warm salt water and on the other side is a colder surface. The countercurrent operation of the system ensures that there is a temperature difference over the entire length of the membrane. The resulting difference in water vapor partial pressure causes water molecules to move from the warm to the cold side of the membrane.

Experimental Techniques

In the following section, various test methods for desalination are listed, some of which are also used in smaller plants.

Plastic Evaporation Hoses

As part of a European CRAFT project, the French research center CEA/GRETH has developed a seawater desalination plant in which the metal components have largely been replaced by polymers. This has the advantage that plastics corrode much less and are therefore more resistant than metals. By using plastic, the process can run under normal conditions at 100° C. and 1 bar. The device achieves a drinking water production rate of 100 l/h. Since the water is heated to 100° C., it is largely sterile and only contains small amounts of salt.

Freezing Process

When salt water cools down, ice crystals are formed that are free of salts. However, the technical difficulties essentially consist in separating the ice crystals from the mother liquor. The ice crystals have to be washed from the mother liquor. In turn, there is a considerable need for fresh water, which has made this process fail in practice.

Electrodialysis

Electrodialysis is only economical when the salt content is very low. The energy costs are in a linear relationship to the salt content. The procedure is therefore often only worthwhile for brackish water.

Ion Power

Salt water is fed into four basins. In basin 1, the salt concentration is increased (e.g. by solar evaporation). The resulting concentrated brine in basin 1 is connected via selective polystyrene membranes, which block Na⁺, towards basin 2 and CI⁻ ions towards basin 3, causing a Na⁺ and Cl⁻ ion surplus in basins 1 and 2 respectively. These two basins are connected to the fourth basin by membranes. The ions diffuse from this fourth basin to compensate for ions in basins 2 and 3. The water in basin 4 is thus NaCl-free. If other salts have to be removed, other ion filters must also be used. A pilot plant with environmental subsidies was built in Canada. The Siemens group operates a pilot plant in Singapore.

The advantage is the low energy consumption, provided that the evaporation in pool 1 is caused by the sun. With the exception of sodium and chloride, the mineral content is retained, so that no other minerals have to be added to use drinking water. Additional ion filters are required for other purposes.

The Bio Fuel Cell

Research on bio-fuel cells for the desalination of weakly saline waters is carried out at the University of Queensland, Tsinghua University and the Oak Ridge National Laboratory, USA, among others. Practical use is also being considered for brackish water.

The Mechanochemical Processing in the Desalination of Water

The salts contain alkaline cations, alkaline earth cations, cations such as ammonium, anions such as chloride and bromide as well as fluoride, nitrogen anions such as nitrite and nitrate, phosphates and residues of heavy metals. The mechanochemical work-up has the goals:

To Immobilize residues of heavy metals on activated carbon.

To convert ammonium, nitrate and nitrite partially or completely into atmospheric nitrogen in the thickened mass, which contains all of the above cations and anions. This results in a fertilizer that contains a lot of potassium and phosphate but little or no nitrogen.

If there is no demand for pure ammonium and nitrate as fertilizer, it is possible to convert these substances cheaply on site into atmospheric nitrogen.

For specific versions, see the explanations on reverse osmosis.

The Detoxification of Carcinogenic Compounds

It is known that the compounds of hexavalent chromium such as potassium dichromate are carcinogenic. With the aid of the mechanochemical process according to the invention, it is possible to reduce the hexavalent chromium to trivalent chromium and in some cases to metallic chromium. Chromium is then no longer a carcinogen in these oxidation states.

The Processing of Nitrate and Ammonium from the Groundwater and Drinking Water with Activated Carbon

Because of the lower concentration, activated carbon can be used to bind nitrate,

Functionalized activated carbon can also be used with CaCl₂), iron such as metallic iron and Fe (III), magnetic iron particles, copper, palladium, tin, indium and other metals.

The Advantages of Mechanochemical Work-up:

During the mechanochemical work-up, the particles are comminuted, which adds nano-effects.

When used as a filter, iron can be washed out, but if it is still present, it can be reactivated by reduction.

The same applies to nanoparticles and compounds of copper, palladium etc. These can be further crushed and recovered together with the coal

This gives you the option of converting the bound nitrate into nitrogen and activated carbon even if the activated carbon is not functionalized.

The same applies to many activated and functionalized activated carbons, which can then be reactivated again, with the nitrate being broken down at the same time.

In this way, the activated carbon can be mechanochemically functionalized anew or post-functionalized or refreshed and reused.

The Mechanochemical Breakdown of Carbon Dioxide and Carbon Monoxide into Oxygen and Carbon Allotropes

The starting point is the binding of carbon dioxide or carbon monoxide to activated carbon or microporous materials such as zeolites in combination with activated carbon and the subsequent mechanochemical conversion of carbon dioxide into carbon oxygen. Therefore, the goal of an inexpensive carbon dioxide sink that can be implemented permanently and on a large scale and can be mobile can be achieved anywhere. The effect can be increased if bases such as ammonia or alkaline solutions are available for binding. It is then a matter of chemisorption. The salts of carbon dioxide such as sodium carbonate or other salts that result from the deposition of carbon dioxide can also be broken down. The adsorption of carbon dioxide can be intensified by OH groups in the carbon and by a certain residual moisture that can be associated with it. Partially pyrolyzed activated carbon or charcoal has also proven to be advantageous, since it has more OH groups and therefore binds carbon dioxide more easily. Tribochemical catalysts such as glass, quartz or rock, reducing catalysts, oxidizing catalysts, mixed catalysts or metal catalysts, as listed above, can be used as catalysts.

Special embodiments are the carbon dioxide conversion with a membrane, in low-temperature systems with the condensation of carbon dioxide, with the introduction of dry ice or with the low-temperature separation of carbon dioxide, with metal catalysts and metal alloys with carbon, with organometallic catalysts or with homogeneous catalysts.

When converting carbon dioxide with a membrane, a gas-permeable membrane is used that is permeable to oxygen and impermeable to carbon dioxide. By sucking off the oxygen, the equilibrium can be shifted so that a permanent conversion takes place. AIRCO offers a membrane that separates the substances as they flow through hollow fibers due to the different diffusion speeds.

In the low-temperature system with the condensation of carbon dioxide, carbon dioxide is condensed into the reactor at −78.5° C. The reactor is cooled to temperatures below the sublimation point of carbon dioxide of −78.5° C. As a result, the amounts of carbon dioxide in the grinding chamber are higher than through adsorption on the coal alone. The reactor can be cooled, for example, via a double-walled reactor which is cooled with liquid nitrogen or helium. The cooling liquid can be combined with a throttle relaxation as in a refrigerator. Thermoelectric elements or Peltier elements can also be used. The oxygen remains gaseous because it only becomes liquid at −183 C.

The dry ice is introduced in pieces or as a slush, optionally mixed with coal. Or the coal is already in the grinding chamber. The dry ice can also be present alone in the grinding chamber and then convert into coal in the course of grinding. However, the presence of activated carbon is preferred because it accelerates the reaction.

In the case of the low-temperature separation of carbon dioxide, the grinding chamber contains a cold finger, which is preferably designed as a tapping finger or separator and on which carbon dioxide separates itself at −78.5° C. Alternatively, the grinding chamber can be combined with a corresponding separate system. The oxygen remains in the gas phase and can be pumped out or separated by membranes.

In the same way, carbon monoxide can be split into the elements. The method according to the invention is thus also available for eliminating this toxic gas.

In a further embodiment of the mechanochemical process according to the invention, the carbon dioxide and the carbon monoxide are not only ground with activated carbon, but with any biomass and/or carbon-supplying materials. For example, compressed gaseous carbon dioxide can be injected into the biomass together with the exhaust gas from biogas plants and the resulting grinding stock can be converted mechanochemically into activated carbon.

This means that the methane slip in biogas plants and generally in others methane and/or natural gas-powered systems such as gas engines can also be avoided effectively, because the slip gases are converted into carbon and no longer get into the atmosphere, where they would act as particularly strong greenhouse gases. In this way, the emission of greenhouse gases can also be effectively prevented by the mechanochemical method according to the invention.

The binding of noxae such as ammonia, amines, fine dust, ultra-fine dust, mercury, carbon dioxide, carbon monoxide, hydrogen sulfide and other sulfur compounds from the air of stables, sewage treatment plants, biogas plants and closed waste dumps to activated carbon is made possible by a suitable impregnation of the activated carbon, which significantly increases its adsorption capacity, so that it can be used with advantage for the economical removal of poorly absorbable impurities in gases. The noxae are then no longer exclusively bound by adsorption, but also by chemical sorption or catalytically. The activated carbons are functionalized with potassium iodide, potassium carbonate, phosphoric acid, caustic soda, potassium hydroxide, sulfur, sulfuric acid and silver and are uniformly and homogeneously impregnated.

The activated carbon loaded with noxae can then be recycled and reactivated with the aid of the mechanochemical process according to the invention.

Another advantageous application of the mechanochemical process according to the invention is the separation and classification of activated carbon with different grain sizes. For this purpose, gases, in particular air or inert gases such as nitrogen, are blown through a first pipe into the grinding chamber of a mechanical mill with the help of a blower, a fan or a compressor, and the finely divided, powdery activated carbon particles are discharged via a second pipe from the grinding chamber and agglomerated in the gas phase by acoustophoresis, as is known, for example, from international patent application WO 2017/153038. The agglomerated activated carbon particles are then blown into a cyclone, in which they are separated from the gas phase. A bypass, which fluidly connects the first and second tubes to one another, ensures that a stronger gas flow flows through the cyclone than through the grinding chamber.

In a particularly advantageous embodiment, the mechanical mill for mechanochemical processes according to the invention comprises at least one rotatable or stationary mechanochemical reactor, waveguide or grinding chamber, which has a plurality of the above-described grinding media in a drum with at least one inlet for the ground stock and at least one outlet for the ground product. The drum of the rotatable mechanochemical reactor and waveguide has a disk-shaped vertical drum wall, which is connected in its center to a rotatable drive shaft that can be driven by a motor.

In contrast to this, the drum of the stationary mechanochemical reactor and waveguide have agitation means for mixing the grinding media and the ground material. The agitation means are arranged to be rotatable along the longitudinal axis of the drum and are rotated by a rotatable drive shaft that can be driven by a motor and passes through the disk-shaped vertical drum wall.

The vertical drum wall of both the stationary and the rotatable mechanochemical reactor and waveguide, which is opposite the disk-shaped vertical drum wall, is formed by an impact-resistant grid or window that is transparent to electromagnetic radiation and/or corpuscular radiation which grid or window separates at least one radiation source and prevents the grinding media and the grinding stock from damaging the at least one radiation source.

Focused laser radiation, electron radiation, radioactive radiation such as alpha radiation, neutron radiation and gamma radiation, X-rays, UV radiation, IR radiation, microwave radiation and ultrasound and the corresponding radiation sources are preferably used. In particular, microwave radiation is used.

The radiation sources can be connected to the mechanochemical reactor, grinding chamber or waveguide or can be arranged separately from them.

The materials from which the mechanical mill is built depends, among other things, on the type of radiation used. In particular, when using microwave radiation, the grid, the inner walls of the mechanochemical reactor and waveguide, the grinding media and the agitation means must be made of a material that does not cause electrical short circuits. Examples of suitable materials for the inner walls and agitation means are impact-resistant, scratch-resistant and high-temperature-resistant plastics and ceramics. The grinding media are preferably also made of ceramic such as porcelain. For the other parts of the mechanical mill that are not irradiated, metals such as stainless steel can be used. An electric motor, in particular one of the internally cooled electric motors described above, is preferably used for the drive.

The mechanochemical process according to the invention and the mechanical mill according to the invention are explained in more detail below with the aid of Examples and Figures. The examples and figures are not restrictive, but are intended to specify the mechanochemical method according to the invention and the mechanochemical device according to the invention.

FIGS. 1 to 24 are schematic representations which are intended to illustrate the essential features of the mechanochemical process according to the invention and its use according to the invention. Some of the figures are not true to scale:

FIG. 1 shows a mechanical mill 1 according to the invention with a rotating drum 1.5 for grinding of the ground stock under irradiation with microwave radiation;

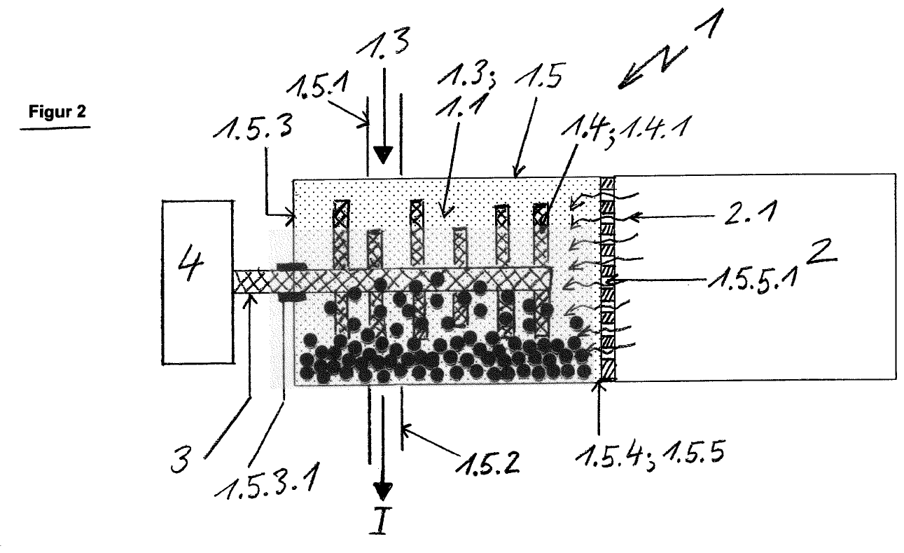

FIG. 2 shows a mechanical mill 1 according to the invention with a fixed drum 1.5 and an attritor 1.4 for grinding the ground stock under irradiation with microwave radiation 2.1;

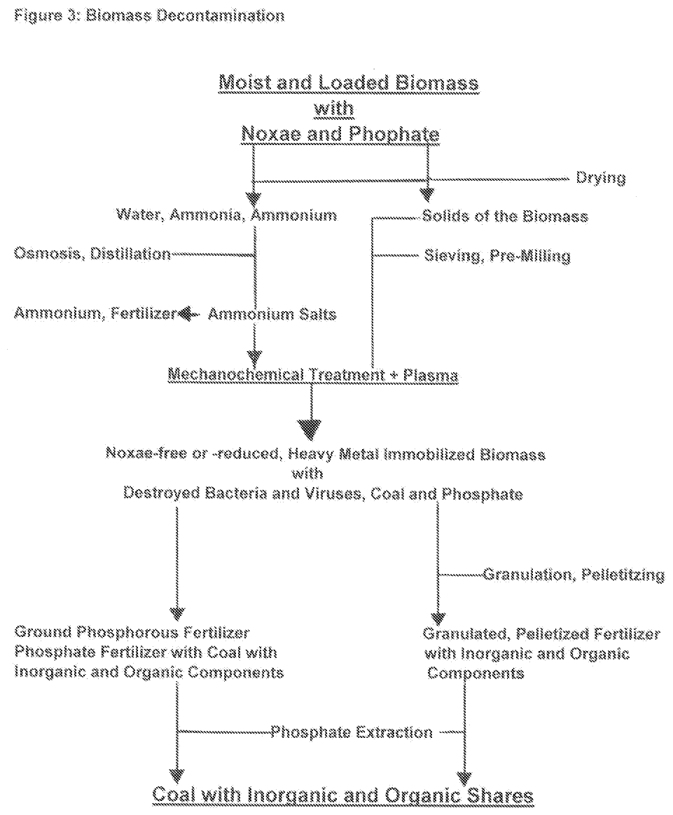

FIG. 3 shows a flow diagram of the mechanochemical process for the decontamination of contaminated, phosphate-containing biomass and for the recovery of phosphate in a biologically available form;

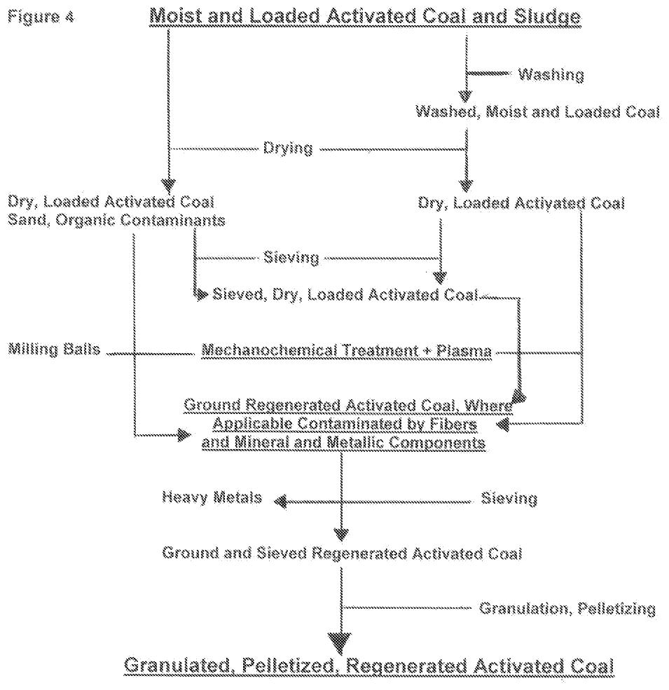

FIG. 4 is a flow diagram of the mechanochemical process for obtaining regenerated activated charcoal from moist and contaminated activated charcoal and sludge of the fourth purification stage;

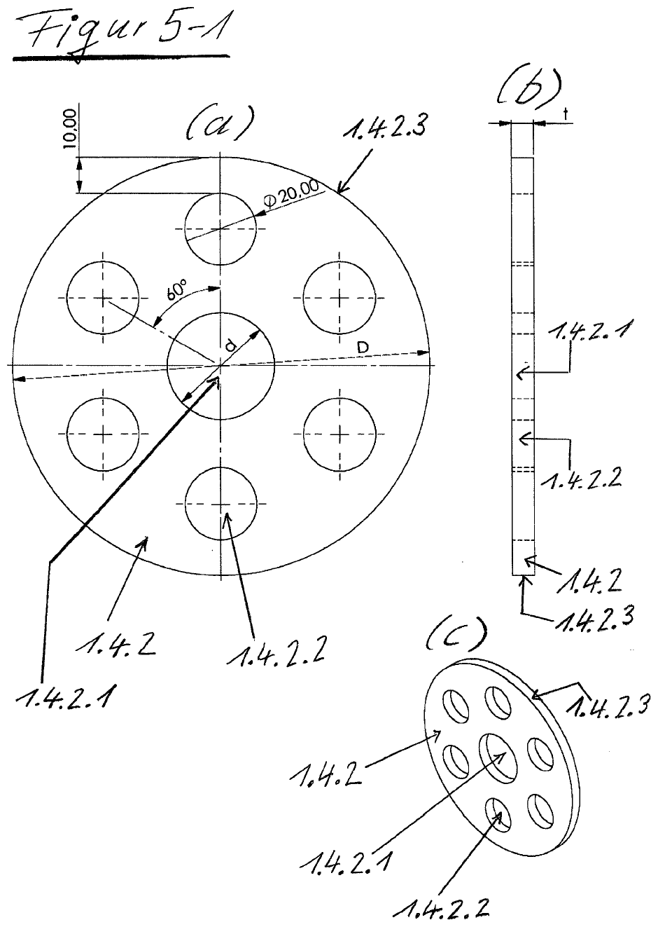

FIG. 5-1 (a) shows a plan view of the true-to-scale surface of the striking disk 1.4.2, (b) a true-to-scale side view of the striking disk 1.4.2 and (c) a perspective illustration of the striking disk 1.4.2;

FIG. 5-2 (a) shows a plan view of the true-to-scale surface of the striking disk 1.4.2, (b) a true-to-scale side view of the striking disk 1.4.2 and (c) a perspective illustration of the striking disk 1.4.2;

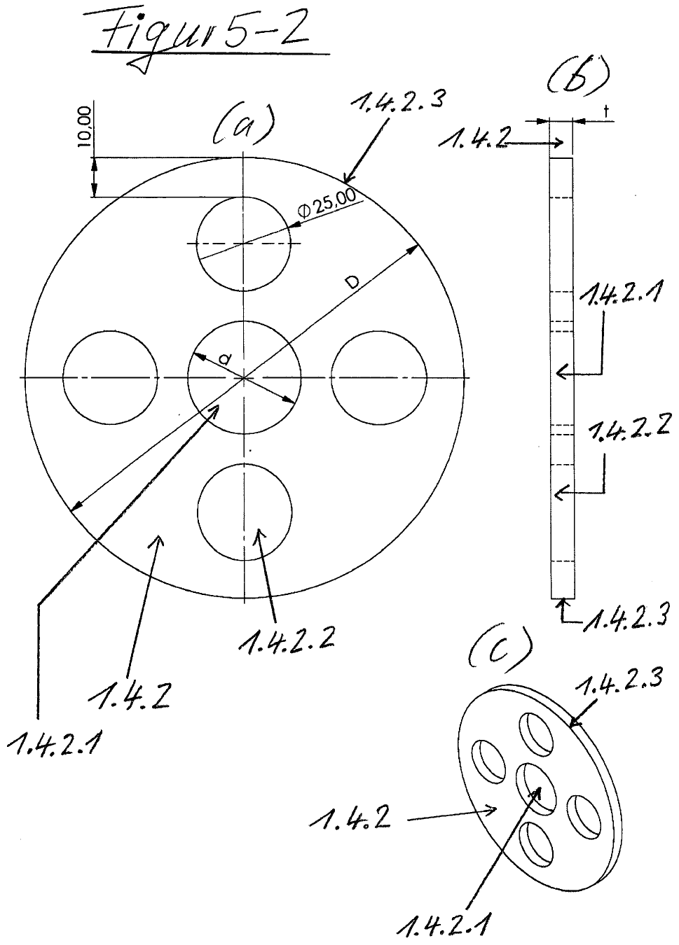

FIG. 6 (a) shows plan view of the true-to-scale surface of striking disk 1.4.2, (b) true-to-scale side view of striking disk 1.4.2 and (c) perspective illustration of striking disk 1.4.2;

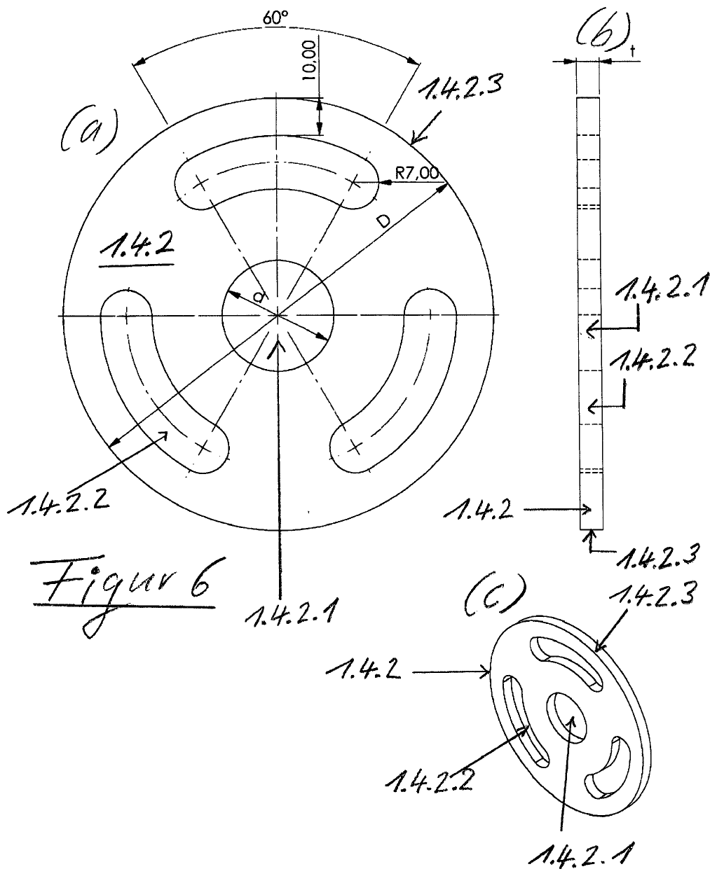

FIG. 7 (a) shows a plan view of the true-to-scale surface of the striking disk 1.4.2 with the striking webs 1.4.2.4, (b) a true-to-scale side view of the striking disc 1.4.2, (c) a profile of a striking web 1.4.2.4 and (d) a perspective view of the striking disc 1.4.2;

FIG. 8 (a) shows a plan view of the true-to-scale surface of the striking disk 1.4.2 with the striking webs 1.4.2.4, (b) a true-to-scale side view of the striking disc 1.4.2, (c) a profile of a striking web 1.4.2.4 and (d) a perspective view of the striking disc 1.4.2;

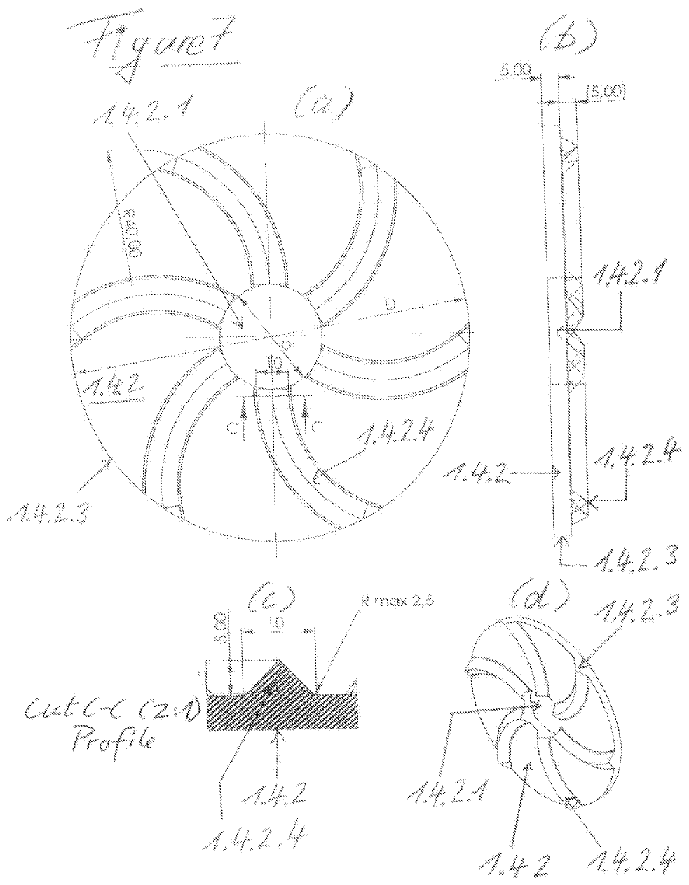

FIG. 9 (a) shows a plan view of the true-to-scale surface of the striking disk 1.4.2 with the striking webs 1.4.2.4, (b) a true-to-scale side view of the striking disc 1.4.2, (c) a profile of a striking web 1.4.2.4 and (d) a perspective view of the striking disc 1.4.2;

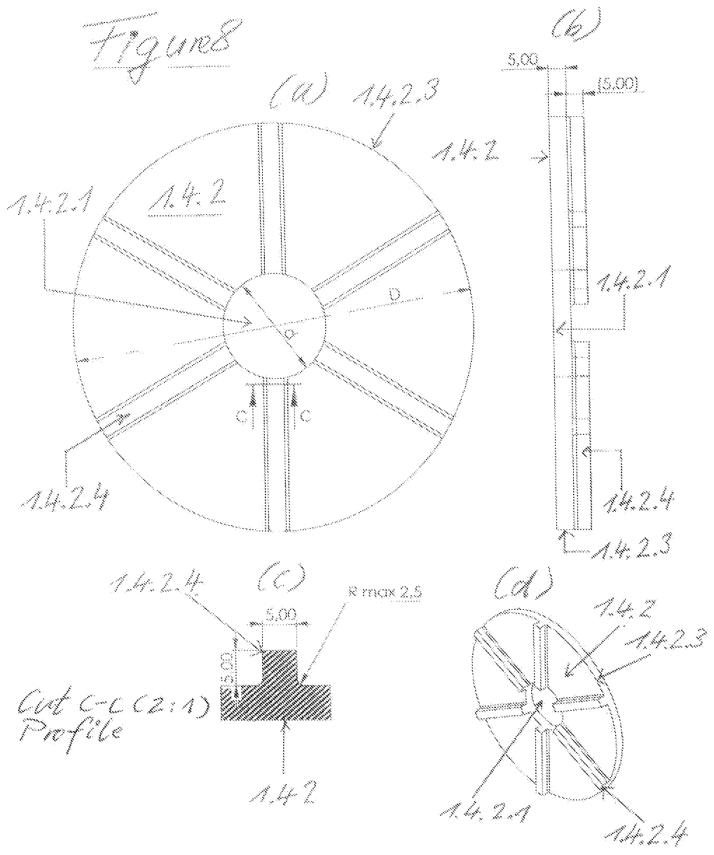

FIG. 10 (a) shows a plan view of the true-to-scale surface of the fan 1.4.3 with the striking webs 1.4.2.4, (b) true-to-scale side view of the striking fan 1.4.2, and (c) a perspective view of the striking fan 1.4.2;

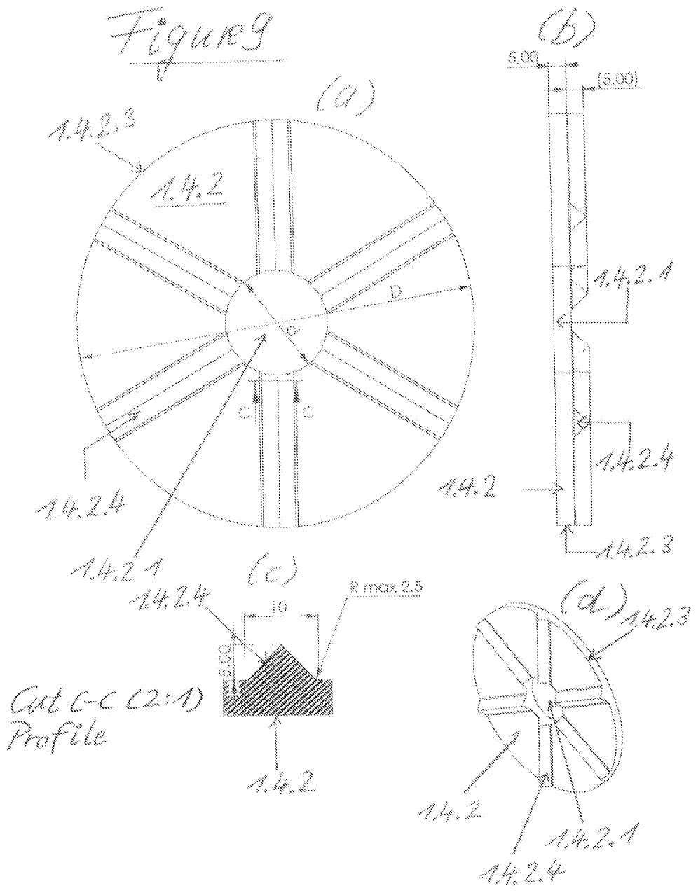

FIG. 11 (a) shows a plan view of the true-to-scale surface of the fan 1.4.3 with the striking webs 1.4.2.4, (b) a true-to-scale side view of the striking fan 1.4.2, (c) a profile of a striking web 1.4.2.4 and (d) a perspective view of the striking fan 1.4.2;

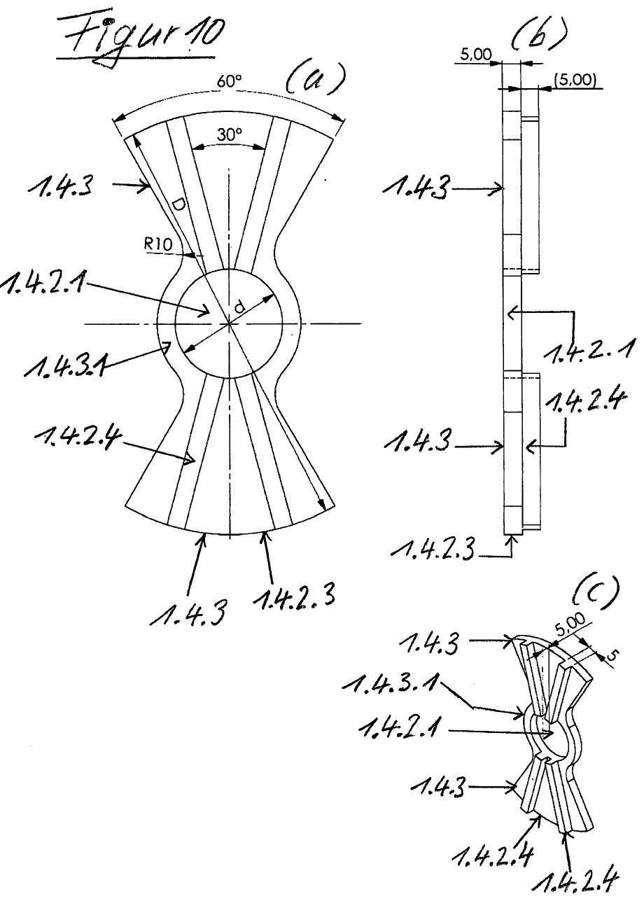

FIG. 12 shows a plan view of the true-to-scale surface of the fan 1.4.3 with the impact webs 1.4.2.4, (a) and (b) show a true-to-scale side views of the striking fan 1.4.2, (c) shows a profile of a striking web 1.4.2.4 and (d) a perspective view of the striking fan 1.4.2;

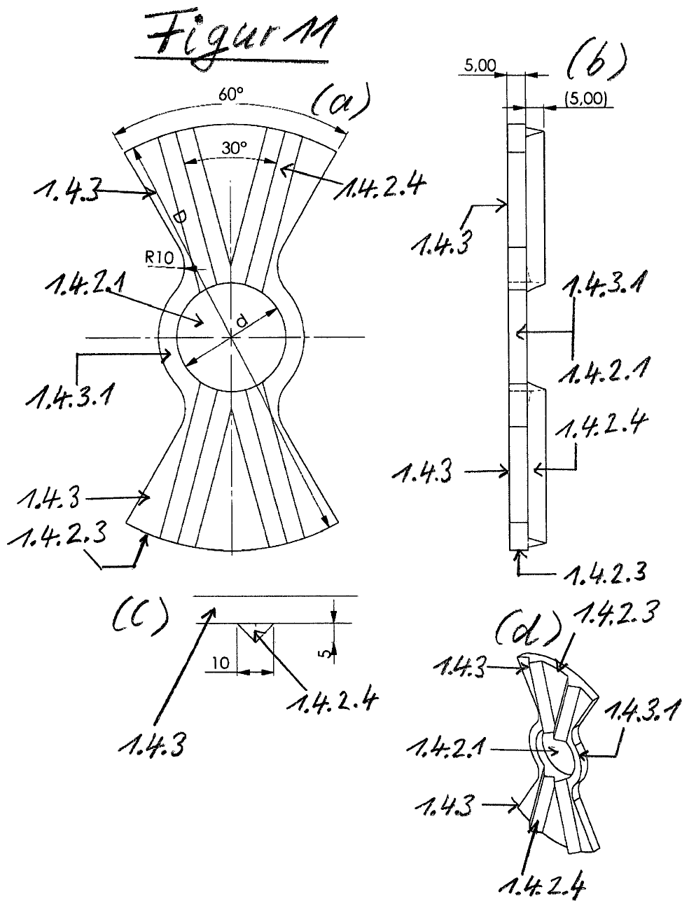

FIG. 13 (a) shows a plan view of the true-to-scale surface of the double striking fan 1.4.3 with the mountain and valley profiles 1.4.3.2 and the U-shaped columns 1.4.3.3, (b) and (d) show true-to-scale side views of the double striking fan 1.4.3, (c) shows a section through the mountain-and-valley profile 1.4.3.2 and (e) a perspective view of the double striking 1.4.3;

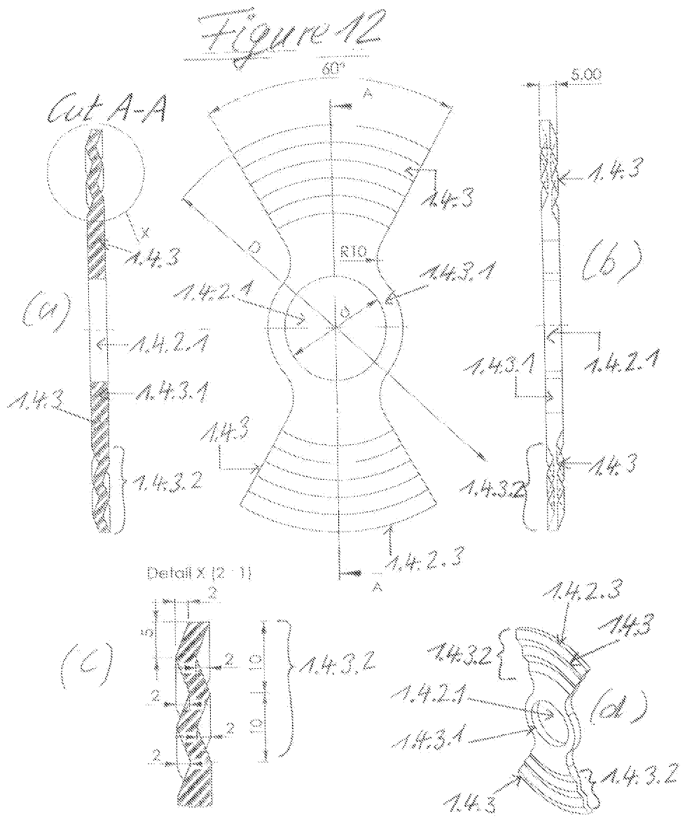

FIG. 14 shows a top view of a striking club 1.4.4 with symmetrically arranged striking bodies 1.4.4.3;

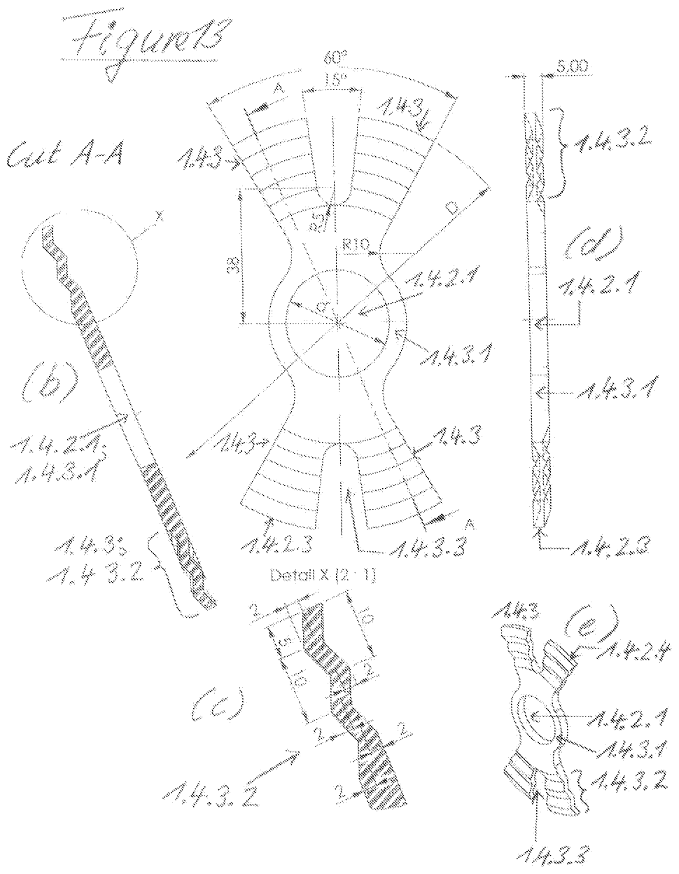

FIG. 15 shows a top view of a striking wing 1.4.5;

FIG. 16 shows a plan view of a further embodiment of the striking wing 1.4.5;

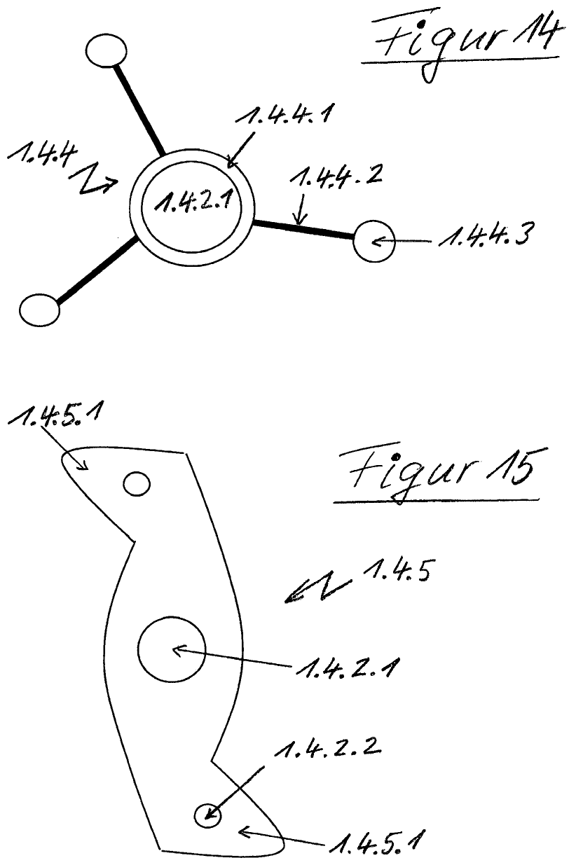

FIG. 17 shows the grinding by two counter-rotating rollers 1.4.6;

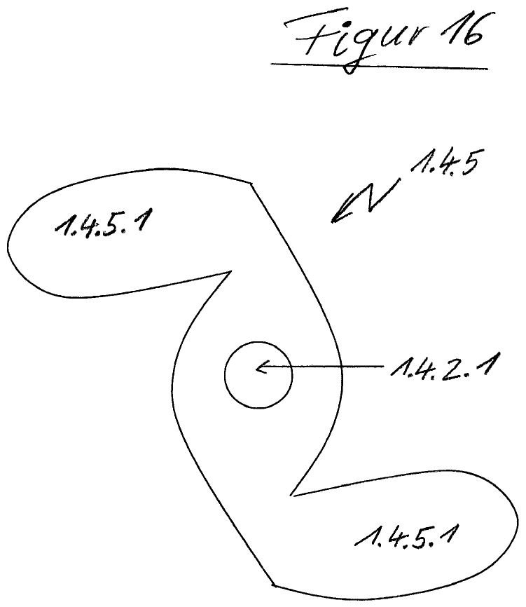

FIG. 18 shows the grinding with two counter-rotating rollers 1.4.6 with surface structures 1.4.6.2;

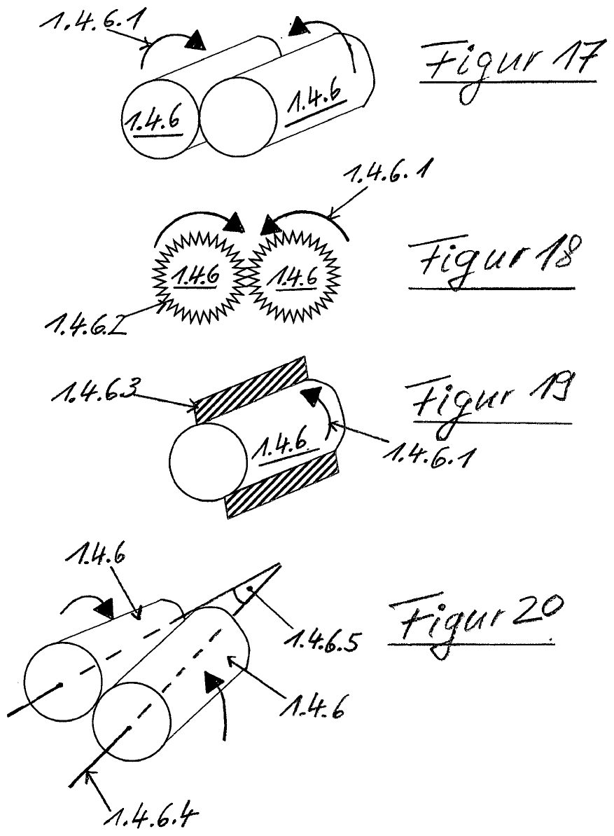

FIG. 19 shows the grinding with a roller 1.4.6 and an abrasion surface 1.4.6.3;

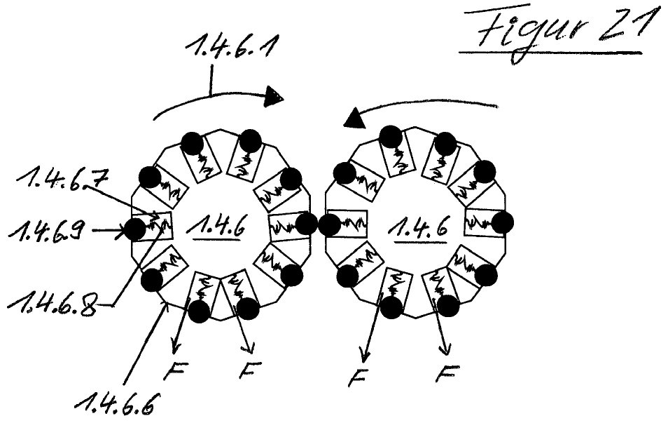

FIG. 20 shows the milling with two counter-rotating inclined rollers 1.4.6 rotating against each other at a certain angle 1.4.6.5

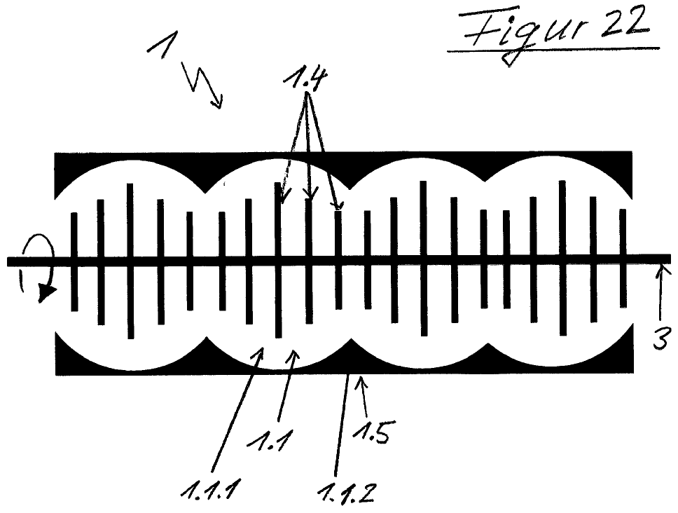

FIG. 21 shows the grinding with two counter-rotating rollers 1.4.6 with resilient surfaces 1.4.6.6;

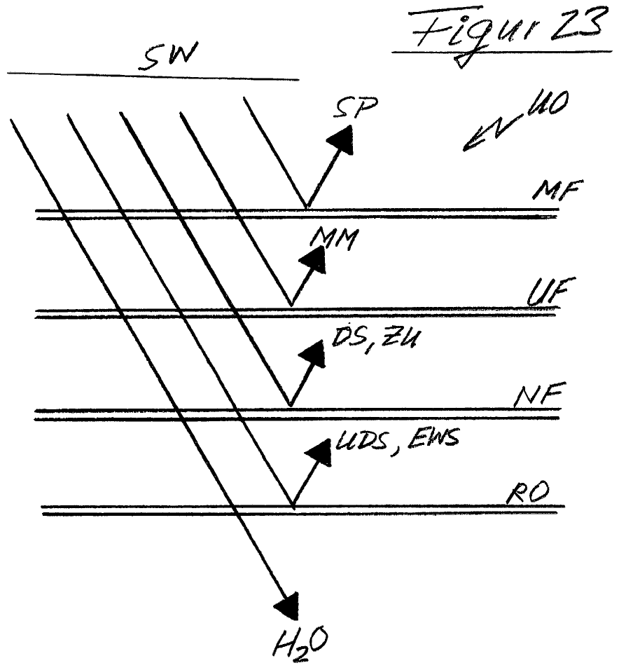

FIG. 22 shows a drum 1.5 comprising several grinding chambers 1.1.1;

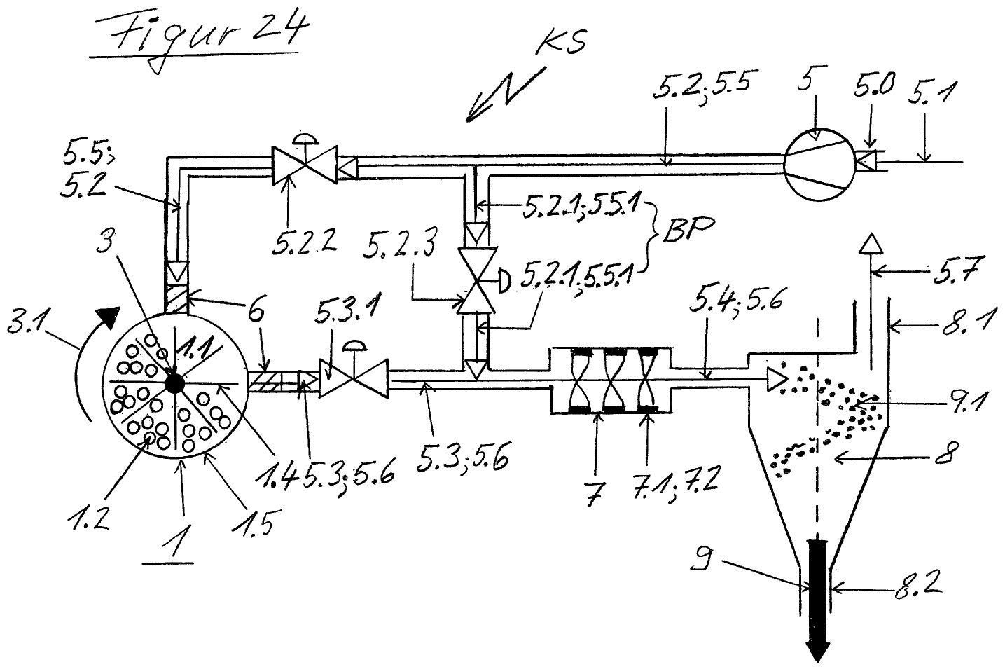

FIG. 23 is a flow diagram of a reverse osmosis system; and

FIG. 24 shows a grain size classifier KS comprising a mechanochemical mill 1, an acoustophoresis device 7 for agglomerating activated carbon particles G and a cyclone 8 for separating the agglomerated activated carbon particles G from the gas phase.

In FIGS. 1 to 24, the reference symbols have the following meaning:
1 Mechanical mill, grinding unit
1.1 Mechanical reactor, waveguide, grinding chamber
1.1.1 Spherical grinding chamber
1.1.2 Circular constriction
1.2 Grinding media
1.3 Grist F
1.4 Agitation means
1.4.1 Attritor
1.4.2 Striking disc
1.4.2.1 Bushing for the drive shaft 3
1.4.2.2 Striking hole
1.4.2.3 Edge
1.4.2.4 Striking bar
1.4.3 Striking fan
1.4.3.1 Ring around the drive shaft 3
1.4.3.2 Hill and valley profile
1.4.3.3 U-shaped divide
1.4.4 Striking club
1.4.4.1 Ring around the drive shaft 3
1.4.4.2 Connecting bar
1.4.4.3 Impactor
1.4.5 Striking wing
1.4.5.1 Striking end
1.4.6 Rotating roller, drum
1.4.6.1 Direction of rotation
1.4.6.2 Spike
1.4.6.3 Abrasion surface
1.4.6.4 Axis of rotation
1.4.6.5 Inclination angle
1.4.6.6 Roller surface
1.4.6.7 Indentation
1.4.6.8 Suspension
1.4.6.9 Sphere
1.5 drum
1.5.1 Inlet for the ground stock F; 1.3
1.5.2 Ground product outlet I
1.5.3 Disc-shaped, vertical drum wall
1.5.3.1 Passage through 1.5.3
1.5.4 drum wall opposite to 1.5.3
1.5.5 Grid, radiolucent window
1.5.5.1 Opening
2 Electromagnetic radiation, corpuscular radiation
2.1 Microwave radiation
3 Drive shaft
3.1 Direction of rotation
4 Motor
5 Fan
5.0 Suction
5.1 Aspirated gas
5.2 Gas stream blown into grinding chamber 1.1 of 1
5.2.1 Gas flow injected into the bypass BP
5.2.2 Control valve in the gas line 5.5 for the gas flow 5.2
5.2.3 Control valve in the gas line 5.5.1 in the bypass BP for the gas flow 5.2.1
5.3 Gas stream loaded with ground grist F
5.3.1 Control valve in the gas line 5.6 for the gas flow 5.3
5.4 Gas flow with agglomerated particles 9.1
5.5 Gas line from the fan 5 to the mechanical mill 1
5.5.1 Gas line in the bypass BP
5.6 Gas line from the mechanical mill 1 to the bypass BP, acoustophoresis unit 7 and cyclone 8
5.7 Cyclone exhaust gas 8
6 Permeable protective grid
7 Acoustophoresis unit
7.1 Ultrasonic source
7.2 Standing wave
8 cyclone
8.1 Exhaust pipe
8.2 Solids outlet
9 Powdered solid I
9.1 Agglomerated particles
A-A cutting line
C-C section line
D diameter of the striking disc 1.4.2
d diameter of the bushing 1.4.2.1 for the drive shaft 3
DS Dissociated acids, divalent salts
EWS monovalent salts
F grist, ground stock, mill base
H₂O water
KS grain size sifter
MF microfiltration
MM macromolecules
NF nanofiltration
R radius
RO reverse osmosis
SP Suspended Particles
SW salt water
T Thickness
UDS Undissociated Acids
UF Ultrafiltration
UO Reverse osmosis
X Enlarged section
ZU Sugar

In the following text, the following abbreviations which are put after the terms have the following meaning:

A Problematic, synthetic, biogenic and biological materials

B phosphates

C Metals and their compounds

D Carbon dioxide, carbon monoxide

E Valuable products

F grist, fluid, solution, suspension, finely divided solid mixture, reactive gas

G Coal, carbon suppliers

H Suspension of a powdery product I

I Powdered Product, Sifted Product I

K Catalytically active particles

Q Piezoelectric particles

Y weight ratio of (A, B, C and/or D and possibly Z) to G

Z Additive

### EXAMPLES 1 TO 3 AND COMPARATIVE EXPERIMENT V1

The grinding units 1 with attritors 1.4.1 described in the German laid-open specification DE 195 04 540 A1 were used for the grinding experiments of Examples 1 to 3 and of Comparative Experiment V1. 2000 steel balls weighing 1 g each were used as grinding media 1.2 in. The weight ratio of the weight of ground stock F:weight of the steel balls 1.2 was 1:10. The grinding tests were carried out under ambient air at atmospheric pressure.

An electric motor 3 according to international patent application WO 2017/055246A2 was used to drive the grinding unit 1 with the attritors 1.4.1. This comprises an electrical motor component with at least one winding for generating a magnetic field, which comprises at least one waveguide, which has a jacket and an inner cavity through which a coolant can be fed, the winding having two ends at which an electrical operating voltage is connected and where

the waveguides are designed in the shape of a round tube and have an outer diameter in a range of 3 mm, the ends of the winding each serve as a coolant inlet or coolant outlet, and

the ends of the winding are connected to a connector that includes a coolant inlet and/or a coolant outlet, multiple waveguide connections for connecting waveguides, a distribution channel through which the coolant is fed into at least one waveguide, and/or a collecting channel in which the coolant emerging from at least one waveguide flows in and is directed to the coolant outlet of the connector.

Motors 3 of this type are sold by Dynamic E Flow GmbH, Kaufbeuren, Germany, under the Capcooltech® brand. The types HC and LC were used.

Mixtures containing potassium nitrate A were provided as millbase F for Examples 1 to 3. The mixture of Comparative Experiment V1 did not contain any potassium nitrate A. Each of the mixtures F was ground for 480 minutes at a speed of the attritor 1.4.1 of 1250 revolutions/min. Samples weighing 0.5 g were taken at 0 minutes (blank sample), after 60 minutes, after 120 minutes and after 480 minutes and eluted with 50 ml of deionized water. The respective nitrate content A according to DIN EN ISO 10304-1 and the ammonium content A according to DIN EN ISO 11732 were then measured.

Table 1 gives an overview of the mixtures F and the results of the measurements.

TABLE 1
Examples 1 to 3 and Comparative Experiment V1

| | | Milling | | |
|---|---|---|---|---|
| | Ground stock F | time | Ammonium A | Nitrate A |
| No. | Composition | h | mg/Liter | mg/Liter |
| V1 | 2 Gew.-% Ammonium | 0 | 84.9 | <1 |
| | chloride A | | | |
| | 49 Gew.-% Coal G | | | |
| | 49 Gew.-% Quartz sand Q | | | |
| ″ | ″ | 60 | 20.7 | <1 |
| ″ | ″ | 120 | 10.8 | <1 |
| ″ | ″ | 480 | 9.5 | <1 |
| 1 | 2 Gew.-% Potassium | 0 | <1 | 163 |
| | nitrate A | | | |
| | 49 Gew.-% Coal G | | | |
| | 49 Gew.-% Quartz sand Q | | | |
| ″ | ″ | 60 | <1 | 87.4 |
| ″ | ″ | 120 | <1 | 29.6 |
| ″ | ″ | 480 | <1 | 28.1 |
| 2 | 2 Gew.-% Potassium | 0 | 67.1 | 129 |
| | nitrate A | | | |
| | 2 Gew.-% Ammonium | | | |
| | chloride A | | | |
| | 48 Gew.-% Coal G | | | |
| | 48 Gew.-% Quartz sand Q | | | |
| ″ | ″ | 60 | 19.7 | 67.5 |
| ″ | ″ | 120 | 7.9 | 31.4 |
| ″ | ″ | 480 | 5.8 | 26.5 |
| 3 | 2 Gew.-% Potassium | 0 | 91.8 | 177 |
| | nitrate A | | | |
| | 2 Gew.-% Ammonium | | | |
| | chloride A | | | |
| | 2 Gew.-% Trisodium- | | | |
| | phosphate B | | | |
| | 47 Gew.-% Coal G | | | |
| | 47 Gew.-% Quartz sand Q | | | |
| ″ | ″ | 60 | 22.7 | 78.5 |
| ″ | ″ | 120 | 8.5 | 36.2 |
| ″ | ″ | 480 | 8.1 | 43.5 |

It was found that the majority of ammonium A and nitrate A had already been eliminated after 60 to 120 minutes of grinding.

### EXAMPLES 4 TO 6 AND COMPARATIVE EXPERIMENT V2

The Grinding of Fermentation Residues A—Influence of the Material Compositions

The grinding tests were carried out essentially as described in Examples 1 to 3 and the comparative test C1. Table 2 gives an overview of the material compositions of the ground stock F. The weight ratio of grinding media 1.2 to ground stock F was 50:1 in all cases. The number of revolutions was 1250 rpm in all cases. After milling times of 0, 1, 2 and 3 hours, 0.5 g of each of the finely divided powdery products I was eluted with 50 ml of distilled water in accordance with DIN 38414-4 DIN EN 12457-4. The respective concentrations of the ammonium ions A were determined in mg/liter in accordance with DIN EN ISO 11732. The results can also be found in Table 2.

TABLE 2
The Grinding of Fermentation Residues A
- Influence of the Material Compositions

| | Example | | | | | |
|---|---|---|---|---|---|---|
| | | | Acti- | | Milling | |
| | Fermentatio | Quartz- | vated | | Time | |
| | residue | sand | Coal | KCl | under | Ammo- |
| Comparative | F | Q | G | Z | air | nium |
| Example V | (g) | (g) | (g) | (g) | (h) | A |
| V2 | 25 | 25 | — | — | 0 | 21.1 |
| ″ | 25 | 25 | — | — | 1 | 10.8 |
| ″ | 25 | 25 | — | — | 2 | 11.6 |
| ″ | 25 | 25 | — | — | 3 | 9.1 |
| 4 | 25 | 25 | 25 | — | 0 | 25.1 |
| ″ | 25 | 25 | 25 | — | 1 | 3.12 |
| ″ | 25 | 25 | 25 | — | 2 | 4.43 |
| ″ | 25 | 25 | 25 | — | 3 | 2.6 |
| 5 | 25 | — | 25 | — | 0 | 11.3 |
| ″ | 25 | — | 25 | — | 1 | 4.19 |
| ″ | 25 | — | 25 | — | 2 | 3.25 |
| ″ | 25 | — | 25 | — | 3 | 1.55 |
| 6 | 25 | 25 | 25 | 25 | 0 | 11.3 |
| ″ | 25 | 25 | 25 | 25 | 1 | 4.19 |
| ″ | 25 | 25 | 25 | 25 | 2 | 3.25 |
| ″ | 25 | 25 | 25 | 25 | 3 | 1.55 |

The test results show that the decrease in ammonium ions A in the samples with activated carbon G or quartz Q and activated carbon A was significantly greater than in the sample without activated carbon.

### EXAMPLE 7

The Mechanochemical Degradation of Drug A as a Model for the Fourth Purification Stage of Sewage Treatment Plants

Quartz sand Q and activated carbon G (Example 7, tests numbers 1 to 4 and 13 to 16), quartz sand Q alone (example 7, tests numbers 9 to 12 and 21 to 24) and activated carbon G alone (example 7, tests 5 to 8 and 17 to 20) were each mixed with a mixture A consisting of 2 tablets propofol, 1 tablet loratidine, 2 tablets Ibuflam and one tablet ACC. The resulting mixtures F were rubbed dry once and a portion was poured over 150 ml of distilled water, then allowed to soak for 48 hours and then dried at room temperature under a water jet vacuum for 2 hours. The samples F were then milled under air and under argon. The grinding tests were carried out as described in Examples 4 to 6. Table 3 gives an overview of the test conditions used.

TABLE 3
The Mechanochemical Degradation of Drugs

| Example | | | | |
|---|---|---|---|---|
| 7 | Quartz sand | Activated | Milling | |
| Trial | Q | coal G | time | |
| No . | (g) | (g) | (min) | RPM |
| 1 | 20 | 20 | 30 | 1100 |
| 2 | 20 | 20 | 60 | 1100 |
| 3 | 20 | 20 | 120 | 1100 |
| 4 | 20 | 20 | 180 | 1100 |
| 5 | 0 | 40 | 30 | 1100 |
| 6 | 0 | 40 | 60 | 1100 |
| 7 | 0 | 40 | 120 | 1100 |
| 8 | 0 | 40 | 180 | 1100 |
| 9 | 40 | 0 | 30 | 1100 |
| 10 | 40 | 0 | 60 | 1100 |
| 11 | 40 | 0 | 120 | 1100 |
| 12 | 40 | 0 | 180 | 1100 |
| 13 | 20 | 20 | 30 | 800 |
| 14 | 20 | 20 | 60 | 800 |
| 15 | 20 | 20 | 120 | 800 |
| 16 | 20 | 20 | 180 | 800 |
| 17 | 0 | 40 | 30 | 800 |
| 18 | 0 | 40 | 60 | 800 |
| 19 | 0 | 40 | 120 | 800 |
| 20 | 0 | 40 | 180 | 800 |
| 21 | 40 | 0 | 30 | 800 |
| 22 | 40 | 0 | 60 | 800 |
| 23 | 40 | 0 | 120 | 800 |
| 24 | 40 | 0 | 180 | 800 |

The results of the tests can be summarized as follows:

1. The degradation of medication A with activated carbon G alone was faster than that with quartz sand Q alone.

2. After a longer grinding time (about 2 hours), the effect of quartz sand Q was stronger than that of activated carbon G, so adding a small amount of quartz sand Q was advantageous.

3. The decrease followed the natural logarithm, with all compounds being decomposed after 60 minutes.

4. Propofol A was broken down much more slowly than the other drugs A.

5. A significant difference between the sumped-in mixtures F and the dry-mixed mixtures F could not be determined. However, there was a certain trend that the sumped mixtures F degraded somewhat more quickly.

6. The speed of rotation was a decisive factor. The degradation of the drugs F was twice as fast at 1100 RPM as the degradation at 800 RPM.

7. No difference could be found between the grinding under inert gas Z and under air.

### EXAMPLE 8

The Recovery of Phosphate B from the Fourth Purification Stage of a Sewage Treatment Plant

Granulated loaded activated carbon G from a basin of the fourth purification stage was roughly cleaned once in a water bath. It was then dried in a commercially available drying system at elevated temperature and under reduced pressure. Thereafter, the dried activated carbon G was continuously introduced into a mechanical mill 1 with a drum 1.5 with a volume of 900 liters. The mechanical mill 1 contained 1000 steel balls 1.2 of 5 mm diameter, which were prevented by a protective grid 6 from exiting the drum 1.5. The dried activated carbon G was entered through the protective grid 6 at the upper opening (1.5.1, inlet for ground material F) and separated again centrally by means of a cyclone 8. About 100 kg of coal G ran through the mechanochemical mill 1 in 1 hour. Alternatively, the process could be carried out discontinuously as a batch process with the same quantities.

The number of revolutions of the mill 1 was 1100 rpm. The ground grist F with the reactivated activated carbon G was pressed discontinuously or continuously into pellets G in a commercially available pelletizing system. The pellets were then again added to the basin of the fourth purification stage. A loss of activated carbon G could not be observed here. Sand contamination did not interfere with the process.

The soluble phosphates B present could be eluted in a separate wash cycle before or after the activated carbon G was pelletized.

### EXAMPLE 9

The Processing of Manure A into Activated Carbon G

1000 kg of slurry A, which contained nitrates A, ammonium A, phosphates B and heavy metals C, were dried with a commercially available digestate dryer. This left 80 kg of dry matter as ground stock F. The drying was carried out at an elevated temperature, and the ammonia A which escaped was bound with sulfuric acid, as described in German patent application DE 10 2016 004 162 A1. The resulting ammonium sulfate A could be processed further together with the dry matter F. The dry matter F and the ammonium sulfate A were premilled in a separate mechanical mill 1. Then, they were continuously introduced into a mechanical mill 1 with a drum 1.5 of a volume of 900 liters together with half the amount of activated carbon G from above through a protective grid 6 which prevented the grinding media 1.2 from exiting. 1000 kg of steel balls 1.2 with a diameter of 5 mm were used as grinding media 1.2. The ground material F was separated again centrally by means of a cyclone 8. About 100 kg of dry material F ran through the mechanical mill 1 in 1 hour and were ground at a constant speed of 1100 rpm.

The resulting solid, finely divided product I contained significantly fewer nitrate ions A and ammonium ions A than the starting products F. In addition, the heavy metals C were immobilized.

In addition or as an alternative to carbon G, sheet silicates Z such as bentonite or montmorillonite could be introduced to immobilize the heavy metals C.

The solid, finely divided product I was pressed in a commercially available pelletizing plant and used as an alternative E to terra preta as a phosphate fertilizer E and a coal fertilizer E, which promoted humus formation and microbial growth.

Alternatively, the phosphate B could also be removed from the pellets G. The remaining material was excellently suitable as a substitute for activated carbon G to bind VOCs (volatile organic compounds), as a filler for the production of panels and as a substitute for wood and sand.

### EXAMPLE 10

The Recovery of Iridium C from Spent Nafion Membranes A

500 kg of used Nafion membranes A were shredded and dry mixed with 100 kg of activated carbon G and 20 kg of solid sodium hydroxide solution Z and pre-ground. The mixture F was then introduced continuously into a mechanochemical mill 1 as described in Examples 8 and 9 and ground for 2 hours at a speed of 1100 rpm. The finely divided solid powder I separated with the aid of a cyclone 8 was eluted with water, whereby the resulting sodium fluoride I was washed out. The remaining powder I contained the immobilized iridium C. This was recovered by burning the powder I.

### EXAMPLE 11 TO 15

The Mechanochemical Processing of Biomass A, the Elimination of Nitrates A and Ammonium A and the Recovery of Phosphate B

Biomass A, quartz sand Q and activated carbon G were mixed together in various amounts. Sodium nitrate A, ammonium chloride A and glassy ultraphosphate B were added in varying amounts to the mixtures. The resulting mixtures F were rubbed dry. Part of each of these was poured over once with 150 ml of distilled water, soaked for 48 hours, then dried at room temperature under a waterjet vacuum for 2 hours and then ground. In parallel, the dry mixed mixtures F were ground. All experiments were carried out once under air and once under argon Z. The devices 1 described in Examples 1 to 3 were used for this purpose. In all cases, after 30 minutes, 60 minutes, 120 minutes and 180 minutes, samples I were taken from the resulting ground mixtures F and eluted with distilled water. The solutions were then analyzed.

Tables 4 to 8 give an overview of the materials used and their proportions.

TABLE 4
Mechanochemical grinding of biomass A with the additives
Sodium Nitrate A, Ammonium chloride A and Ultraphosphate
B under Air and under Argon Z

| | Ex. 11 | | | | | | | |
|---|---|---|---|---|---|---|---|---|
| | | Acti- | | | | Ultra- | | |
| | Quartz- | vated | Bio- | | | phos- | Mill- | |
| | Sand | Coal | mass | NaNO₃ | NH₄Cl | phate | ing | |
| Tri. | Q | G | A | A | A | B | time | |
| No. | [g] | [g] | [g] | [g] | [g] | [g] | [min] | RPM |
| 1 | 30 | 30 | 30 | 5 | 5 | 5 | 30 | 1100 |
| 2 | 30 | 30 | 30 | 5 | 5 | 5 | 60 | 1100 |
| 3 | 30 | 30 | 30 | 5 | 5 | 5 | 120 | 1100 |
| 4 | 30 | 30 | 30 | 5 | 5 | 5 | 180 | 1100 |
| 5 | 0 | 45 | 45 | 5 | 5 | 5 | 30 | 1100 |
| 6 | 0 | 45 | 45 | 5 | 5 | 5 | 60 | 1100 |
| 7 | 0 | 45 | 45 | 5 | 5 | 5 | 120 | 1100 |
| 8 | 0 | 45 | 45 | 5 | 5 | 5 | 180 | 1100 |
| 9 | 45 | 0 | 45 | 5 | 5 | 5 | 30 | 1100 |
| 10 | 45 | 0 | 45 | 5 | 5 | 5 | 60 | 1100 |
| 11 | 45 | 0 | 45 | 5 | 5 | 5 | 120 | 1100 |
| 12 | 45 | 0 | 45 | 5 | 5 | 5 | 180 | 1100 |
| 13 | 30 | 30 | 30 | 5 | 5 | 5 | 30 | 800 |
| 14 | 30 | 30 | 30 | 5 | 5 | 5 | 60 | 800 |
| 15 | 30 | 30 | 30 | 5 | 5 | 5 | 120 | 800 |
| 16 | 30 | 30 | 30 | 5 | 5 | 5 | 180 | 800 |
| 17 | 0 | 45 | 45 | 5 | 5 | 5 | 30 | 800 |
| 18 | 0 | 45 | 45 | 5 | 5 | 5 | 60 | 800 |
| 19 | 0 | 45 | 45 | 5 | 5 | 5 | 120 | 800 |
| 20 | 0 | 45 | 45 | 5 | 5 | 5 | 180 | 800 |
| 21 | 45 | 0 | 45 | 5 | 5 | 5 | 30 | 800 |
| 22 | 45 | 0 | 45 | 5 | 5 | 5 | 60 | 800 |
| 23 | 45 | 0 | 45 | 5 | 5 | 5 | 120 | 800 |
| 24 | 45 | 0 | 45 | 5 | 5 | 5 | 180 | 800 |

Ex. = Example;
Tri. = Trial

TABLE 5
Mechanochemical Grinding of Biomass A with the Additives
Sodium Nitrate A, Ammonium Chloride A and Ultraphosphate
B under Air and under Argon Z

| | Ex. 12 | | | | | | |
|---|---|---|---|---|---|---|---|
| | | Acti- | | | | | |
| | Quartz- | vated | | | Ultra- | | |
| | sand | Coal | Biomass | NH₄Cl | phosphat | Milling | |
| Tri. | Q | G | A | A | B | time | |
| No. | [g] | [g] | [g] | [g] | [g] | [min] | RPM |
| 1 | 30 | 30 | 30 | 7.5 | 7.5 | 30 | 1100 |
| 2 | 30 | 30 | 30 | 7.5 | 7.5 | 60 | 1100 |
| 3 | 30 | 30 | 30 | 7.5 | 7.5 | 120 | 1100 |
| 4 | 30 | 30 | 30 | 7.5 | 7.5 | 180 | 1100 |
| 5 | 0 | 45 | 45 | 7.5 | 7.5 | 30 | 1100 |
| 6 | 0 | 45 | 45 | 7.5 | 7.5 | 60 | 1100 |
| 7 | 0 | 45 | 45 | 7.5 | 7.5 | 120 | 1100 |
| 8 | 0 | 45 | 45 | 7.5 | 7.5 | 180 | 1100 |
| 9 | 45 | 0 | 45 | 7.5 | 7.5 | 30 | 1100 |
| 10 | 45 | 0 | 45 | 7.5 | 7.5 | 60 | 1100 |
| 11 | 45 | 0 | 45 | 7.5 | 7.5 | 120 | 1100 |
| 12 | 45 | 0 | 45 | 7.5 | 7.5 | 180 | 1100 |
| 13 | 30 | 30 | 30 | 7.5 | 7.5 | 30 | 800 |
| 14 | 30 | 30 | 30 | 7.5 | 7.5 | 60 | 800 |
| 15 | 30 | 30 | 30 | 7.5 | 7.5 | 120 | 800 |
| 16 | 30 | 30 | 30 | 7.5 | 7.5 | 180 | 800 |
| 17 | 0 | 45 | 45 | 7.5 | 7.5 | 30 | 800 |
| 18 | 0 | 45 | 45 | 7.5 | 7.5 | 60 | 800 |
| 19 | 0 | 45 | 45 | 7.5 | 7.5 | 120 | 800 |
| 20 | 0 | 45 | 45 | 7.5 | 7.5 | 180 | 800 |
| 21 | 45 | 0 | 45 | 7.5 | 7.5 | 30 | 800 |
| 22 | 45 | 0 | 45 | 7.5 | 7.5 | 60 | 800 |
| 23 | 45 | 0 | 45 | 7.5 | 7.5 | 120 | 800 |
| 24 | 45 | 0 | 45 | 7.5 | 7.5 | 180 | 800 |

Ex. = Example;
Tri. = Trial

TABLE 6
Mechanochemical Grinding of Biomass A with the Additives
Sodium Nitrate A, Ammonium Chloride A and Ultraphosphate
B under Air and under Argon Z

| | Ex. 13 | | | | | | |
|---|---|---|---|---|---|---|---|
| | | Acti- | | | | | |
| | Quartz- | vated | | | Ultra- | | |
| | sand | Coal | Biomass | NaNO₃ | phosphate | Milling | |
| Tri. | Q | G | A | A | B | Time | |
| No. | [g] | [g] | [g] | [g] | [g] | [min] | RPM |
| 1 | 30 | 30 | 30 | 7.5 | 7.5 | 30 | 1100 |
| 2 | 30 | 30 | 30 | 7.5 | 7.5 | 60 | 1100 |
| 3 | 30 | 30 | 30 | 7.5 | 7.5 | 120 | 1100 |
| 4 | 30 | 30 | 30 | 7.5 | 7.5 | 180 | 1100 |
| 5 | 0 | 45 | 45 | 7.5 | 7.5 | 30 | 1100 |
| 6 | 0 | 45 | 45 | 7.5 | 7.5 | 60 | 1100 |
| 7 | 0 | 45 | 45 | 7.5 | 7.5 | 120 | 1100 |
| 8 | 0 | 45 | 45 | 7.5 | 7.5 | 180 | 1100 |
| 9 | 45 | 0 | 45 | 7.5 | 7.5 | 30 | 1100 |
| 10 | 45 | 0 | 45 | 7.5 | 7.5 | 60 | 1100 |
| 11 | 45 | 0 | 45 | 7.5 | 7.5 | 120 | 1100 |
| 12 | 45 | 0 | 45 | 7.5 | 7.5 | 180 | 1100 |
| 13 | 30 | 30 | 30 | 7.5 | 7.5 | 30 | 800 |
| 14 | 30 | 30 | 30 | 7.5 | 7.5 | 60 | 800 |
| 15 | 30 | 30 | 30 | 7.5 | 7.5 | 120 | 800 |
| 16 | 30 | 30 | 30 | 7.5 | 7.5 | 180 | 800 |
| 17 | 0 | 45 | 45 | 7.5 | 7.5 | 30 | 800 |
| 18 | 0 | 45 | 45 | 7.5 | 7.5 | 60 | 800 |
| 19 | 0 | 45 | 45 | 7.5 | 7.5 | 120 | 800 |
| 20 | 0 | 45 | 45 | 7.5 | 7.5 | 180 | 800 |
| 21 | 45 | 0 | 45 | 7.5 | 7.5 | 30 | 800 |
| 22 | 45 | 0 | 45 | 7.5 | 7.5 | 60 | 800 |
| 23 | 45 | 0 | 45 | 7.5 | 7.5 | 120 | 800 |
| 24 | 45 | 0 | 45 | 7.5 | 7.5 | 180 | 800 |

Ex. = Example;
Tri. = Trial

TABLE 7
Mechanochemical Grinding of Biomass A with
the Additives Sodium Nitrate A and Ammonium
Chloride A under Air and under Argon Z

| | Ex. 14 | | | | | | |
|---|---|---|---|---|---|---|---|
| | | Acti- | | | | | |
| | Quartz- | vated | | | | | |
| | Sand | Coal | Biomass | NaNO₃ | NH₄C1 | Milling | |
| Tri. | Q | G | A | A | A | Time | |
| No. | [g] | [g] | [g] | [g] | [g] | [min] | RPM |
| 1 | 30 | 30 | 30 | 7.5 | 7.5 | 30 | 1100 |
| 2 | 30 | 30 | 30 | 7.5 | 7.5 | 60 | 1100 |
| 3 | 30 | 30 | 30 | 7.5 | 7.5 | 120 | 1100 |
| 4 | 30 | 30 | 30 | 7.5 | 7.5 | 180 | 1100 |
| 5 | 0 | 45 | 45 | 7.5 | 7.5 | 30 | 1100 |
| 6 | 0 | 45 | 45 | 7.5 | 7.5 | 60 | 1100 |
| 7 | 0 | 45 | 45 | 7.5 | 7.5 | 120 | 1100 |
| 8 | 0 | 45 | 45 | 7.5 | 7.5 | 180 | 1100 |
| 9 | 45 | 0 | 45 | 7.5 | 7.5 | 30 | 1100 |
| 10 | 45 | 0 | 45 | 7.5 | 7.5 | 60 | 1100 |
| 11 | 45 | 0 | 45 | 7.5 | 7.5 | 120 | 1100 |
| 12 | 45 | 0 | 45 | 7.5 | 7.5 | 180 | 1100 |
| 13 | 30 | 30 | 30 | 7.5 | 7.5 | 30 | 800 |
| 14 | 30 | 30 | 30 | 7.5 | 7.5 | 60 | 800 |
| 15 | 30 | 30 | 30 | 7.5 | 7.5 | 120 | 800 |
| 16 | 30 | 30 | 30 | 7.5 | 7.5 | 180 | 800 |
| 17 | 0 | 45 | 45 | 7.5 | 7.5 | 30 | 800 |
| 18 | 0 | 45 | 45 | 7.5 | 7.5 | 60 | 800 |
| 19 | 0 | 45 | 45 | 7.5 | 7.5 | 120 | 800 |
| 20 | 0 | 45 | 45 | 7.5 | 7.5 | 180 | 800 |
| 21 | 45 | 0 | 45 | 7.5 | 7.5 | 30 | 800 |
| 22 | 45 | 0 | 45 | 7.5 | 7.5 | 60 | 800 |
| 23 | 45 | 0 | 45 | 7.5 | 7.5 | 120 | 800 |
| 24 | 45 | 0 | 45 | 7.5 | 7.5 | 180 | 800 |

Ex. = Example;
Tri. = Trial

TABLE 8
Mechanochemical Grinding of Biomass A with
the Additives Sodium Nitrate A and Ammonium
Chloride A under Air and under Argon Z

| | Ex. 15 | | | | | | |
|---|---|---|---|---|---|---|---|
| | | Acti- | | | | | |
| | Quartz- | vated | | | | | |
| | sand | Coal | Biomasse | NaNO₃ | NH₄C1 | Milling | |
| Tri. | Q | G | A | A | A | time | |
| No. | [g] | [g] | [g] | [g] | [g] | [min] | RPM |
| 1 | 30 | 30 | 30 | 7.5 | 7.5 | 30 | 1100 |
| 2 | 30 | 30 | 30 | 7.5 | 7.5 | 60 | 1100 |
| 3 | 30 | 30 | 30 | 7.5 | 7.5 | 120 | 1100 |
| 4 | 30 | 30 | 30 | 7.5 | 7.5 | 180 | 1100 |
| 5 | 0 | 45 | 45 | 7.5 | 7.5 | 30 | 1100 |
| 6 | 0 | 45 | 45 | 7.5 | 7.5 | 60 | 1100 |
| 7 | 0 | 45 | 45 | 7.5 | 7.5 | 120 | 1100 |
| 8 | 0 | 45 | 45 | 7.5 | 7.5 | 180 | 1100 |
| 9 | 45 | 0 | 45 | 7.5 | 7.5 | 30 | 1100 |
| 10 | 45 | 0 | 45 | 7.5 | 7.5 | 60 | 1100 |
| 11 | 45 | 0 | 45 | 7.5 | 7.5 | 120 | 1100 |
| 12 | 45 | 0 | 45 | 7.5 | 7.5 | 180 | 1100 |
| 13 | 30 | 30 | 30 | 7.5 | 7.5 | 30 | 800 |
| 14 | 30 | 30 | 30 | 7.5 | 7.5 | 60 | 800 |
| 15 | 30 | 30 | 30 | 7.5 | 7.5 | 120 | 800 |
| 16 | 30 | 30 | 30 | 7.5 | 7.5 | 180 | 800 |
| 17 | 0 | 45 | 45 | 7.5 | 7.5 | 30 | 800 |
| 18 | 0 | 45 | 45 | 7.5 | 7.5 | 60 | 800 |
| 19 | 0 | 45 | 45 | 7.5 | 7.5 | 120 | 800 |
| 20 | 0 | 45 | 45 | 7.5 | 7.5 | 180 | 800 |
| 21 | 45 | 0 | 45 | 7.5 | 7.5 | 30 | 800 |
| 22 | 45 | 0 | 45 | 7.5 | 7.5 | 60 | 800 |
| 23 | 45 | 0 | 45 | 7.5 | 7.5 | 120 | 800 |
| 24 | 45 | 0 | 45 | 7.5 | 7.5 | 180 | 800 |

Ex. = Example;
Tri. = Trial

The following general tendencies can be derived from the test results of Examples 11 to 15.

1. The degradation of the biomass A and the nitrogenous compounds A proceeded faster with activated carbon G than with quartz sand Q.

2. After about 2 hours, however, the effect of quartz sand Q was stronger than that of activated carbon G, so it was advisable to add small amounts of quartz sand Q to the mixtures.

3. The decrease in nitrogen-containing compounds A followed the natural logarithm, with all nitrogen-containing compounds A having been broken down after 60 minutes.

4. A significant difference in the breakdown of the nitrogen-containing compounds A between the sumped-in mixtures F and the dry-prepared mixtures F could not be determined. There was only a certain trend that the sumped mixtures F showed faster degradation.

5. The number of revolutions was the decisive factor. For example, the breakdown of the nitrogen-containing compounds A is twice as fast at 1,100 RPM as that at 800 RPM.

6. No difference was found between the rate of degradation when grinding in air and the rate of degradation when grinding under argon.

7. The ultraphosphate B could be converted into biologically available, water-soluble phosphate B by grinding.

8. The different amounts of sodium nitrate A and ammonium chloride A had no influence on the degradation rates.

### EXAMPLE 16

The Elimination of Nitrates A and Ammonium A and the Immobilization of Trace Elements C in Coal G and the Reuse of Coal G in Biogas Plants

10,000 kg of slurry A, which contained nitrates A, ammonium A, phosphates B and traces of arsenic C and heavy metals C, were gradually dried using a commercially available digestate dryer. A total of 800 kg of dry matter F remained. The drying was carried out at an elevated temperature, and the ammonia A which escaped was bound with sulfuric acid, as described in German patent application DE 10 2016 004 162 A1. The resulting ammonium sulfate A could be processed further together with the dry matter F. The dry matter F and the ammonium sulfate A were premilled in a separate mechanical mill 1. Then they were entered from above together with half the amount of activated carbon G, 50 kg of bentonite Z and 10 kg of N,N,N′,N′-ethylenediaminetetra-(methylenephosphonic acid) Z continuously in a mechanical mill 1 with a drum 1.5 of a volume of 900 liters through a protective grille 6, which prevented the grinding media 1.2 from exiting. 1000 kg of steel balls 1.2 with a diameter of 5 mm were used as grinding media 1.2. The ground material F was separated again centrally by means of a cyclone 8. About 100 kg of dry material F ran through the mechanical mill 1 in one hour and were ground at a constant speed of 1,100 rpm.

The resulting solid, finely divided product I contained significantly fewer nitrate ions A and ammonium ions A than the original dry matter F. In addition, arsenic C, the heavy metals C and their compounds C were immobilized in the coal G, in the bentonite Z, and with the chelate complexing agent Z and thus could no longer get into the groundwater, which was a major benefit.

The water-soluble phosphate B was washed out of the solid, finely divided product I, and the resulting solution could be used as liquid fertilizer E.

The washed product I could be returned to the biogas plant as dry matter or in a moist state in any form in order to increase the methane formation.

### EXAMPLE 17

The Mechanochemical Processing of Manure A and the Elimination of Nitrates A in the Presence of Catalytically Active Iron Particles K.

A slurry containing 200 mg/L nitrate ions was dried in a customary and known manner. 100 parts by weight of the dried manure A, 34 parts by weight of quartz sand Q, 34 parts by weight of activated carbon G and 2 parts by weight of catalytic iron particles K were mixed with one another and ground as described in the Examples 1 to 3. After 30 minutes, 60 minutes, 90 minutes, 120 minutes, 180 minutes and 240 minutes, samples I were removed from the mill base F and eluted with distilled water. The respective nitrate content A was then determined. It was 180 mg/L, 120 mg/L, 90 mg/L, 50 mg/L, 36 mg/L, 21 mg/L and 11 mg/L, respectively.

The example demonstrated that the mechanochemical process according to the invention was outstandingly suitable for the elimination of nitrates A in biomasses.

### EXAMPLE 18

The Mechanochemical Immobilization of Carcinogenic Hexavalent Chromium A

A mill base F was prepared from 50 parts by weight of activated carbon G, 50 parts by weight of quartz sand and 10 parts by weight of potassium dichromate C and ground as described in the Examples 1 to 3. After 120 minutes, samples were taken from the powdery product I. The samples I were eluted with water and it was checked whether water-soluble chromium salts C were still present. However, the concentrations were below the detection limits of the customary and known methods for determining chromium C. For comparison, the chromium content of the powdered product I was analyzed in the customary and known manner. Almost the entire original amount of chromium C was found. Thus the original amount of hexavalent chromium C was almost completely immobilized. The small missing amounts of chromium C had apparently been taken up by the materials in cavity 1.1 of mechanical mill 1

### EXAMPLES 19 AND 20

Mechanical Mills for Carrying Out Mechanochemical Processes

The mechanical mill 1 for mechanochemical processes comprised at least one rotatable (Example 18; FIG. 1) or fixed (Example 19; FIG. 2) mechanochemical reactor and waveguide 1.1, containing a variety of balls made of technical ceramic as grinding media 1.2 in a drum 1.5 made of stainless steel and lined with technical ceramic, at least one inlet 1.5.1 for the grist F; 1.3 and at least one outlet 1.5.2 for the ground product I.

The drum 1.5 of the rotatable mechanochemical reactor and waveguide 1.1 of example 19 (FIG. 1) had a disk-shaped vertical drum wall 1.5.3 which was connected in its center to a rotating drive shaft 3 driven by a motor 4.

The drum 1.5 of the stationary mechanochemical reactor and waveguide 1.1 of Example 20 (FIG. 2) had an attritor 1.4 made of stainless steel, coated with technical ceramics, for mixing the grinding media 1.2 and the ground material 1.3. The attritor was arranged to be rotatable along the longitudinal axis of the drum 1.5 by a rotatable drive shaft 3 which was driven by a motor 4 and which passed through the disk-shaped vertical drum wall 1.5.3 through a bushing 1.5.3.1.

Both in the mechanical mill 1 of Example 19 (FIG. 1) and in the mechanical mill 1 of Example 20 (FIG. 2), the disk-shaped vertical drum wall 1.5.3 and the opposing drum wall 1.5.4 consisted of a electromagnetic radiation and/or corpuscular radiation 2.1 permeable, removable, scratch-resistant and impact-resistant grid 1.5.5 made of ceramic, which separated the mechanochemical reactors and waveguides 1.1 from the microwave generators 2.

The microwave generators 2 were firmly connected to mechanochemical reactors and waveguides 1.1 by means of flanges. The openings 1.5.5.1 in the grids 1.5.5 were round and formed a pattern. The grids 1.5.5 with round openings 1.5.5.1 could be replaced by grids 1.5.5 with openings 1.5.5.1 with 3-cornered, 4-cornered, 5-cornered, 6-cornered and slot-shaped outlines.

The drum 1.5 of Example 20 (FIG. 2) could also have the shape shown in FIGS. 1 a, 1 b, 2a and 3a of the German patent application DE 195 04 540 A1, only that it had at least one grid 1.5.5 on the drive 4; 3 and the drum wall 1.5.4 opposite the drum wall 1.5.3.

The motors 4 used were electric motors from Dynamic E Flow GmbH, Kaufbeuren, Germany, under the Capcooltech® brand, type HC and type LC.

### EXAMPLE 21

Embodiments of the Agitation Means 1.4 in Mechanochemical Mills 1

Mechanochemical mills 1 according to Example 20 were provided which, instead of the attritors 1.4.1, contained further embodiments of the agitation means 1.4.

The agitation means 1.4 according to FIGS. 5-1 (a), (b) and (c) were striking disks 1.4.2, each with a circular edge 1.4.2.3. The striking disks 1.4.2 each had a centrally arranged bushing 1.4.2.1 for the drive shaft 3. Six equally sized striking holes 1.4.2.2 were arranged symmetrically around the bushing 1.4.2.1. The striking disks 1.4.2 according to FIGS. 5-2 (a), (b) and (c) differ from the striking disks 1.4.2 according to FIGS. 5-1 a), (b) and (c) only in that they had four instead of six striking holes 1.4.2.2. The striking disks 1.4.2 according to FIGS. 6 (a), (b) and (c) had three striking holes 1.4.2.2 which were curved, elongated and symmetrically arranged in a circle to each other and arranged parallel to the edge 1.2.4.3.

The striking disks 1.4.2 could be arranged on the drive shaft 3 in such a way that the striking holes 1.4.2.2 were in congruence or in a gap. The striking disks 1.4.2.1 could, however, also be arranged in such a way that two or more were alternately in congruence and then two or more on gaps.

The striking disks 1.4.2 of FIGS. 7 (a), (b) and (c) had six symmetrically arranged striking webs with a triangular profile that were convexly curved in the direction of rotation on one of their opposite surfaces. 1.4.2.4. The striking webs 1.4.2.1 each ran from the bushing 1.4.2.1 to the edge 1.4.2.3. In a further embodiment, the striking webs 1.4.2.4 could be arranged on both surfaces.

The striking disks 1.4.2 of FIGS. 8 (a), (b) and (c) differ from the striking disks 1.4.2 in that the striking webs 1.4.2.4 were arranged in a straight line and had a square profile. The striking disks 1.4.2 of FIGS. 9 (a), (b) and (c) differed from those of FIGS. 8 (a), (b) and (c) only in that the striking webs 1.4.2.4 had a triangular profile.

These striking disks 1.4.2 could also be arranged on the drive shaft 3 in such a way that the striking webs 1.4.2.4 were in congruence or in a gap. The striking disks 1.4.2.1 could, however, also be arranged in such a way that two or more were alternately in congruence and then two or more on gaps.

The agitation means 1.4 of FIGS. 10 (a), (b) and (c), which are arranged symmetrically to the drive shafts 3, each had two striking fans 1.4.3 radiating from a ring 1.4.3.1 surrounding the bushing 1.4.2. Two striking webs 1.4.2.4 with a square profile were arranged radially on each of the surfaces of the two striking fans 1.4.3. The striking fans 1.4.3 of FIGS. 11 (a), (b) and (c) differed from those of FIGS. 10 (a), (b) and (c) only in that the striking webs 1.4.2.4 had a triangular profile.

The striking fans 1.4.3 of FIGS. 12 (a), (b), (c) and (d) were arranged symmetrically to the drive shafts 3 and had each a mountain-and-valley profile 1.4.3.2 which consisted of two valleys and two mountains each running parallel to the edges 1.4.2.3.

In the agitation means 1.4 of FIGS. 13 (a), (b), (c) and (e), the ring 1.4.3.1 widened symmetrically and merged into two pairs of two radiating striking fans 1.4.3, each separated by a U-shaped gap 1.4.3.3 were separated from each other, over. The each of the four compartments had also a mountain-and-valley profile running parallel to the edges 1.4.2.3.

These striking fans 1.4.3 could also be arranged on the drive shaft 3 in such a way that they were in congruence or in a gap. The striking fans 1.4.3 could also be arranged in such a way that alternately two or more were in congruence and then two or more on gaps.

The striking club 1.4.4 of FIG. 14 had three connecting webs 1.4.2.4 with a round cross section radiating symmetrically from the ring 1.4.4.1 encompassing the drive shaft 3, at each of the ends of which a spherical striking body 1.4.4.3 was attached. The striking clubs 1.4.4 could be arranged on the drive shaft 3 in such a way that they were in congruence or on gap. However, they could also be arranged in such a way that alternately two or more stood in congruence and then two or more on gap. In other embodiments, the connecting webs 1.4.2.4 could also have a quadrangular, oval or trapezoidal cross-section or a flattened cross-section the same as through a knife edge.

The sheet-like striking wing 1.4.5 of FIG. 15 had an S-shape, in the two striking ends 1.4.5.1 of which striking holes 1.4.2.2 were arranged. The planar striking fan 1.4.5 16 had a more pronounced S-shape without striking holes 1.4.2.2. The striking wings 1.4.5 could be arranged on the drive shaft in such a way that they were in congruence or on gap. They could, however, also be arranged in such a way that two or more were alternately in congruence and then two or more on gap.

Instead of the agitation means 1.4 and grinding media 1.2 described above, the mechanical mills 1 could also be operated with rollers 1.4.6 rotating in the opposite direction of rotation 1.4.6.1. The grinding then took place in the nip. In the configuration according to FIG. 17, two parallel rollers were arranged in the grinding chamber 1.1. In the configuration according to FIG. 18, the surfaces of the two rollers 1.4.6 had interlocking spikes 1.4.6.2. In the configuration according to FIG. 19, the roller 1.4.6 rotated against an abrasion wall 1.4.6.3, the grinding taking place in the gap between the roller 1.4.6 and the abrasion wall 1.4.6.3. In the configuration of FIG. 20, the axes of rotation 1.4.6.4 of the two parallel rollers 1.4.6 intersected at an angle 1.4.6.5, which resulted in an additional torsion of the ground stock F.

The rollers 1.4.6 of FIG. 21 rotating in the opposite direction of rotation 1.4.6.1 had a resilient surface 1.4.6.6. This was formed by symmetrically arranged depressions 1.4.6.7, in which springs 1.4.6.8 pushed the spheres 1.4.6.9 out of the depressions 1.4.6.7. The grinding of the ground stock F then took place when the rollers 1.4.6 were rotated in the contact area between two spheres 1.4.6.9. The spheres 1.4.6.9 had a smaller diameter than the clear width of the depressions 1.4.6.7, so that the grist F that had penetrated into the depressions 1.4.6.7 could trickle out again when the rollers 1.4.6 were in a suitable position.

### EXAMPLE 22

Embodiments of the Grinding Chamber 1.1 of the Mechanical Mills 1

Instead of a drum 1.5, in which the grinding chamber 1.1 had the shape of a straight cylinder, a grinding chamber 1.1 could also be used, comprising at least two spherical-shaped grinding chambers 1.1.1 arranged one behind the other, which were formed by at least one circular constriction 1.1.2. The drive shaft 3 ran centrally through the spherical section-shaped grinding chambers 1.1.1 and the circular constrictions 1.1.2. The dimensions of the agitation means 1.4 were adapted to the periodically changing diameter of the grinding chambers 1.1.1. This configuration made it possible to improve the mixing of the ground stock F.

### EXAMPLE 23

Mechanochemical Process for the Decontamination of Contaminated, Phosphate-Containing Biomass A; B and for the Recovery of Phosphate B in Bioavailable Form

The mechanochemical process is explained in more detail using the flow diagram in FIG. 4.

The moist, noxious, phosphate-containing biomass A; B was dried. The resulting dry matter A; B or the solids of the biomass A; B were sieved and pre-ground. The water obtained during drying, which contained ammonia A and ammonium A, was subjected to osmosis or distillation, so that solid ammonium salts E resulted. These could be used as ammonium fertilizers (valuable product E). The ammonium salts A could also be transferred together with the solids of the biomass A; B to a mechanical mill and subjected therein to mechanochemical grinding in the presence of a plasma. This resulted in a noxious-free or noxious-reduced, immobilized heavy metals C and destroyed bacteria A and viruses A containing biomass A; B, as well as coal G and phosphates B. This mixture I could be granulated and pelletized and used as phosphate fertilizer E with coal G and non-toxic inorganic and organic components Z. The mixture I could also be ground, so that powdered phosphate fertilizer E with coal G and non-toxic inorganic and organic components Z was formed. The water-soluble, biologically available phosphate B could be extracted from the powder I and the pellets I and used as liquid fertilizer E. This way, carbon G with non-toxic organic and inorganic components Z was left behind.

### EXAMPLE 23

The regeneration of Activated Carbon G for the Return to the Fourth Purification Stage

The moist, loaded activated carbon G and the sludge A of the fourth purification stage were washed out. This resulted in a washed-out, moist, loaded activated carbon G; A. This was dried so that a washed-out, dry, loaded activated carbon G resulted.

In a further embodiment, the moist, loaded activated carbon G; A and the sludge A were dried directly, so that a dry, loaded activated carbon G; A with sand Q and organic impurities A resulted.

The two dry masses could each be sieved for itself or combined and then sieved, so that sieved, dry, loaded activated carbon G; A was obtained.

The dry, loaded activated carbon G; A with sand Q and organic impurities A, the washed-out, dry, loaded activated carbon G; A and the sifted, dry, loaded activated carbon G; A could be subjected each individually or together in a mechanical mill 1 to a mechanochemical processing with grinding media 1.2 and a plasma. In all cases, the result was a ground, regenerated activated carbon G, which may also contain impurities A; C due to fibers and mineral and metallic components. This activated carbon was sieved to separate the heavy metals C. If necessary, the heavy metals C could also be separated using magnets. The resulting milled, sieved and regenerated activated carbon G could be granulated and pelletized, and the granules and pellets could be returned to the fourth purification stage.

### EXAMPLE 24

The Radical Graft Copolymerization of a Mixture of Ethylene and Propylene on a Mechanochemically Treated, Thermosetting Clearcoat—Proof of Concept

A mechanical mill 1 according to Examples 1 to 3 was used for the grinding. Their metal surfaces were coated with a layer of aluminum oxide ceramic according to Example 17 (FIG. 2), and balls made of aluminum oxide ceramic were used instead of steel balls 1.2 (cf. Ulrike Wiech in the company brochure of Ceram Tec-ETEC GmbH, Lohmar, think ceramics TECHNISCHE KERAMIK, pages 211 and 212, 3.4.4.2 grinding and breaking). The weight ratio of grinding media 1.2 to ground stock F was 20:1. The inlet 1.5.1 for the ground stock F comprised an evacuable lock into which the ground stock F was poured. The lock was then evacuated. After a pressure of 0.01 mbar had been reached, the lock was filled with argon up to a pressure of 1.0 bar. The ground stock F was then dropped from the lock into the argon-filled grinding chamber 1.1 of the mechanochemical reactor and waveguide 1.1. The outlet 1.5.2 for the ground product P comprised a tangential cyclone separator 8.

A mixture of 70 g of powdered, thermally cured automobile series clearcoat A according to Table II-2.5: Automobile series clearcoat, page 142 of the textbook by Bodo Mueller and Ulrich Poth, lacquer formulations and lacquer recipes, the textbook for training and practice, Vincentz Verlag 2003, 3 g activated carbon G and 2 g quartz sand Q were used as the ground stock F. The ground stock F was ground under argon for 2 hours with an attritor speed of 1100 rpm to a fineness of an average particle size d₅₀=500 nm. During the grinding, the waveguide 1.1 was irradiated through the grid 1.5.5 with microwaves 2.1, which were generated with the aid of a microwave generator 2. After the end of the grinding, the resulting product I was flushed with argon from the mechanochemical reactor 1.1 into the tangential cyclone separator 8 and separated therein from the gas phase under argon, transferred under inert conditions into a suitably sized fluidized bed reactor of the customary and known design and fluidized with argon. The inert gas atmosphere was displaced by a gas mixture of ethylene and propylene in a molar ratio of 1:1. The gas mixture was pumped in a circle from below through the fluidized bed reactor, and the pressure drop resulting from the graft copolymerization on the particles of the ground product I was compensated for by metering in the gas mixture. When the pressure drop could be no longer observed, the graft copolymerization was terminated by flushing the fluidized bed reactor with argon and the resulting graft copolymer was discharged. This was a finely divided, free-flowing black powder with an average particle size of d₅₀=1.5 μm.

### EXAMPLE 25

The Use of the Mechanochemical Process According to the Invention in the Production of Drinking Water H₂O

FIG. 23 schematically shows the production of drinking water H₂O from salt water and/or dirty water SW by reverse osmosis UO and membrane filtration.

Before the microfiltration MF, the activated carbon G was used as a preliminary stage for microfiltration in order to protect the membrane MF from dirt and particles SP. This reduced the buildup and clogging.

Common macromolecules MM were retained at the ultrafiltration stage. However, the majority of the macromolecules MM had already been removed by the activated carbon G, so that the ultrafiltration membrane UF was a guard membrane that was less clogged and lasted much longer. This was especially true for cellulose, hemicellulose, lignin, humic acids, proteins and metabolites.

In the subsequent nanofiltration, the nanofiltration membrane NF retained dissociated salts and divalent and higher-valent salts DS as well as cations and anions such as sulfates DS, phosphates B and alkaline earth metals C as well as sugars ZU. It was particularly important that phosphates B could be separated here and processed cleanly together with alkaline earth metals C.

In the final reverse osmosis or reverse osmosis RO, monovalent and undissociated salts EWS; UDS were withheld. This resulted in a highly enriched solution or suspension that contained a lot of ammonium A and nitrate A as well as chlorides, bromides and alkali metal cations C. These salts C could be thickened separately or sold as fertilizer concentrate E or, if there was an oversupply, simply converted mechanochemically into atmospheric nitrogen after drying. This made it possible to increase the concentration of cations C, such as potassium C, that were not destroyed, in the mechanical mill. The activated carbon as a prefilter was mechanochemically recycled after drying and used again as a prefilter.

Overall, this process enabled the production of pure water effectively and efficiently due to the pre-filtration and the mechanochemical reprocessing of the activated carbon.

### EXAMPLE 26

The Binding of Noxae A with the Help of Impregnated Activated Carbons G and the Reprocessing of the Loaded Impregnated Activated Carbons G

The exhaust air filters of cattle barns, digestion towers, biogas plants and closed waste disposal sites were equipped with multi-layer impregnated activated carbon filters A. The individual layers were impregnated with potassium iodide, carbon dioxide, carbon monoxide, hydrogen sulfide and other sulfur compounds. This significantly increased the adsorption capacity of activated carbon G, because noxae A such as ammonia, amines, fine dust, ultrafine dust, arsenic and mercury were not only bound by adsorption, but also by chemical sorption or catalyzed reactions. The activated carbons G impregnated with potassium iodide were particularly effective in this regard.

The impregnated activated carbons G loaded with noxae A could then be recycled and reactivated with the aid of the mechanochemical process according to the invention.

### EXAMPLE 27

The Classification of Activated Carbon Particles G with a Particle Size of 1 μm to 3 μm

A further advantageous application of the mechanochemical method according to the invention was the sifting, the separation and sifting of activated carbon particles G with an average particle size d₅₀ of 1 μm 3 μm in the device according to FIG. 24. For this purpose, cleaned, dried nitrogen 5.1 was sucked in through a suction pipe 5.0 with the aid of a blower 5 and blown as a gas flow 5.2 through a first pipe 5.5 into the grinding chamber 1.1 of a mechanical 1 mill. Before entering the grinding chamber 1.1, the gas 5.2 flowed through a gas-permeable protective grid 6, which prevented grinding balls 1.2 from entering the tube 5.5 during the operation of the mechanical mill 1. The gas flow 5.2, viewed in the direction of flow, was regulated with the aid of a control valve 5.2.2 immediately before entering the grinding chamber 1.1.

The finely divided, powdery activated carbon particles G were discharged from the grinding chamber 1.1 with the gas stream 5.3 with an average particle size <1 μm through a further protective grid 6 via a second tube 5.6. The gas flow 5.3 was regulated by a control valve 5.3.1.

The gas flow 5.3 was passed in the further course of the pipe 5.6 through a bypass BP with a pipe 5.5.1 and combined with a gas flow 5.2.1 regulated with the aid of a control valve 5.2.3. The combined gas streams 5.3; 5.2.1 was led into an acoustophoresis unit 7 according to the international patent application WO 2017/153038, in which the finely divided activated carbon particles G were agglomerated by means of standing ultrasonic waves 7.2, which were generated by mutually opposing ultrasonic sources 7.1, so that they had the desired mean particle size d₅₀. The exiting gas stream 5.4 with the agglomerated activated carbon particles G was blown into the cyclone 8 via the gas feed line 5.6, in which the agglomerated activated carbon particles G; 9.1 were separated from the gas phase (exhaust gas 5.7), which was discharged via the exhaust gas line 8.1, and discharged as a powdery solid 9 via the solids outlet 8.2.

A major advantage of this device was that the bypass BP, which fluidly connected the gas line 5.5 and the gas line 5.6, ensured that a stronger gas flow 5.4 flowed through the cyclone 8 than through the grinding chamber 1.1.

### EXAMPLE 28

The Mechanochemical Elimination of the Slip of Organic Gases and Carbon Dioxide in the Exhaust Gases from Biogas Plants and Gas Engines

The slip of organic gases F and carbon dioxide D, in particular the methane slip F in biogas plants and in gas engines operated with methane and/or natural gas, could be effectively and efficiently eliminated by mechanochemically converting the slip gases into carbon G using the mechanochemical method according to the invention in the presence of activated carbon G so that they no longer entered the atmosphere, where they would have acted as particularly strong greenhouse gases. Thus, not only could the emission of greenhouse gases be effectively prevented by the mechanochemical process according to the invention, but the resulting coal G could be used again for grinding.

### EXAMPLES 29 AND 30

The Splitting of Carbon Dioxide into the Elements—Proof of Concept

### EXAMPLE 29: CARBON DIOXIDE WITH C-13 ON NORMAL ACTIVATED CARBON

20 g of activated carbon with a typical isotope ratio of 98.9% C-12 and 1.1% C-13 were treated with C-13-labeled carbon dioxide (Sigma Aldrich 364592-1 L EU, 99% atom C-13) until saturation in a mechanical mill with a volume of 1 L for 12 hours at room temperature. The activated carbon was first dried at 1100 C. for 12 hours and then degassed under reduced pressure. The reduced pressure was a high vacuum of 10³ hPa (mbar).

Thereafter, the coal was mixed with 5% by weight of silica and treated mechanochemically at room temperature at 1200 RPM in a mechanical mill with a grinding chamber of 1 L with 1250 g of chrome steel balls of 5 mm diameter. The C-13 content of the activated carbon was then determined by means of mass spectrometry. The measurements indicated that 3.4% C-13 was present. This means that 3.4×100/3.854=88.2% C-13 had been incorporated into the activated carbon during the grinding.

Calculation:

1 Liters of C-13 CO₂ contained 0.04461 moles of C-13 CO₂

0.04461 mol with a molar mass of M=45 g/mol (O-16=99%) contained n×M=m, m=2.0076 g

Of this, 13/45 percentages would have been converted into coal with 100% conversion. That would have been 0.579 g of C-13.

A theoretical implementation of 100% would have resulted in:

20 g activated carbon AK with 98.9% C-12 and 1.1% C-13

Making 0.006 g and 0.573 g

Yielding 19.780 g Activated Carbon AK and 0.220 g with C-13 and 99% C-12

In total: 19.786 g of C-12 and 0.793 g of C-13

In total: 19.786 g+0.793 g=20.579 g

Which is 96.146% C-12 and 3.854% C-13

Previously, the mass ratio in the activated carbon AK=98.9 C-12/1.1% C-13

After a 100% adsorption and conversion, the ratio in the activated carbon AK would have been 96.146% C-12/3.854% C-13.

### EXAMPLE 30

Carbon Dioxide Labeled with 13-C on Activated Carbon Loaded with Ammonia

20 g of activated carbon with a typical isotope ratio of 98.9% C-12 and 1.1% C-13 were treated in a mechanical mill with a volume of 1 L for 12 hours at room temperature with C-13-labeled carbon dioxide (Sigma Aldrich 364592-1 L EU, 99%—atom C-13) and the same stoichiometric amount of ammonia until saturation. The activated carbon was first dried at 110° C. for 12 hours and then degassed under reduced pressure. The reduced pressure was a high vacuum of 10⁻³ hPa (mbar).

Thereafter the coal was mixed with 5% by weight of silicon dioxide and treated mechanochemically at room temperature at 1200 rpm in a mechanical mill with a grinding chamber of 1 L with 1250 g of chrome steel balls of 5 mm diameter. The C-13 content in the ground coal was then determined by means of mass spectrometry. The measurements showed that it contained 3.4% C-13. This means that 3.6×100/3.854=93.4% C-13 had been incorporated into the activated carbon.

1 Liters of C-13 CO₂ contained 0.04461 moles of C-13 CO₂

0.04461 mol with a molar mass of M=45 g/mol (O-16=99%) contained n×M=m, m=2.0076 g

Of this, 13/45 percentages would have been converted into coal with 100% conversion. That would have been 0.579 g of C-13.

A theoretical implementation of 100% would have resulted in:

20 g activated carbon AK with 98.9% C-12 and 1.1% C-13

Making 0.006 g and 0.573 g

Yielding 19.780 g Activated Carbon AK and 0.220 g with C-13 and 99% C-12

In total: 19.786 g of C-12 and 0.793 g of C-13

In total: 19.786 g+0.793 g=20.579 g

Which is 96.146% C-12 and 3.854% C-13

Previously, the mass ratio in the activated carbon AK=98.9 C-12/1.1% C-13

After a 100% adsorption and conversion, the ratio in the activated carbon AK would have been 96.146% C-12/3.854% C-13.

### CONCLUSION

In the presence of ammonia, the incorporation of C-13 into the activated carbon was significantly increased. The incorporation of C-13 into the activated carbon was evidence that the carbon dioxide had been split into the elements.

1. Mechanochemical process for the decontamination and/or elimination of problematic, synthetic, biogenic and biological materials (A), for the digestion of phosphates (B), for the immobilization of metals and their compounds (C), for the splitting of carbon dioxide (D) into the elements and for the recovery of valuable products (E), characterized in that
(I) one makes available as the ground stock F at least one fluid F, at least one solution F, at least one suspension F, at least one finely divided solid mixture F and/or at least one reactive gas F, containing
at least one material A, B, C and/or D and
at least one material G, selected from the group consisting of pure, finely divided, mineral coal, partially pyrolyzed coal, biochar and activated carbon, contaminated or impregnated, finely divided mineral coal, partially pyrolyzed coal, biochar and activated carbon, finely divided lignite and pure and contaminated or impregnated, finely divided carbon suppliers as well as of the above-mentioned, moistened materials G, or alternatively, the components F and G are made available separately from one another,
(II) one feeds the at least one fluid F, the at least one solution F, the at least one suspension F, the at least one finely divided solid mixture F and/or the at least one reactive gas F continuously or discontinuously into the grinding chamber (1.1) of at least one mechanical mill (1) or alternatively
(III) one pours the components A, B, C and/or D as well as G of the ground stock F into the grinding chamber (1.1) of the at least one mechanical mill (1) one after the other or at the same time, continuously or discontinuously, and
(IV) finely grinds them therein with agitation means (1.4) or moving grinding media (1.2) or with rollers (1.4.6) at constant and/or variable speed of rotation, after which one
(V) separates the resulting at least one suspension H of at least one pulverulent product I and/or the at least one pulverulent product I continuously or discontinuously from the grinding media (1.2) or the rollers (1.4.6) and discharges it from the grinding chamber (1.1) and
(VI) separates the at least one finely divided, solid product I from the suspension H, as a result of which at least one digested, biologically available, soluble material passes into the liquid medium as product E of value, or
(VII) one washes out the at least one digested, biologically available, soluble material E present or still present in the at least one finely divided, solid product I with at least one liquid medium or leaves it in the at least one product I as product E until its further use and/or
(VIII) one recycles the at least one washed, finely divided, solid product I of activated carbon G to process step (I) and/or uses it as product of value E elsewhere and/or
(IX) one stores the at least one finely divided, solid product I, which contains at least one immobilized metal C and/or at least one compound C thereof, until it is reused as product E of value or disposes it and/or
(X) one separates the resulting elemental nitrogen and/or oxygen.

2. Mechanochemical process according to claim 1, wherein the at least one digested material E, which is soluble in liquid media, is selected from the group consisting of lithium, sodium and potassium salts and magnesium and calcium salts and biologically available phosphates B; and/or the at least one immobilized material C is selected from the group consisting of main group elements, transition metals, lanthanides and actinides C and their compounds C.

3. Mechanochemical process according to claim 1, wherein the at least one solid, finely divided product I is at least one product E of value selected from the group consisting of activated carbons G, which are returned to process step (I) or are used otherwise, at least one phosphate-containing fertilizer E, which is applied to agricultural land, at least one safely storable material E containing at least one immobilized metal C and/or at least one of its compounds C, or at least one heterogeneous catalyst E on the basis at least one immobilized metal C and/or at least one of its compounds C.

4. Mechanochemical process according to claim 1, wherein a plasma is present during the grinding in the grinding chamber (1.1) of the mills (1).

5. Mechanochemical process according to claim 4, wherein the plasmas are generated by generating triboplasm by means of gas discharge, hotspots, electrostatic charging, emission of exoelectrons, triboluminescence, crystal lattice defects, shredding, dislocations, crystal lattice vibrations, fracture formation, cutting processes, compression, sanding, abrasion, high pressures, friction, metastable states and hotspots due to the collision of solids and/or the friction of solids against each other as well as catalytically active and/or piezoelectric particles and coatings on the grinding bodies (1.2) and/or the walls of the grinding chamber (1.1) and/or on the agitation means (1.4) and/or in the grinding chamber (1.1) of the mechanical mills (1), focused laser radiation, electron beams, radioactive radiation, X-rays, UV-Radiation, IR radiation, Microwave radiation, ultrasound, chemical and nuclear reactions, electrostatic fields, electromagnetic fields, direct voltage, capacitive electrical excitation, wire explosions, gas discharges, electric arcs, spark discharges, vacuum spark discharges, cyclotron resonance, capacitive glass tube discharge and the pinch effect.

6. Mechanochemical method according to claim 5, wherein the piezoelectric particles and/or the coatings on the grinding bodies (1.2), the drive shafts (3), the walls of the grinding chamber (1.1) and/or on the agitation means (1.4) and/or in the grinding chamber (1.1) of the mechanical mills (1) are selected from the group consisting of carbon, quartz, glass barium titanate (BTO), lead zirconate titanate (PZT), lead magnesium niobate (PMN), gallium orthophosphate, berlinite, tourmaline, seignette salt, piezoelectric thin layers of zinc oxide, aluminum nitride, silicon nitride, silicon carbide, aluminum oxide, zirconium oxide and titanium nitride, polyvinylidene fluoride (PVDF) and ferroelectric, polycrystalline ceramics, and the catalytically active particles and/or the coatings on the grinding media (1.2), the walls of the grinding chamber (1.1), the drive shafts (3) and/or on the agitation means (1.4) and/or in the grinding chamber (1.1) of the mechanical Mills (1) are selected from the group consisting of metals, metal alloys, metal compounds and microporous materials.

7. Mechanochemical method according to claim 1, wherein the at least one material A is selected from the group consisting of natural, synthetic, biogenic and biological materials that are ecologically problematic, intensely smelling, toxic, combustible, oxidizing, radioactive, carbon supplying and/or explosive materials, their mixtures and their waste as well as contaminated mineral coals, biochars, activated carbons and carbon suppliers.

8. Mechanochemical process according to claim 1, wherein the grinding of the at least one ground stock F is carried out at a temperature of the grinding media (1.2) and of the at least one ground stock F of from −273° C. to +1,200° C.

9. Mechanochemical process according to claim 8, wherein the temperatures in the hotspots and in the plasmas are up to 15,000° C.

10. Mechanochemical process according to claim 1, wherein the weight ratio (Y)=(A, B, C and/or D): (G) in the mill base F is 0.01 to 1012.

11. Use of an electric motor, comprising an electric machine component with at least one winding for generating a magnetic field which comprises at least one waveguide which has a jacket and an inner cavity through which a coolant can be conducted, the winding having two ends at which an electrical operating voltage is connected and wherein
the waveguides are round tubular and have an outer diameter in a range of 1 mm to 4 mm,
the ends of the winding each serve as a coolant inlet or coolant outlet and
the ends of the winding are connected to a connector that has a coolant inlet and/or a coolant outlet, several waveguide connections for connecting waveguides, a distribution channel through which the coolant is fed into at least one waveguide, and/or that comprises a collecting channel into which the coolant emerging from at least one waveguide is directed to the coolant outlet of the connector,
as a drive for mechanical mills for mechanochemical processes.

12. Mechanical mill (1), comprising at least one rotatable or stationary mechanochemical reactor and waveguide (1.1) containing a rotatable or stationary drum (1.5) with a grinding chamber (1.1) with at least one inlet (1.5.1) for the ground material (F; 1.3), at least one outlet (1.5.2) for the ground product I and a large number of stationary or rotatable agitation means (1.4), wherein
the drum (1.5) of the rotatable mechanochemical reactor and waveguide (1.1) has a disk-shaped vertical drum wall (1.5.3) which is connected in its center to a rotatable drive shaft (3) which can be driven by a motor (4), and
the drum (1.5) of the fixed mechanochemical reactor and waveguide (1.1) has agitation means (1.4) rotatable with the aid of a drive shaft (3) for mixing the grinding media (1.2) and the ground stock (1.3) or rotatable rollers aligned in the longitudinal direction of the drum (1.5) (1.4.6), the drive shaft (3) being driven by a motor (4) and being guided through the disc-shaped vertical drum wall (1.5.3) through the bushing (1.5.3.1),
the agitation means (1.4) are selected from the group consisting of striking disks (1.4.2), striking holes (1.4.3), flapping or striking clubs (1.4.4) and flapping or striking wings (1.4.5), having striking holes (1.4.2.2), flapping or striking webs (1.4.2.4), mountain-and-valley profiles (1.4.3.2), connecting webs (1.4.4.2) and impact bodies (1.4.4.3) symmetrically arranged to the drive shaft (3), and wherein
the rotatable rollers (1.4.6) can be rotated in opposite directions of rotation (1.4.6.1) and their axes of rotation (1.4.6.4) are parallel to one another or have an angle of inclination (1.4.6.5) or can be rotated against an abrasion surface (1.4.6.3) are.

13. Mechanochemical mill (1) according to claim 14, wherein the mill (1) has an agitation means (1.4) of the same type and/or at least two different types of agitation means (1.4), the agitation means (1.4) being selected from the group, consisting of striking disks (1.4.2), striking fans (1.4.3), striking clubs (1.4.4) and flapping or striking wings (1.4.5), wherein the striking holes (1.4.2.2), the flapping or striking webs (1.4.2.4), the mountain and valley profiles (1.4.3.2), the connecting webs (1.4.4.2) and the striking bodies (1.4.4.3) are arranged symmetrically to the drive shaft (3), which agitation means (1.4) seen in the direction of the drive shaft (3) are in congruence and/or on gap.

14. Mechanical mill (1) according to claim 12, wherein the drum wall (1.5.4) of both the stationary and the rotatable mechanochemical reactor and waveguide (1.1) opposite of the disk-shaped vertical drum wall (1.5.3) is provided with one impact-resistant grid or window (1.5.5) which is permeable for electromagnetic radiation and/or corpuscular radiation (2.1) and which separates the mechanochemical reactor and waveguide (1.1) from the at least one radiation source (2).

15. Mechanochemical mill (1) according to claim 12, wherein the grinding chamber (1.1) has at least two spherical-shaped grinding chambers (1.1.1) arranged one behind the other, which are formed by at least one circular constriction (1.1.2), wherein drive shaft (3) runs centrally through the spherical section-shaped grinding chambers (1.1.1) and the circular constrictions (1.1.2) and the dimensions of the agitation means (1.4) are adapted to the periodically changing diameter of the grinding chambers (1.1.1).
